(19) United States
(12) Patent Application Publication
(10) Pub. No.: US 2025/0317840 A1
(43) Pub. Date: Oct. 9, 2025

(54) Connection Management of Direct Access

(71) Applicant: Ofinno, LLC, Reston, VA (US)

(72) Inventors: SungDuck Chun, Fairfax, VA (US); Kyungmin Park, Vienna, VA (US); Esmael Hejazi Dinan, McLean, VA (US); Jian Xu, McLean, VA (US); Taehun Kim, Fairfax, VA (US); Stanislav Filin, Chantilly, VA (US)

(21) Appl. No.: 19/098,403

(22) Filed: Apr. 2, 2025

Related U.S. Application Data
(60) Provisional application No. 63/574,107, filed on Apr. 3, 2024.

(51) Int. Cl. H04W 48/18; H04W 60/04; H04W 76/10

(52) U.S. Cl. CPC H04W 48/18; H04W 60/04; H04W 76/10

(57) ABSTRACT

A wireless device receives, from a first access and mobility management function (AMF), a non-access stratum (NAS) message comprising an indication indicating whether an access traffic steering, switching, and splitting (ATSSS) type of a plurality of ATSSS types is allowed for a single network slice selection assistance information (S-NSSAI).

### CROSS-REFERENCE TO RELATED APPLICATIONS

This application claims the benefit of U.S. Provisional Application No. 63/574,107, filed Apr. 3, 2024, which is hereby incorporated by reference in its entirety.

### BRIEF DESCRIPTION OF THE DRAWINGS

Examples of several of the various embodiments of the present disclosure are described herein with reference to the drawings.

FIG. 1A and FIG. 1B illustrate example communication networks including an access network and a core network.

FIG. 2A, FIG. 2B, FIG. 2C, and FIG. 2D illustrate various examples of a framework for a service-based architecture within a core network.

FIG. 3 illustrates an example communication network including core network functions.

FIG. 4A and FIG. 4B illustrate example of core network architecture with multiple user plane functions and untrusted access.

FIG. 5 illustrates an example of a core network architecture for a roaming scenario.

FIG. 6 illustrates an example of network slicing.

FIG. 7A, FIG. 7B, and FIG. 7C illustrate a user plane protocol stack, a control plane protocol stack, and services provided between protocol layers of the user plane protocol stack.

FIG. 8 illustrates an example of a quality of service model for data exchange.

FIG. 9A, FIG. 9B, FIG. 9C, and FIG. 9D illustrate example states and state transitions of a wireless device.

FIG. 10 illustrates an example of a registration procedure for a wireless device.

FIG. 11 illustrates an example of a service request procedure for a wireless device.

FIG. 12 illustrates an example of a protocol data unit session establishment procedure for a wireless device.

FIG. 13 illustrates examples of components of the elements in a communications network.

FIG. 14A, FIG. 14B, FIG. 14C, and FIG. 14D illustrate various examples of physical core network deployments, each having one or more network functions or portions thereof.

FIG. 15 is a diagram of an aspect of an example embodiment of the present disclosure.

FIGS. 16A and 16B are diagrams of an aspect of an example embodiment of the present disclosure.

FIG. 17 is a diagram of an aspect of an example embodiment of the present disclosure.

FIG. 18 is a diagram of an aspect of an example embodiment of the present disclosure.

FIG. 19 is a diagram of an aspect of an example embodiment of the present disclosure.

FIG. 20 is a diagram of an aspect of an example embodiment of the present disclosure.

FIG. 21 is a diagram of an aspect of an example embodiment of the present disclosure.

FIG. 22 is a diagram of an aspect of an example embodiment of the present disclosure.

FIG. 23 is a diagram of an aspect of an example embodiment of the present disclosure.

FIG. 24 is a diagram of an aspect of an example embodiment of the present disclosure.

FIG. 25 is a diagram of an aspect of an example embodiment of the present disclosure.

FIG. 26 is a diagram of an aspect of an example embodiment of the present disclosure.

FIG. 27 is a diagram of an aspect of an example embodiment of the present disclosure.

FIG. 28 is a diagram of an aspect of an example embodiment of the present disclosure.

FIG. 29 is a diagram of an aspect of an example embodiment of the present disclosure.

FIG. 30 is a diagram of an aspect of an example embodiment of the present disclosure.

FIG. 31 is a diagram of an aspect of an example embodiment of the present disclosure.

FIG. 32 is a diagram of an aspect of an example embodiment of the present disclosure.

FIG. 33 is a diagram of an aspect of an example embodiment of the present disclosure.

FIG. 34 is a diagram of an aspect of an example embodiment of the present disclosure.

FIG. 35 is a diagram of an aspect of an example embodiment of the present disclosure.

FIG. 36 is a diagram of an aspect of an example embodiment of the present disclosure.

FIG. 37 is a diagram of an aspect of an example embodiment of the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have one or more specific capabilities. When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases refer to a single instance of a particular element, but should not be interpreted to exclude other instances of that element. For example, a bicycle with two wheels may be described as having “a wheel”. Any term that ends with the suffix “(s)” is to be interpreted as “at least one” and/or “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described.

The phrases “based on”, “in response to”, “depending on”, “employing”, “using”, and similar phrases indicate the presence and/or influence of a particular factor and/or condition on an event and/or action, but do not exclude unenumerated factors and/or conditions from also being present and/or influencing the event and/or action. For example, if action X is performed “based on” condition Y, this is to be interpreted as the action being performed “based at least on” condition Y. For example, if the performance of action X is performed when conditions Y and Z are both satisfied, then the performing of action X may be described as being “based on Y”.

The term “configured” may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, a parameter may comprise one or more information objects, and an information object may comprise one or more other objects. For example, if parameter J comprises parameter K, and parameter K comprises parameter L, and parameter L comprises parameter M, then J comprises L, and J comprises M. A parameter may be referred to as a field or information element. In an example embodiment, when one or more messages comprise a plurality of parameters, it implies that a parameter in the plurality of parameters is in at least one of the one or more messages, but does not have to be in each of the one or more messages.

This disclosure may refer to possible combinations of enumerated elements. For the sake of brevity and legibility, the present disclosure does not explicitly recite each and every permutation that may be obtained by choosing from a set of optional features. The present disclosure is to be interpreted as explicitly disclosing all such permutations. For example, the seven possible combinations of enumerated elements A, B, C consist of: (1) “A”; (2) “B”; (3) “C”; (4) “A and B”; (5) “A and C”; (6) “B and C”; and (7) “A, B, and C”. For the sake of brevity and legibility, these seven possible combinations may be described using any of the following interchangeable formulations: “at least one of A, B, and C”; “at least one of A, B, or C”; “one or more of A, B, and C”; “one or more of A, B, or C”; “A, B, and/or C”. It will be understood that impossible combinations are excluded. For example, “X and/or not-X” should be interpreted as “X or not-X”. It will be further understood that these formulations may describe alternative phrasings of overlapping and/or synonymous concepts, for example, “identifier, identification, and/or ID number”.

This disclosure may refer to sets and/or subsets. As an example, set X may be a set of elements comprising one or more elements. If every element of X is also an element of Y, then X may be referred to as a subset of Y. In this disclosure, only non-empty sets and subsets are considered. For example, if Y consists of the elements Y1, Y2, and Y3, then the possible subsets of Y are {Y1, Y2, Y3}, {Y1, Y2}, {Y1, Y3}, {Y2, Y3}, {Y1}, {Y2}, and {Y3}.

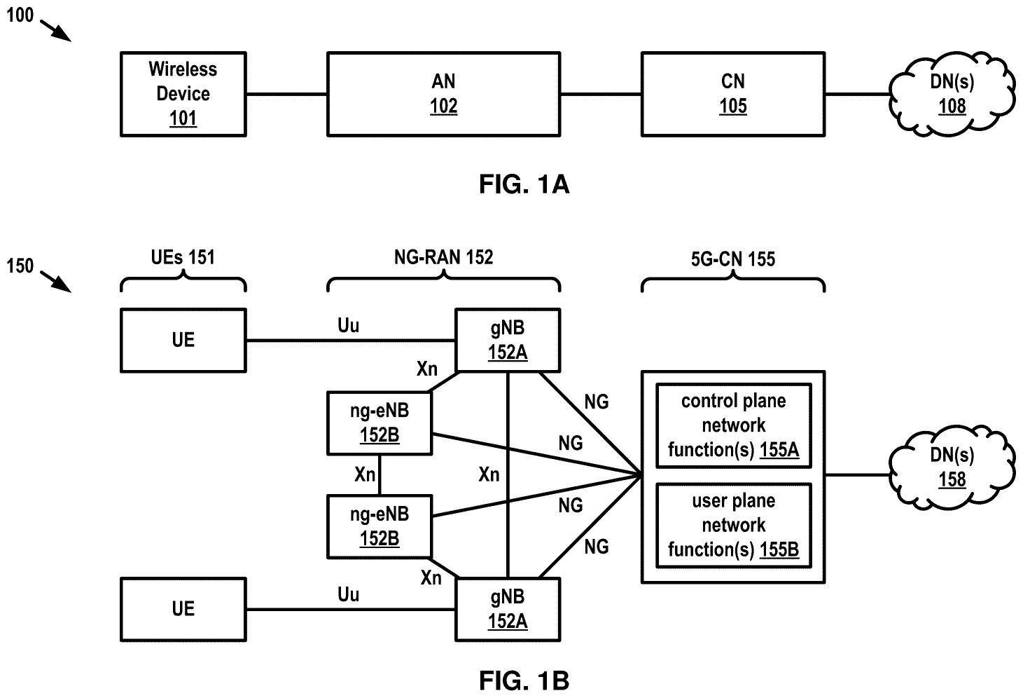

FIG. 1A illustrates an example of a communication network 100 in which embodiments of the present disclosure may be implemented. The communication network 100 may comprise, for example, a public land mobile network (PLMN) run by a network operator. As illustrated in FIG. 1A, the communication network 100 includes a wireless device 101, an access network (AN) 102, a core network (CN) 105, and one or more data network (DNs) 108.

The wireless device 101 may communicate with DNs 108 via AN 102 and CN 105. In the present disclosure, the term wireless device may refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle road side unit (RSU), relay node, automobile, unmanned aerial vehicle, urban air mobility, and/or any combination thereof. The term wireless device encompasses other terminology, including user equipment (UE), user terminal (UT), access terminal (AT), mobile station, handset, wireless transmit and receive unit (WTRU), and/or wireless communication device.

The AN 102 may connect wireless device 101 to CN 105 in any suitable manner. The communication direction from the AN 102 to the wireless device 101 is known as the downlink and the communication direction from the wireless device 101 to AN 102 is known as the uplink. Downlink transmissions may be separated from uplink transmissions using frequency division duplexing (FDD), time-division duplexing (TDD), and/or some combination of the two duplexing techniques. The AN 102 may connect to wireless device 101 through radio communications over an air interface. An access network that at least partially operates over the air interface may be referred to as a radio access network (RAN). The CN 105 may set up one or more end-to-end connection between wireless device 101 and the one or more DNs 108. The CN 105 may authenticate wireless device 101 and provide charging functionality.

In the present disclosure, the term base station may refer to and encompass any element of AN 102 that facilitates communication between wireless device 101 and AN 102. Access networks and base stations have many different names and implementations. The base station may be a terrestrial base station fixed to the earth. The base station may be a mobile base station with a moving coverage area. The base station may be in space, for example, on board a satellite. For example, WiFi and other standards may use the term access point. As another example, the Third-Generation Partnership Project (3GPP) has produced specifications for three generations of mobile networks, each of which uses different terminology. Third Generation (3G) and/or Universal Mobile Telecommunications System (UMTS) standards may use the term Node B. 4G, Long Term Evolution (LTE), and/or Evolved Universal Terrestrial Radio Access (E-UTRA) standards may use the term Evolved Node B (eNB). 5G and/or New Radio (NR) standards may describe AN 102 as a next-generation radio access network (NG-RAN) and may refer to base stations as Next Generation eNB (ng-eNB) and/or Generation Node B (gNB). Future standards (for example, 6G, 7G, 8G) may use new terminology to refer to the elements which implement the methods described in the present disclosure (e.g., wireless devices, base stations, ANs, CNs, and/or components thereof). A base station may be implemented as a repeater or relay node used to extend the coverage area of a donor node. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The AN 102 may include one or more base stations, each having one or more coverage areas. The geographical size and/or extent of a coverage area may be defined in terms of a range at which a receiver of AN 102 can successfully receive transmissions from a transmitter (e.g., wireless device 101) operating within the coverage area (and/or vice-versa). The coverage areas may be referred to as sectors or cells (although in some contexts, the term cell refers to the carrier frequency used in a particular coverage area, rather than the coverage area itself). Base stations with large coverage areas may be referred to as macrocell base stations. Other base stations cover smaller areas, for example, to provide coverage in areas with weak macrocell coverage, or to provide additional coverage in areas with high traffic (sometimes referred to as hotspots). Examples of small cell base stations include, in order of decreasing coverage area, microcell base stations, picocell base stations, and femtocell base stations or home base stations. Together, the coverage areas of the base stations may provide radio coverage to wireless device 101 over a wide geographic area to support wireless device mobility.

A base station may include one or more sets of antennas for communicating with the wireless device 101 over the air interface. Each set of antennas may be separately controlled by the base station. Each set of antennas may have a corresponding coverage area. As an example, a base station may include three sets of antennas to respectively control three coverage areas on three different sides of the base station. The entirety of the base station (and its corresponding antennas) may be deployed at a single location. Alternatively, a controller at a central location may control one or more sets of antennas at one or more distributed locations. The controller may be, for example, a baseband processing unit that is part of a centralized or cloud RAN architecture. The baseband processing unit may be either centralized in a pool of baseband processing units or virtualized. A set of antennas at a distributed location may be referred to as a remote radio head (RRH).

FIG. 1B illustrates another example communication network 150 in which embodiments of the present disclosure may be implemented. The communication network 150 may comprise, for example, a PLMN run by a network operator. As illustrated in FIG. 1B, communication network 150 includes UEs 151, a next generation radio access network (NG-RAN) 152, a 5G core network (5G-CN) 155, and one or more DNs 158. The NG-RAN 152 includes one or more base stations, illustrated as generation node Bs (gNBs) 152A and next generation evolved Node Bs (ng eNBs) 152B. The 5G-CN 155 includes one or more network functions (NFs), including control plane functions 155A and user plane functions 155B. The one or more DNs 158 may comprise public DNS (e.g., the Internet), private DNs, and/or intra-operator DNs. Relative to corresponding components illustrated in FIG. 1A, these components may represent specific implementations and/or terminology.

The base stations of the NG-RAN 152 may be connected to the UEs 151 via Uu interfaces. The base stations of the NG-RAN 152 may be connected to each other via Xn interfaces. The base stations of the NG-RAN 152 may be connected to 5G CN 155 via NG interfaces. The Uu interface may include an air interface. The NG and Xn interfaces may include an air interface, or may consist of direct physical connections and/or indirect connections over an underlying transport network (e.g., an internet protocol (IP) transport network).

Each of the Uu, Xn, and NG interfaces may be associated with a protocol stack. The protocol stacks may include a user plane (UP) and a control plane (CP). Generally, user plane data may include data pertaining to users of the UEs 151, for example, internet content downloaded via a web browser application, sensor data uploaded via a tracking application, or email data communicated to or from an email server. Control plane data, by contrast, may comprise signaling and messages that facilitate packaging and routing of user plane data so that it can be exchanged with the DN(s). The NG interface, for example, may be divided into an NG user plane interface (NG-U) and an NG control plane interface (NG-C). The NG-U interface may provide delivery of user plane data between the base stations and the one or more user plane network functions 155B. The NG-C interface may be used for control signaling between the base stations and the one or more control plane network functions 155A. The NG-C interface may provide, for example, NG interface management, UE context management, UE mobility management, transport of NAS messages, paging, PDU session management, and configuration transfer and/or warning message transmission. In some cases, the NG-C interface may support transmission of user data (for example, a small data transmission for an IoT device).

One or more of the base stations of the NG-RAN 152 may be split into a central unit (CU) and one or more distributed units (DUs). A CU may be coupled to one or more DUs via an F1 interface. The CU may handle one or more upper layers in the protocol stack and the DU may handle one or more lower layers in the protocol stack. For example, the CU may handle RRC, PDCP, and SDAP, and the DU may handle RLC, MAC, and PHY. The one or more DUs may be in geographically diverse locations relative to the CU and/or each other. Accordingly, the CU/DU split architecture may permit increased coverage and/or better coordination.

The gNBs 152A and ng-eNBs 152B may provide different user plane and control plane protocol termination towards the UEs 151. For example, the gNB 154A may provide new radio (NR) protocol terminations over a Uu interface associated with a first protocol stack. The ng-eNBs 152B may provide Evolved UMTS Terrestrial Radio Access (E-UTRA) protocol terminations over a Uu interface associated with a second protocol stack.

The 5G-CN 155 may authenticate UEs 151, set up end-to-end connections between UEs 151 and the one or more DNs 158, and provide charging functionality. The 5G-CN 155 may be based on a service-based architecture, in which the NFs making up the 5G-CN 155 offer services to each other and to other elements of the communication network 150 via interfaces. The 5G-CN 155 may include any number of other NFs and any number of instances of each NF.

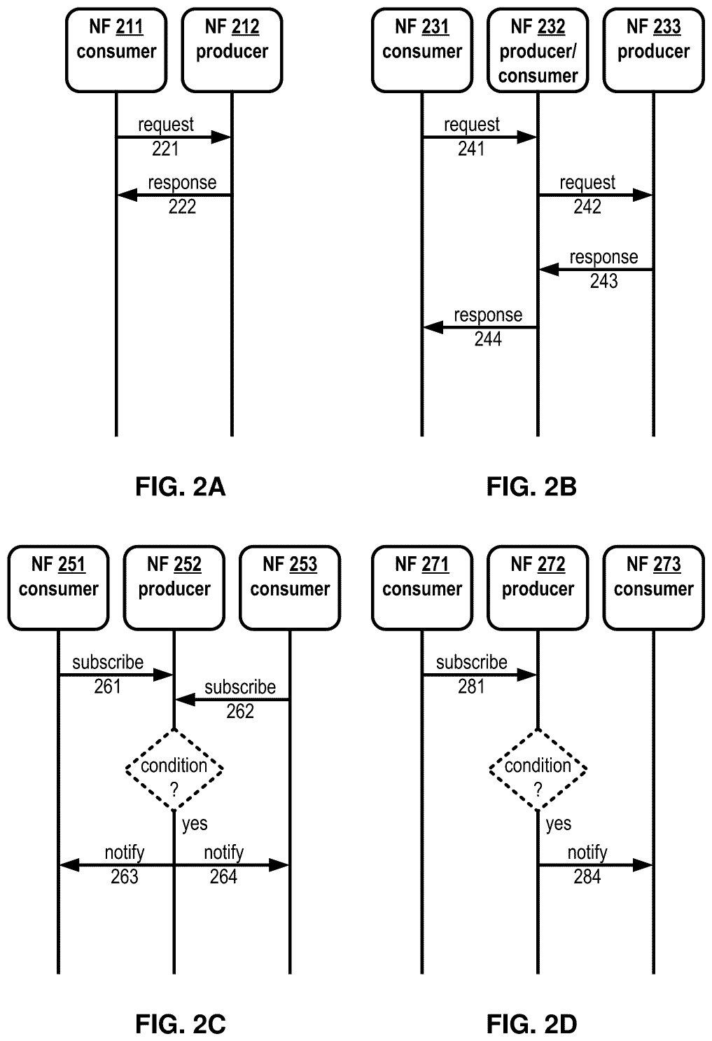

FIG. 2A, FIG. 2B, FIG. 2C, and FIG. 2D illustrate various examples of a framework for a service-based architecture within a core network. In a service-based architecture, a service may be sought by a service consumer and provided by a service producer. Prior to obtaining a particular service, an NF may determine where such a service can be obtained. To discover a service, the NF may communicate with a network repository function (NRF). As an example, an NF that provides one or more services may register with a network repository function (NRF). The NRF may store data relating to the one or more services that the NF is prepared to provide to other NFs in the service-based architecture. A consumer NF may query the NRF to discover a producer NF (for example, by obtaining from the NRF a list of NF instances that provide a particular service).

In the example of FIG. 2A, an NF 211 (a consumer NF in this example) may send a request 221 to an NF 212 (a producer NF). The request 221 may be a request for a particular service and may be sent based on a discovery that NF 212 is a producer of that service. The request 221 may comprise data relating to NF 211 and/or the requested service. The NF 212 may receive request 221, perform one or more actions associated with the requested service (e.g., retrieving data), and provide a response 221. The one or more actions performed by the NF 212 may be based on request data included in the request 221, data stored by NF 212, and/or data retrieved by NF 212. The response 222 may notify NF 211 that the one or more actions have been completed. The response 222 may comprise response data relating to NF 212, the one or more actions, and/or the requested service.

In the example of FIG. 2B, an NF 231 sends a request 241 to an NF 232. In this example, part of the service produced by NF 232 is to send a request 242 to an NF 233. The NF 233 may perform one or more actions and provide a response 243 to NF 232. Based on response 243, NF 232 may send a response 244 to NF 231. It will be understood from FIG. 2B that a single NF may perform the role of producer of services, consumer of services, or both. A particular NF service may include any number of nested NF services produced by one or more other NFs.

FIG. 2C illustrates examples of subscribe-notify interactions between a consumer NF and a producer NF. In FIG. 2C, an NF 251 sends a subscription 261 to an NF 252. An NF 253 sends a subscription 262 to the NF 252. Two NFs are shown in FIG. 2C for illustrative purposes (to demonstrate that the NF 252 may provide multiple subscription services to different NFs), but it will be understood that a subscribe-notify interaction only requires one subscriber. The NFs 251, 253 may be independent from one another. For example, the NFs 251, 253 may independently discover NF 252 and/or independently determine to subscribe to the service offered by NF 252. In response to receipt of a subscription, the NF 252 may provide a notification to the subscribing NF. For example, NF 252 may send a notification 263 to NF 251 based on subscription 261 and may send a notification 264 to NF 253 based on subscription 262.

As shown in the example illustration of FIG. 2C, the sending of the notifications 263, 264 may be based on a determination that a condition has occurred. For example, the notifications 263, 264 may be based on a determination that a particular event has occurred, a determination that a particular condition is outstanding, and/or a determination that a duration of time associated with the subscription has elapsed (for example, a period associated with a subscription for periodic notifications). As shown in the example illustration of FIG. 2C, NF 252 may send notifications 263, 264 to NFs 251, 253 simultaneously and/or in response to the same condition. However, it will be understood that the NF 252 may provide notifications at different times and/or in response to different notification conditions. In an example, the NF 251 may request a notification when a certain parameter, as measured by the NF 252, exceeds a first threshold, and the NF 252 may request a notification when the parameter exceeds a second threshold different from the first threshold. In an example, a parameter of interest and/or a corresponding threshold may be indicated in the subscriptions 261, 262.

FIG. 2D illustrates another example of a subscribe-notify interaction. In FIG. 2D, an NF 271 sends a subscription 281 to an NF 272. In response to receipt of subscription 281 and/or a determination that a notification condition has occurred, NF 272 may send a notification 284. The notification 284 may be sent to an NF 273. Unlike the example in FIG. 2C (in which a notification is sent to the subscribing NF), FIG. 2D demonstrates that a subscription and its corresponding notification may be associated with different NFs. For example, NF 271 may subscribe to the service provided by NF 272 on behalf of NF 273.

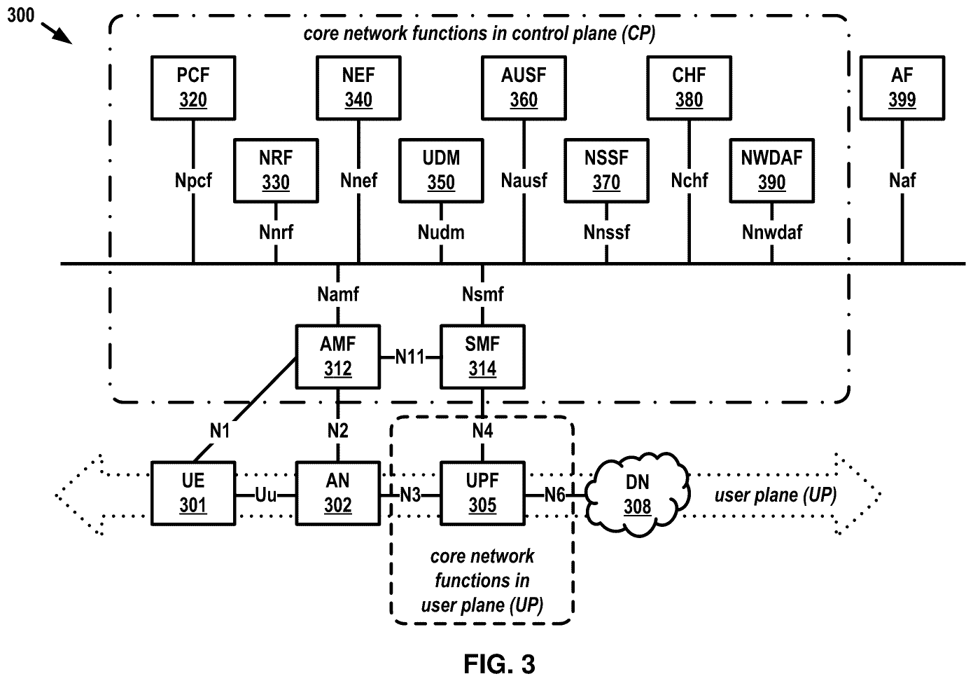

FIG. 3 illustrates another example communication network 300 in which embodiments of the present disclosure may be implemented. Communication network 300 includes a user equipment (UE) 301, an access network (AN) 302, and a data network (DN) 308. The remaining elements depicted in FIG. 3 may be included in and/or associated with a core network. Each element of the core network may be referred to as a network function (NF).

The NFs depicted in FIG. 3 include a user plane function (UPF) 305, an access and mobility management function (AMF) 312, a session management function (SMF) 314, a policy control function (PCF) 320, a network repository function (NRF) 330, a network exposure function (NEF) 340, a unified data management (UDM) 350, an authentication server function (AUSF) 360, a network slice selection function (NSSF) 370, a charging function (CHF) 380, a network data analytics function (NWDAF) 390, and an application function (AF) 399. The UPF 305 may be a user-plane core network function, whereas the NFs 312, 314, and 320-390 may be control-plane core network functions. Although not shown in the example of FIG. 3, the core network may include additional instances of any of the NFs depicted and/or one or more different NF types that provide different services. Other examples of NF type include a gateway mobile location center (GMLC), a location management function (LMF), an operations, administration, and maintenance function (OAM), a public warning system (PWS), a short message service function (SMSF), a unified data repository (UDR), and an unstructured data storage function (UDSF).

Each element depicted in FIG. 3 has an interface with at least one other element. The interface may be a logical connection rather than, for example, a direct physical connection. Any interface may be identified using a reference point representation and/or a service-based representation. In a reference point representation, the letter ‘N’ is followed by a numeral, indicating an interface between two specific elements. For example, as shown in FIG. 3, AN 302 and UPF 305 interface via ‘N3’, whereas UPF 305 and DN 308 interface via ‘N6’. By contrast, in a service-based representation, the letter ‘N’ is followed by letters. The letters identify an NF that provides services to the core network. For example, PCF 320 may provide services via interface ‘Npcf’. The PCF 320 may provide services to any NF in the core network via ‘Npcf’. Accordingly, a service-based representation may correspond to a bundle of reference point representations. For example, the Npcf interface between PCF 320 and the core network generally may correspond to an N7 interface between PCF 320 and SMF 314, an N30 interface between PCF 320 and NEF 340, etc.

The UPF 305 may serve as a gateway for user plane traffic between AN 302 and DN 308. The UE 301 may connect to UPF 305 via a Uu interface and an N3 interface (also described as NG-U interface). The UPF 305 may connect to DN 308 via an N6 interface. The UPF 305 may connect to one or more other UPFs (not shown) via an N9 interface. The UE 301 may be configured to receive services through a protocol data unit (PDU) session, which is a logical connection between UE 301 and DN 308. The UPF 305 (or a plurality of UPFs if desired) may be selected by SMF 314 to handle a particular PDU session between UE 301 and DN 308. The SMF 314 may control the functions of UPF 305 with respect to the PDU session. The SMF 314 may connect to UPF 305 via an N4 interface. The UPF 305 may handle any number of PDU sessions associated with any number of UEs (via any number of ANs). For purposes of handling the one or more PDU sessions, UPF 305 may be controlled by any number of SMFs via any number of corresponding N4 interfaces.

The AMF 312 depicted in FIG. 3 may control UE access to the core network. The UE 301 may register with the network via AMF 312. It may be necessary for UE 301 to register prior to establishing a PDU session. The AMF 312 may manage a registration area of UE 301, enabling the network to track the physical location of UE 301 within the network. For a UE in connected mode, AMF 312 may manage UE mobility, for example, handovers from one AN or portion thereof to another. For a UE in idle mode, AMF 312 may perform registration updates and/or page the UE to transition the UE to connected mode.

The AMF 312 may receive, from UE 301, non-access stratum (NAS) messages transmitted in accordance with NAS protocol. NAS messages relate to communications between UE 301 and the core network. Although NAS messages may be relayed to AMF 312 via AN 302, they may be described as communications via the N1 interface. NAS messages may facilitate UE registration and mobility management, for example, by authenticating, identifying, configuring, and/or managing a connection of UE 301. NAS messages may support session management procedures for maintaining user plane connectivity and quality of service (QOS) of a session between UE 301 and DN 309. If the NAS message involves session management, AMF 312 may send the NAS message to SMF 314. NAS messages may be used to transport messages between UE 301 and other components of the core network (e.g., core network components other than AMF 312 and SMF 314). The AMF 312 may act on a particular NAS message itself, or alternatively, forward the NAS message to an appropriate core network function (e.g., SMF 314, etc.)

The SMF 314 depicted in FIG. 3 may establish, modify, and/or release a PDU session based on messaging received UE 301. The SMF 314 may allocate, manage, and/or assign an IP address to UE 301, for example, upon establishment of a PDU session. There may be multiple SMFs in the network, each of which may be associated with a respective group of wireless devices, base stations, and/or UPFs. A UE with multiple PDU sessions may be associated with a different SMF for each PDU session. As noted above, SMF 314 may select one or more UPFs to handle a PDU session and may control the handling of the PDU session by the selected UPF by providing rules for packet handling (PDR, FAR, QER, etc.). Rules relating to QoS and/or charging for a particular PDU session may be obtained from PCF 320 and provided to UPF 305.

The PCF 320 may provide, to other NFs, services relating to policy rules. The PCF 320 may use subscription data and information about network conditions to determine policy rules and then provide the policy rules to a particular NF which may be responsible for enforcement of those rules. Policy rules may relate to policy control for access and mobility, and may be enforced by the AMF. Policy rules may relate to session management, and may be enforced by the SMF 314. Policy rules may be, for example, network-specific, wireless device-specific, session-specific, or data flow-specific.

The NRF 330 may provide service discovery. The NRF 330 may belong to a particular PLMN. The NRF 330 may maintain NF profiles relating to other NFs in the communication network 300. The NF profile may include, for example, an address, PLMN, and/or type of the NF, a slice identifier, a list of the one or more services provided by the NF, and the authorization required to access the services.

The NEF 340 depicted in FIG. 3 may provide an interface to external domains, permitting external domains to selectively access the control plane of the communication network 300. The external domain may comprise, for example, third-party network functions, application functions, etc. The NEF 340 may act as a proxy between external elements and network functions such as AMF 312, SMF 314, PCF 320, UDM 350, etc. As an example, NEF 340 may determine a location or reachability status of UE 301 based on reports from AMF 312, and provide status information to an external element. As an example, an external element may provide, via NEF 340, information that facilitates the setting of parameters for establishment of a PDU session. The NEF 340 may determine which data and capabilities of the control plane are exposed to the external domain. The NEF 340 may provide secure exposure that authenticates and/or authorizes an external entity to which data or capabilities of the communication network 300 are exposed. The NEF 340 may selectively control the exposure such that the internal architecture of the core network is hidden from the external domain.

The UDM 350 may provide data storage for other NFs. The UDM 350 may permit a consolidated view of network information that may be used to ensure that the most relevant information can be made available to different NFs from a single resource. The UDM 350 may store and/or retrieve information from a unified data repository (UDR). For example, UDM 350 may obtain user subscription data relating to UE 301 from the UDR.

The AUSF 360 may support mutual authentication of UE 301 by the core network and authentication of the core network by UE 301. The AUSF 360 may perform key agreement procedures and provide keying material that can be used to improve security.

The NSSF 370 may select one or more network slices to be used by the UE 301. The NSSF 370 may select a slice based on slice selection information. For example, the NSSF 370 may receive Single Network Slice Selection Assistance Information (S-NSSAI) and map the S-NSSAI to a network slice instance identifier (NSI).

The CHF 380 may control billing-related tasks associated with UE 301. For example, UPF 305 may report traffic usage associated with UE 301 to SMF 314. The SMF 314 may collect usage data from UPF 305 and one or more other UPFs. The usage data may indicate how much data is exchanged, what DN the data is exchanged with, a network slice associated with the data, or any other information that may influence billing. The SMF 314 may share the collected usage data with the CHF. The CHF may use the collected usage data to perform billing-related tasks associated with UE 301. The CHF may, depending on the billing status of UE 301, instruct SMF 314 to limit or influence access of UE 301 and/or to provide billing-related notifications to UE 301.

The NWDAF 390 may collect and analyze data from other network functions and offer data analysis services to other network functions. As an example, NWDAF 390 may collect data relating to a load level for a particular network slice instance from UPF 305, AMF 312, and/or SMF 314. Based on the collected data, NWDAF 390 may provide load level data to the PCF 320 and/or NSSF 370, and/or notify the PC 220 and/or NSSF 370 if load level for a slice reaches and/or exceeds a load level threshold.

The AF 399 may be outside the core network, but may interact with the core network to provide information relating to the QoS requirements or traffic routing preferences associated with a particular application. The AF 399 may access the core network based on the exposure constraints imposed by the NEF 340. However, an operator of the core network may consider the AF 399 to be a trusted domain that can access the network directly.

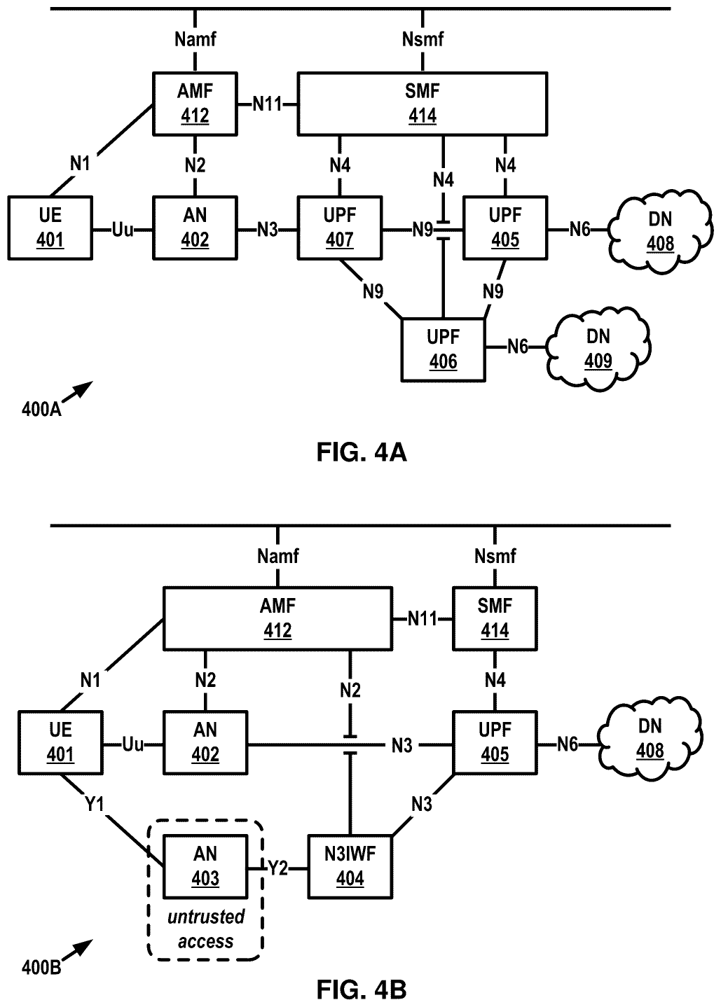

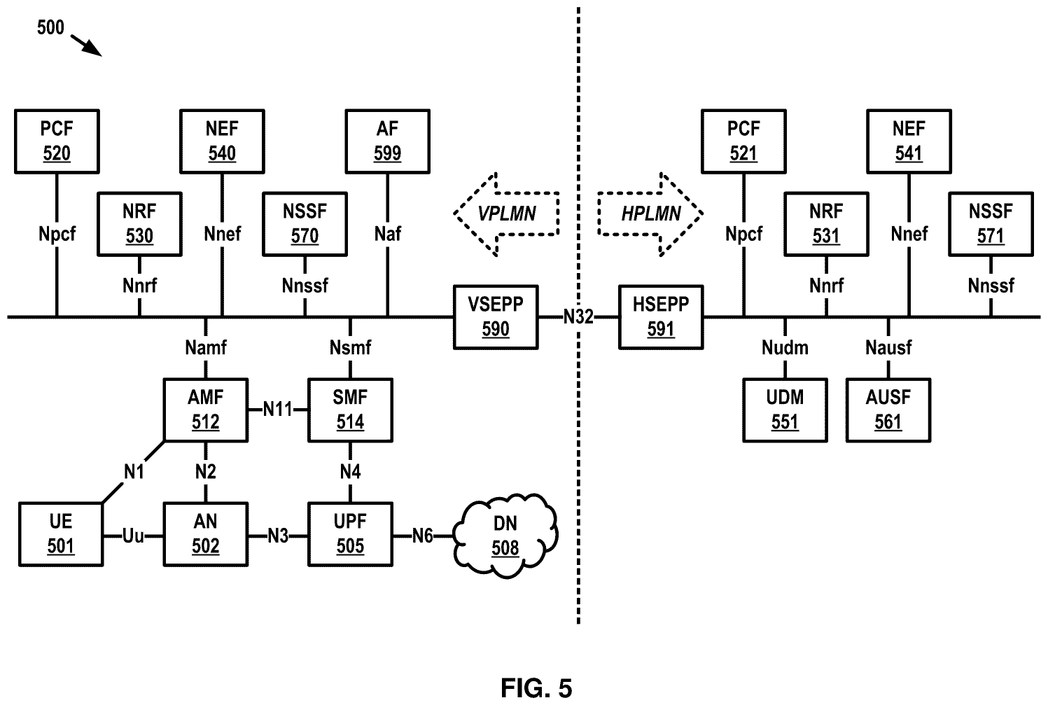

FIGS. 4A, 4B, and 5 illustrate other examples of core network architectures that are analogous in some respects to the core network architecture 300 depicted in FIG. 3. For conciseness, some of the core network elements depicted in FIG. 3 are omitted. Many of the elements depicted in FIGS. 4A, 4B, and 5 are analogous in some respects to elements depicted in FIG. 3. For conciseness, some of the details relating to their functions or operation are omitted.

FIG. 4A illustrates an example of a core network architecture 400A comprising an arrangement of multiple UPFs. Core network architecture 400A includes a UE 401, an AN 402, an AMF 412, and an SMF 414. Unlike previous examples of core network architectures described above, FIG. 4A depicts multiple UPFs, including a UPF 405, a UPF 406, and a UPF 407, and multiple DNs, including a DN 408 and a DN 409. Each of the multiple UPFs 405, 406, 407 may communicate with the SMF 414 via an N4 interface. The DNs 408, 409 communicate with the UPFs 405, 406, respectively, via N6 interfaces. As shown in FIG. 4A, the multiple UPFs 405, 406, 407 may communicate with one another via N9 interfaces.

The UPFs 405, 406, 407 may perform traffic detection, in which the UPFs identify and/or classify packets. Packet identification may be performed based on packet detection rules (PDR) provided by the SMF 414. A PDR may include packet detection information comprising one or more of: a source interface, a UE IP address, core network (CN) tunnel information (e.g., a CN address of an N3/N9 tunnel corresponding to a PDU session), a network instance identifier, a quality of service flow identifier (QFI), a filter set (for example, an IP packet filter set or an ethernet packet filter set), and/or an application identifier.

In addition to indicating how a particular packet is to be detected, a PDR may further indicate rules for handling the packet upon detection thereof. The rules may include, for example, forwarding action rules (FARs), multi-access rules (MARs), usage reporting rules (URRs), QOS enforcement rules (QERs), etc. For example, the PDR may comprise one or more FAR identifiers, MAR identifiers, URR identifiers, and/or QER identifiers. These identifiers may indicate the rules that are prescribed for the handling of a particular detected packet.

The UPF 405 may perform traffic forwarding in accordance with a FAR. For example, the FAR may indicate that a packet associated with a particular PDR is to be forwarded, duplicated, dropped, and/or buffered. The FAR may indicate a destination interface, for example, “access” for downlink or “core” for uplink. If a packet is to be buffered, the FAR may indicate a buffering action rule (BAR). As an example, UPF 405 may perform data buffering of a certain number of downlink packets if a PDU session is deactivated.

The UPF 405 may perform QoS enforcement in accordance with a QER. For example, the QER may indicate a guaranteed bitrate that is authorized and/or a maximum bitrate to be enforced for a packet associated with a particular PDR. The QER may indicate that a particular guaranteed and/or maximum bitrate may be for uplink packets and/or downlink packets. The UPF 405 may mark packets belonging to a particular QoS flow with a corresponding QFI. The marking may enable a recipient of the packet to determine a QoS of the packet.

The UPF 405 may provide usage reports to the SMF 414 in accordance with a URR. The URR may indicate one or more triggering conditions for generation and reporting of the usage report, for example, immediate reporting, periodic reporting, a threshold for incoming uplink traffic, or any other suitable triggering condition. The URR may indicate a method for measuring usage of network resources, for example, data volume, duration, and/or event.

As noted above, the DNs 408, 409 may comprise public DNS (e.g., the Internet), private DNs (e.g., private, internal corporate-owned DNs), and/or intra-operator DNs. Each DN may provide an operator service and/or a third-party service. The service provided by a DN may be the Internet, an IP multimedia sub system (IMS), an augmented or virtual reality network, an edge computing or mobile edge computing (MEC) network, etc. Each DN may be identified using a data network name (DNN). The UE 401 may be configured to establish a first logical connection with DN 408 (a first PDU session), a second logical connection with DN 409 (a second PDU session), or both simultaneously (first and second PDU sessions).

Each PDU session may be associated with at least one UPF configured to operate as a PDU session anchor (PSA, or “anchor”). The anchor may be a UPF that provides an N6 interface with a DN.

In the example of FIG. 4A, UPF 405 may be the anchor for the first PDU session between UE 401 and DN 408, whereas the UPF 406 may be the anchor for the second PDU session between UE 401 and DN 409. The core network may use the anchor to provide service continuity of a particular PDU session (for example, IP address continuity) as UE 401 moves from one access network to another. For example, suppose that UE 401 establishes a PDU session using a data path to the DN 408 using an access network other than AN 402. The data path may include UPF 405 acting as anchor. Suppose further that the UE 401 later moves into the coverage area of the AN 402. In such a scenario, SMF 414 may select a new UPF (UPF 407) to bridge the gap between the newly-entered access network (AN 402) and the anchor UPF (UPF 405). The continuity of the PDU session may be preserved as any number of UPFs are added or removed from the data path. When a UPF is added to a data path, as shown in FIG. 4A, it may be described as an intermediate UPF and/or a cascaded UPF.

As noted above, UPF 406 may be the anchor for the second PDU session between UE 401 and DN 409. Although the anchor for the first and second PDU sessions are associated with different UPFs in FIG. 4A, it will be understood that this is merely an example. It will also be understood that multiple PDU sessions with a single DN may correspond to any number of anchors. When there are multiple UPFs, a UPF at the branching point (UPF 407 in FIG. 4A) may operate as an uplink classifier (UL-CL). The UL-CL may divert uplink user plane traffic to different UPFs.

The SMF 414 may allocate, manage, and/or assign an IP address to UE 401, for example, upon establishment of a PDU session. The SMF 414 may maintain an internal pool of IP addresses to be assigned. The SMF 414 may, if necessary, assign an IP address provided by a dynamic host configuration protocol (DHCP) server or an authentication, authorization, and accounting (AAA) server. IP address management may be performed in accordance with a session and service continuity (SSC) mode. In SSC mode 1, an IP address of UE 401 may be maintained (and the same anchor UPF may be used) as the wireless device moves within the network. In SSC mode 2, the IP address of UE 401 changes as UE 401 moves within the network (e.g., the old IP address and UPF may be abandoned and a new IP address and anchor UPF may be established). In SSC mode 3, it may be possible to maintain an old IP address (similar to SSC mode 1) temporarily while establishing a new IP address (similar to SSC mode 2), thus combining features of SSC modes 1 and 2. Applications that are sensitive to IP address changes may operate in accordance with SSC mode 1.

UPF selection may be controlled by SMF 414. For example, upon establishment and/or modification of a PDU session between UE 401 and DN 408, SMF 414 may select UPF 405 as the anchor for the PDU session and/or UPF 407 as an intermediate UPF. Criteria for UPF selection include path efficiency and/or speed between AN 402 and DN 408. The reliability, load status, location, slice support and/or other capabilities of candidate UPFs may also be considered.

FIG. 4B illustrates an example of a core network architecture 400B that accommodates untrusted access. Similar to FIG. 4A, UE 401 as depicted in FIG. 4B connects to DN 408 via AN 402 and UPF 405. The AN 402 and UPF 405 constitute trusted (e.g., 3GPP) access to the DN 408. By contrast, UE 401 may also access DN 408 using an untrusted access network, AN 403, and a non-3GPP interworking function (N3IWF) 404.

The AN 403 may be, for example, a wireless land area network (WLAN) operating in accordance with the IEEE 802.11 standard. The UE 401 may connect to AN 403, via an interface Y1, in whatever manner is prescribed for AN 403. The connection to AN 403 may or may not involve authentication. The UE 401 may obtain an IP address from AN 403. The UE 401 may determine to connect to core network 400B and select untrusted access for that purpose. The AN 403 may communicate with N3IWF 404 via a Y2 interface. After selecting untrusted access, the UE 401 may provide N3IWF 404 with sufficient information to select an AMF. The selected AMF may be, for example, the same AMF that is used by UE 401 for 3GPP access (AMF 412 in the present example). The N3IWF 404 may communicate with AMF 412 via an N2 interface. The UPF 405 may be selected and N3IWF 404 may communicate with UPF 405 via an N3 interface. The UPF 405 may be a PDU session anchor (PSA) and may remain the anchor for the PDU session even as UE 401 shifts between trusted access and untrusted access.

FIG. 5 illustrates an example of a core network architecture 500 in which a UE 501 is in a roaming scenario. In a roaming scenario, UE 501 is a subscriber of a first PLMN (a home PLMN, or HPLMN) but attaches to a second PLMN (a visited PLMN, or VPLMN). Core network architecture 500 includes UE 501, an AN 502, a UPF 505, and a DN 508. The AN 502 and UPF 505 may be associated with a VPLMN. The VPLMN may manage the AN 502 and UPF 505 using core network elements associated with the VPLMN, including an AMF 512, an SMF 514, a PCF 520, an NRF 530, an NEF 540, and an NSSF 570. An AF 599 may be adjacent the core network of the VPLMN.

The UE 501 may not be a subscriber of the VPLMN. The AMF 512 may authorize UE 501 to access the network based on, for example, roaming restrictions that apply to UE 501. In order to obtain network services provided by the VPLMN, it may be necessary for the core network of the VPLMN to interact with core network elements of a HPLMN of UE 501, in particular, a PCF 521, an NRF 531, an NEF 541, a UDM 551, and/or an AUSF 561. The VPLMN and HPLMN may communicate using an N32 interface connecting respective security edge protection proxies (SEPPs). In FIG. 5, the respective SEPPs are depicted as a VSEPP 590 and an HSEPP 591.

The VSEPP 590 and the HSEPP 591 communicate via an N32 interface for defined purposes while concealing information about each PLMN from the other. The SEPPs may apply roaming policies based on communications via the N32 interface. The PCF 520 and PCF 521 may communicate via the SEPPs to exchange policy-related signaling. The NRF 530 and NRF 531 may communicate via the SEPPs to enable service discovery of NFs in the respective PLMNs. The VPLMN and HPLMN may independently maintain NEF 540 and NEF 541. The NSSF 570 and NSSF 571 may communicate via the SEPPs to coordinate slice selection for UE 501. The HPLMN may handle all authentication and subscription related signaling. For example, when the UE 501 registers or requests service via the VPLMN, the VPLMN may authenticate UE 501 and/or obtain subscription data of UE 501 by accessing, via the SEPPs, the UDM 551 and AUSF 561 of the HPLMN.

The core network architecture 500 depicted in FIG. 5 may be referred to as a local breakout configuration, in which UE 501 accesses DN 508 using one or more UPFs of the VPLMN (i.e., UPF 505). However, other configurations are possible. For example, in a home-routed configuration (not shown in FIG. 5), UE 501 may access a DN using one or more UPFs of the HPLMN. In the home-routed configuration, an N9 interface may run parallel to the N32 interface, crossing the frontier between the VPLMN and the HPLMN to carry user plane data. One or more SMFs of the respective PLMNs may communicate via the N32 interface to coordinate session management for UE 501. The SMFs may control their respective UPFs on either side of the frontier.

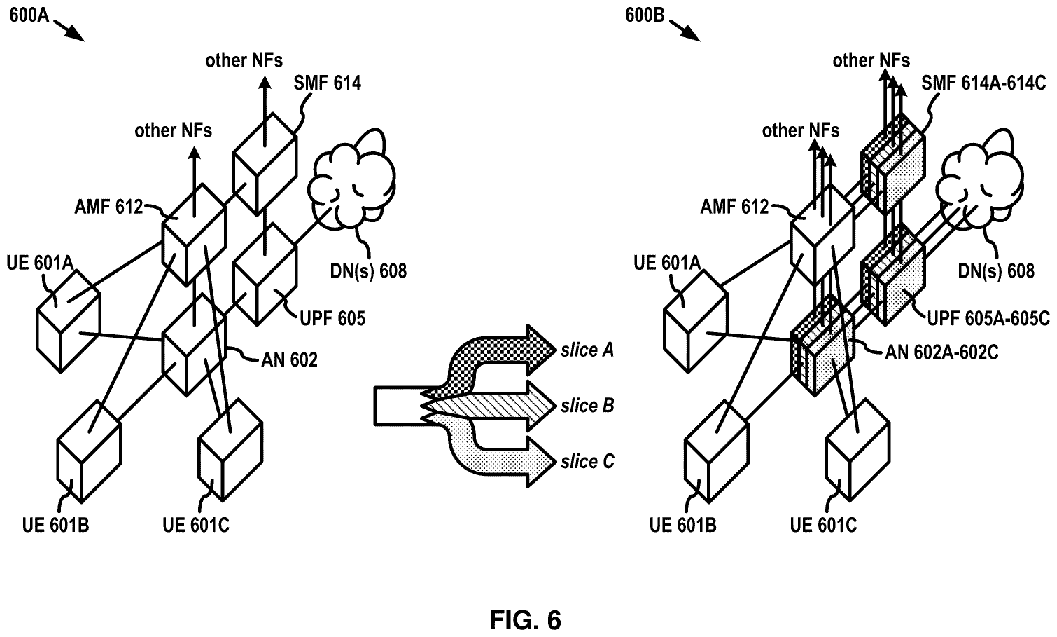

FIG. 6 illustrates an example of network slicing. Network slicing may refer to division of shared infrastructure (e.g., physical infrastructure) into distinct logical networks. These distinct logical networks may be independently controlled, isolated from one another, and/or associated with dedicated resources.

Network architecture 600A illustrates an un-sliced physical network corresponding to a single logical network. The network architecture 600A comprises a user plane wherein UEs 601A, 601B, 601C (collectively, UEs 601) have a physical and logical connection to a DN 608 via an AN 602 and a UPF 605. The network architecture 600A comprises a control plane wherein an AMF 612 and a SMF 614 control various aspects of the user plane.

The network architecture 600A may have a specific set of characteristics (e.g., relating to maximum bit rate, reliability, latency, bandwidth usage, power consumption, etc.). This set of characteristics may be affected by the nature of the network elements themselves (e.g., processing power, availability of free memory, proximity to other network elements, etc.) or the management thereof (e.g., optimized to maximize bit rate or reliability, reduce latency or power bandwidth usage, etc.). The characteristics of network architecture 600A may change over time, for example, by upgrading equipment or by modifying procedures to target a particular characteristic. However, at any given time, network architecture 600A will have a single set of characteristics that may or may not be optimized for a particular use case. For example, UEs 601A, 601B, 601C may have different requirements, but network architecture 600A can only be optimized for one of the three.

Network architecture 600B is an example of a sliced physical network divided into multiple logical networks. In FIG. 6, the physical network is divided into three logical networks, referred to as slice A, slice B, and slice C. For example, UE 601A may be served by AN 602A, UPF 605A, AMF 612, and SMF 614A. UE 601B may be served by AN 602B, UPF 605B, AMF 612, and SMF 614B. UE 601C may be served by AN 602C, UPF 605C, AMF 612, and SMF 614C. Although the respective UEs 601 communicate with different network elements from a logical perspective, these network elements may be deployed by a network operator using the same physical network elements.

Each network slice may be tailored to network services having different sets of characteristics. For example, slice A may correspond to enhanced mobile broadband (eMBB) service. Mobile broadband may refer to internet access by mobile users, commonly associated with smartphones. Slice B may correspond to ultra-reliable low-latency communication (URLLC), which focuses on reliability and speed. Relative to eMBB, URLLC may improve the feasibility of use cases such as autonomous driving and telesurgery. Slice C may correspond to massive machine type communication (mMTC), which focuses on low-power services delivered to a large number of users. For example, slice C may be optimized for a dense network of battery-powered sensors that provide small amounts of data at regular intervals. Many mMTC use cases would be prohibitively expensive if they operated using an eMBB or URLLC network.

If the service requirements for one of the UEs 601 changes, then the network slice serving that UE can be updated to provide better service. Moreover, the set of network characteristics corresponding to eMBB, URLLC, and mMTC may be varied, such that differentiated species of eMBB, URLLC, and mMTC are provided. Alternatively, network operators may provide entirely new services in response to, for example, customer demand.

In FIG. 6, each of the UEs 601 has its own network slice. However, it will be understood that a single slice may serve any number of UEs and a single UE may operate using any number of slices. Moreover, in the example network architecture 600B, the AN 602, UPF 605 and SMF 614 are separated into three separate slices, whereas the AMF 612 is unsliced. However, it will be understood that a network operator may deploy any architecture that selectively utilizes any mix of sliced and unsliced network elements, with different network elements divided into different numbers of slices. Although FIG. 6 only depicts three core network functions, it will be understood that other core network functions may be sliced as well. A PLMN that supports multiple network slices may maintain a separate network repository function (NFR) for each slice, enabling other NFs to discover network services associated with that slice.

Network slice selection may be controlled by an AMF, or alternatively, by a separate network slice selection function (NSSF). For example, a network operator may define and implement distinct network slice instances (NSIs). Each NSI may be associated with single network slice selection assistance information (S-NSSAI). The S-NSSAI may include a particular slice/service type (SST) indicator (indicating eMBB, URLLC, mMTC, etc.). As an example, a particular tracking area may be associated with one or more configured S-NSSAIs. UEs may identify one or more requested and/or subscribed S-NSSAIs (e.g., during registration). The network may indicate to the UE one or more allowed and/or rejected S-NSSAIs.

The S-NSSAI may further include a slice differentiator (SD) to distinguish between different tenants of a particular slice and/or service type. For example, a tenant may be a customer (e.g., vehicle manufacture, service provider, etc.) of a network operator that obtains (for example, purchases) guaranteed network resources and/or specific policies for handling its subscribers. The network operator may configure different slices and/or slice types, and use the SD to determine which tenant is associated with a particular slice.

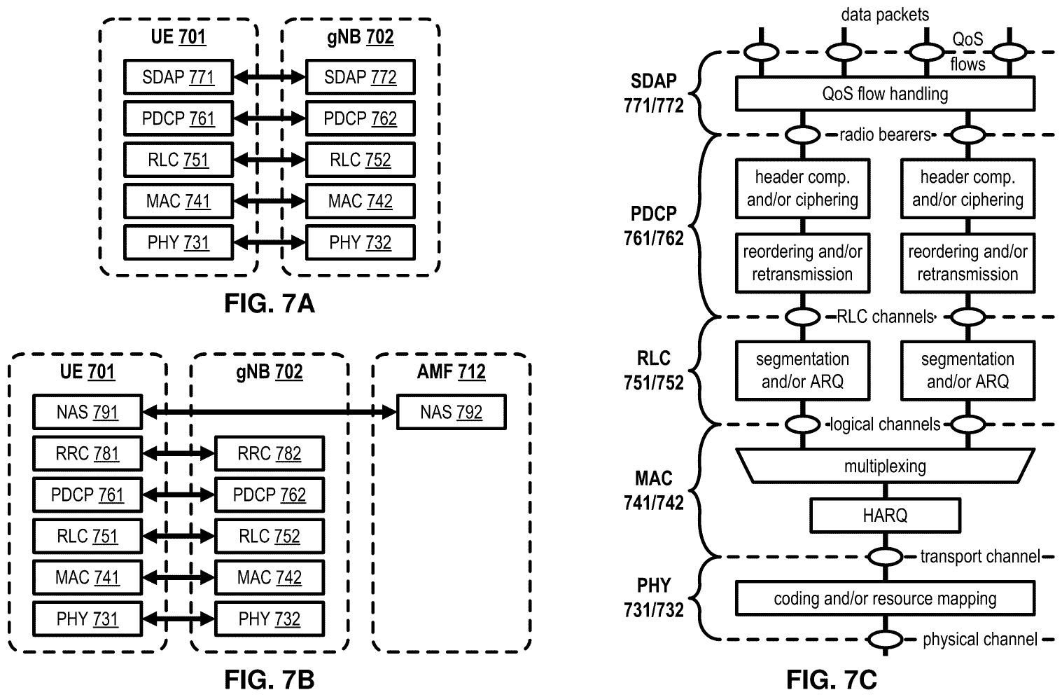

FIG. 7A, FIG. 7B, and FIG. 7C illustrate a user plane (UP) protocol stack, a control plane (CP) protocol stack, and services provided between protocol layers of the UP protocol stack.

The layers may be associated with an open system interconnection (OSI) model of computer networking functionality. In the OSI model, layer 1 may correspond to the bottom layer, with higher layers on top of the bottom layer. Layer 1 may correspond to a physical layer, which is concerned with the physical infrastructure used for transfer of signals (for example, cables, fiber optics, and/or radio frequency transceivers). In New Radio (NR), layer 1 may comprise a physical layer (PHY). Layer 2 may correspond to a data link layer. Layer 2 may be concerned with packaging of data (into, e.g., data frames) for transfer, between nodes of the network, using the physical infrastructure of layer 1. In NR, layer 2 may comprise a media access control layer (MAC), a radio link control layer (RLC), a packet data convergence layer (PDCP), and a service data application protocol layer (SDAP).

Layer 3 may correspond to a network layer. Layer 3 may be concerned with routing of the data which has been packaged in layer 2. Layer 3 may handle prioritization of data and traffic avoidance. In NR, layer 3 may comprise a radio resource control layer (RRC) and a non-access stratum layer (NAS). Layers 4 through 7 may correspond to a transport layer, a session layer, a presentation layer, and an application layer. The application layer interacts with an end user to provide data associated with an application. In an example, an end user implementing the application may generate data associated with the application and initiate sending of that information to a targeted data network (e.g., the Internet, an application server, etc.). Starting at the application layer, each layer in the OSI model may manipulate and/or repackage the information and deliver it to a lower layer. At the lowest layer, the manipulated and/or repackaged information may be exchanged via physical infrastructure (for example, electrically, optically, and/or electromagnetically). As it approaches the targeted data network, the information will be unpackaged and provided to higher and higher layers, until it once again reaches the application layer in a form that is usable by the targeted data network (e.g., the same form in which it was provided by the end user). To respond to the end user, the data network may perform this procedure in reverse.

FIG. 7A illustrates a user plane protocol stack. The user plane protocol stack may be a new radio (NR) protocol stack for a Uu interface between a UE 701 and a gNB 702. In layer 1 of the UP protocol stack, the UE 701 may implement PHY 731 and the gNB 702 may implement PHY 732. In layer 2 of the UP protocol stack, the UE 701 may implement MAC 741, RLC 751, PDCP 761, and SDAP 771. The gNB 702 may implement MAC 742, RLC 752, PDCP 762, and SDAP 772.

FIG. 7B illustrates a control plane protocol stack. The control plane protocol stack may be an NR protocol stack for the Uu interface between the UE 701 and the gNB 702 and/or an N1 interface between the UE 701 and an AMF 712. In layer 1 of the CP protocol stack, the UE 701 may implement PHY 731 and the gNB 702 may implement PHY 732. In layer 2 of the CP protocol stack, the UE 701 may implement MAC 741, RLC 751, PDCP 761, RRC 781, and NAS 791. The gNB 702 may implement MAC 742, RLC 752, PDCP 762, and RRC 782. The AMF 712 may implement NAS 792.

The NAS may be concerned with the non-access stratum, in particular, communication between the UE 701 and the core network (e.g., the AMF 712). Lower layers may be concerned with the access stratum, for example, communication between the UE 701 and the gNB 702. Messages sent between the UE 701 and the core network may be referred to as NAS messages. In an example, a NAS message may be relayed by the gNB 702, but the content of the NAS message (e.g., information elements of the NAS message) may not be visible to the gNB 702.

FIG. 7C illustrates an example of services provided between protocol layers of the NR user plane protocol stack illustrated in FIG. 7A. The UE 701 may receive services through a PDU session, which may be a logical connection between the UE 701 and a data network (DN). The UE 701 and the DN may exchange data packets associated with the PDU session. The PDU session may comprise one or more quality of service (QOS) flows. SDAP 771 and SDAP 772 may perform mapping and/or demapping between the one or more QoS flows of the PDU session and one or more radio bearers (e.g., data radio bearers). The mapping between the QoS flows and the data radio bearers may be determined in the SDAP 772 by the gNB 702, and the UE 701 may be notified of the mapping (e.g., based on control signaling and/or reflective mapping). For reflective mapping, the SDAP 772 of the gNB 220 may mark downlink packets with a QoS flow indicator (QFI) and deliver the downlink packets to the UE 701. The UE 701 may determine the mapping based on the QFI of the downlink packets.

PDCP 761 and PDCP 762 may perform header compression and/or decompression. Header compression may reduce the amount of data transmitted over the physical layer. The PDCP 761 and PDCP 762 may perform ciphering and/or deciphering. Ciphering may reduce unauthorized decoding of data transmitted over the physical layer (e.g., intercepted on an air interface), and protect data integrity (e.g., to ensure control messages originate from intended sources). The PDCP 761 and PDCP 762 may perform retransmissions of undelivered packets, in-sequence delivery and reordering of packets, duplication of packets, and/or identification and removal of duplicate packets. In a dual connectivity scenario, PDCP 761 and PDCP 762 may perform mapping between a split radio bearer and RLC channels.

RLC 751 and RLC 752 may perform segmentation, retransmission through Automatic Repeat Request (ARQ). The RLC 751 and RLC 752 may perform removal of duplicate data units received from MAC 741 and MAC 742, respectively. The RLCs 213 and 223 may provide RLC channels as a service to PDCPs 214 and 224, respectively.

MAC 741 and MAC 742 may perform multiplexing and/or demultiplexing of logical channels. MAC 741 and MAC 742 may map logical channels to transport channels. In an example, UE 701 may, in MAC 741, multiplex data units of one or more logical channels into a transport block. The UE 701 may transmit the transport block to the gNB 702 using PHY 731. The gNB 702 may receive the transport block using PHY 732 and demultiplex data units of the transport blocks back into logical channels. MAC 741 and MAC 742 may perform error correction through Hybrid Automatic Repeat Request (HARQ), logical channel prioritization, and/or padding.

PHY 731 and PHY 732 may perform mapping of transport channels to physical channels. PHY 731 and PHY 732 may perform digital and analog signal processing functions (e.g., coding/decoding and modulation/demodulation) for sending and receiving information (e.g., transmission via an air interface). PHY 731 and PHY 732 may perform multi-antenna mapping.

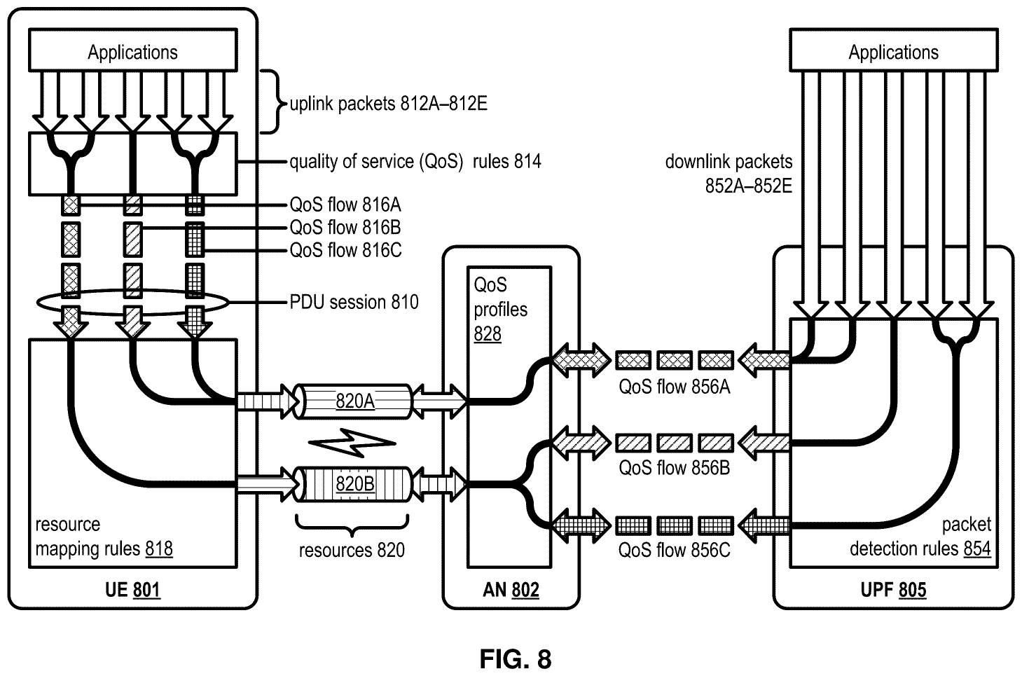

FIG. 8 illustrates an example of a quality of service (QOS) model for differentiated data exchange. In the QoS model of FIG. 8, there are a UE 801, a AN 802, and a UPF 805. The QoS model facilitates prioritization of certain packet or protocol data units (PDUs), also referred to as packets. For example, higher-priority packets may be exchanged faster and/or more reliably than lower-priority packets. The network may devote more resources to exchange of high-QoS packets.

In the example of FIG. 8, a PDU session 810 is established between UE 801 and UPF 805. The PDU session 810 may be a logical connection enabling the UE 801 to exchange data with a particular data network (for example, the Internet). The UE 801 may request establishment of the PDU session 810. At the time that the PDU session 810 is established, the UE 801 may, for example, identify the targeted data network based on its data network name (DNN). The PDU session 810 may be managed, for example, by a session management function (SMF, not shown). In order to facilitate exchange of data associated with the PDU session 810, between the UE 801 and the data network, the SMF may select the UPF 805 (and optionally, one or more other UPFs, not shown).

One or more applications associated with UE 801 may generate uplink packets 812A-812E associated with the PDU session 810. In order to work within the QoS model, UE 801 may apply QoS rules 814 to uplink packets 812A-812E. The QoS rules 814 may be associated with PDU session 810 and may be determined and/or provided to the UE 801 when PDU session 810 is established and/or modified. Based on QoS rules 814, UE 801 may classify uplink packets 812A-812E, map each of the uplink packets 812A-812E to a QoS flow, and/or mark uplink packets 812A-812E with a QoS flow indicator (QFI). As a packet travels through the network, and potentially mixes with other packets from other UEs having potentially different priorities, the QFI indicates how the packet should be handled in accordance with the QoS model. In the present illustration, uplink packets 812A, 812B are mapped to QoS flow 816A, uplink packet 812C is mapped to QoS flow 816B, and the remaining packets are mapped to QoS flow 816C.

The QoS flows may be the finest granularity of QoS differentiation in a PDU session. In the figure, three QoS flows 816A-816C are illustrated. However, it will be understood that there may be any number of QoS flows. Some QoS flows may be associated with a guaranteed bit rate (GBR QoS flows) and others may have bit rates that are not guaranteed (non-GBR QoS flows). QoS flows may also be subject to per-UE and per-session aggregate bit rates. One of the QoS flows may be a default QoS flow. The QoS flows may have different priorities. For example, QoS flow 816A may have a higher priority than QoS flow 816B, which may have a higher priority than QoS flow 816C. Different priorities may be reflected by different QoS flow characteristics. For example, QoS flows may be associated with flow bit rates. A particular QoS flow may be associated with a guaranteed flow bit rate (GFBR) and/or a maximum flow bit rate (MFBR). QoS flows may be associated with specific packet delay budgets (PDBs), packet error rates (PERs), and/or maximum packet loss rates. QoS flows may also be subject to per-UE and per-session aggregate bit rates.

In order to work within the QoS model, UE 801 may apply resource mapping rules 818 to the QoS flows 816A-816C. The air interface between UE 801 and AN 802 may be associated with resources 820. In the present illustration, QoS flow 816A is mapped to resource 820A, whereas QoS flows 816B, 816C are mapped to resource 820B. The resource mapping rules 818 may be provided by the AN 802. In order to meet QoS requirements, the resource mapping rules 818 may designate more resources for relatively high-priority QoS flows. With more resources, a high-priority QoS flow such as QoS flow 816A may be more likely to obtain the high flow bit rate, low packet delay budget, or other characteristic associated with QoS rules 814. The resources 820 may comprise, for example, radio bearers. The radio bearers (e.g., data radio bearers) may be established between the UE 801 and the AN 802. The radio bearers in 5G, between the UE 801 and the AN 802, may be distinct from bearers in LTE, for example, Evolved Packet System (EPS) bearers between a UE and a packet data network gateway (PGW), S1 bearers between an eNB and a serving gateway (SGW), and/or an S5/S8 bearer between an SGW and a PGW.

Once a packet associated with a particular QoS flow is received at AN 802 via resource 820A or resource 820B, AN 802 may separate packets into respective QoS flows 856A-856C based on QoS profiles 828. The QoS profiles 828 may be received from an SMF. Each QoS profile may correspond to a QFI, for example, the QFI marked on the uplink packets 812A-812E. Each QoS profile may include QoS parameters such as 5G QoS identifier (5QI) and an allocation and retention priority (ARP). The QoS profile for non-GBR QoS flows may further include additional QoS parameters such as a reflective QoS attribute (RQA). The QoS profile for GBR QoS flows may further include additional QoS parameters such as a guaranteed flow bit rate (GFBR), a maximum flow bit rate (MFBR), and/or a maximum packet loss rate. The 5QI may be a standardized 5QI which has one-to-one mapping to a standardized combination of 5G QoS characteristics per well-known services. The 5QI may be a dynamically assigned 5QI which the standardized 5QI values are not defined. The 5QI may represent 5G QoS characteristics. The 5QI may comprise a resource type, a default priority level, a packet delay budget (PDB), a packet error rate (PER), a maximum data burst volume, and/or an averaging window. The resource type may indicate a non-GBR QoS flow, a GBR QoS flow or a delay-critical GBR QoS flow. The averaging window may represent a duration over which the GFBR and/or MFBR is calculated. ARP may be a priority level comprising pre-emption capability and a pre-emption vulnerability. Based on the ARP, the AN 802 may apply admission control for the QoS flows in a case of resource limitations.

The AN 802 may select one or more N3 tunnels 850 for transmission of the QoS flows 856A-856C. After the packets are divided into QoS flows 856A-856C, the packet may be sent to UPF 805 (e.g., towards a DN) via the selected one or more N3 tunnels 850. The UPF 805 may verify that the QFIs of the uplink packets 812A-812E are aligned with the QoS rules 814 provided to the UE 801. The UPF 805 may measure and/or count packets and/or provide packet metrics to, for example, a PCF.

The figure also illustrates a process for downlink. In particular, one or more applications may generate downlink packets 852A-852E. The UPF 805 may receive downlink packets 852A-852E from one or more DNs and/or one or more other UPFs. As per the QoS model, UPF 805 may apply packet detection rules (PDRs) 854 to downlink packets 852A-852E. Based on PDRs 854, UPF 805 may map packets 852A-852E into QoS flows. In the present illustration, downlink packets 852A, 852B are mapped to QoS flow 856A, downlink packet 852C is mapped to QoS flow 856B, and the remaining packets are mapped to QoS flow 856C.

The QoS flows 856A-856C may be sent to AN 802. The AN 802 may apply resource mapping rules to the QoS flows 856A-856C. In the present illustration, QoS flow 856A is mapped to resource 820A, whereas QoS flows 856B, 856C are mapped to resource 820B. In order to meet QoS requirements, the resource mapping rules may designate more resources to high-priority QoS flows.

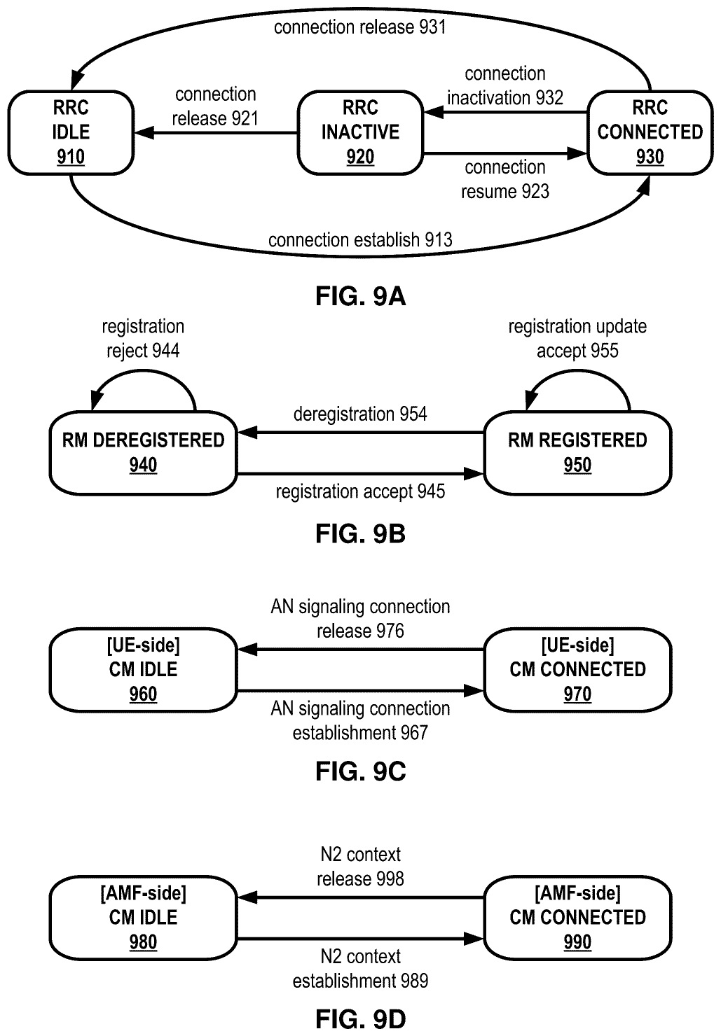

FIGS. 9A-9D illustrate example states and state transitions of a wireless device (e.g., a UE). At any given time, the wireless device may have a radio resource control (RRC) state, a registration management (RM) state, and a connection management (CM) state.

FIG. 9A is an example diagram showing RRC state transitions of a wireless device (e.g., a UE). The UE may be in one of three RRC states: RRC idle 910, (e.g., RRC_IDLE), RRC inactive 920 (e.g., RRC_INACTIVE), or RRC connected 930 (e.g., RRC_CONNECTED). The UE may implement different RAN-related control-plane procedures depending on its RRC state. Other elements of the network, for example, a base station, may track the RRC state of one or more UEs and implement RAN-related control-plane procedures appropriate to the RRC state of each.

In RRC connected 930, it may be possible for the UE to exchange data with the network (for example, the base station). The parameters necessary for exchange of data may be established and known to both the UE and the network. The parameters may be referred to and/or included in an RRC context of the UE (sometimes referred to as a UE context). These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. The base station with which the UE is connected may store the RRC context of the UE.

While in RRC connected 930, mobility of the UE may be managed by the access network, whereas the UE itself may manage mobility while in RRC idle 910 and/or RRC inactive 920. While in RRC connected 930, the UE may manage mobility by measuring signal levels (e.g., reference signal levels) from a serving cell and neighboring cells and reporting these measurements to the base station currently serving the UE. The network may initiate handover based on the reported measurements. The RRC state may transition from RRC connected 930 to RRC idle 910 through a connection release procedure 930 or to RRC inactive 920 through a connection inactivation procedure 932.

In RRC idle 910, an RRC context may not be established for the UE. In RRC idle 910, the UE may not have an RRC connection with a base station. While in RRC idle 910, the UE may be in a sleep state for a majority of the time (e.g., to conserve battery power). The UE may wake up periodically (e.g., once in every discontinuous reception cycle) to monitor for paging messages from the access network. Mobility of the UE may be managed by the UE through a procedure known as cell reselection. The RRC state may transition from RRC idle 910 to RRC connected 930 through a connection establishment procedure 913, which may involve a random access procedure, as discussed in greater detail below.

In RRC inactive 920, the RRC context previously established is maintained in the UE and the base station. This may allow for a fast transition to RRC connected 930 with reduced signaling overhead as compared to the transition from RRC idle 910 to RRC connected 930. The RRC state may transition to RRC connected 930 through a connection resume procedure 923. The RRC state may transition to RRC idle 910 though a connection release procedure 921 that may be the same as or similar to connection release procedure 931.

An RRC state may be associated with a mobility management mechanism. In RRC idle 910 and RRC inactive 920, mobility may be managed by the UE through cell reselection. The purpose of mobility management in RRC idle 910 and/or RRC inactive 920 is to allow the network to be able to notify the UE of an event via a paging message without having to broadcast the paging message over the entire mobile communications network. The mobility management mechanism used in RRC idle 910 and/or RRC inactive 920 may allow the network to track the UE on a cell-group level so that the paging message may be broadcast over the cells of the cell group that the UE currently resides within instead of the entire communication network. Tracking may be based on different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 920 state, the UE may be assigned a RAN notification area. A RAN notification area may comprise one or more cell identities, a list of RAIs, and/or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 920.

FIG. 9B is an example diagram showing registration management (RM) state transitions of a wireless device (e.g., a UE). The states are RM deregistered 940, (e.g., RM-DEREGISTERED) and RM registered 950 (e.g., RM-REGISTERED).

In RM deregistered 940, the UE is not registered with the network, and the UE is not reachable by the network. In order to be reachable by the network, the UE must perform an initial registration. As an example, the UE may register with an AMF of the network. If registration is rejected (registration reject 944), then the UE remains in RM deregistered 940. If registration is accepted (registration accept 945), then the UE transitions to RM registered 950. While the UE is RM registered 950, the network may store, keep, and/or maintain a UE context for the UE. The UE context may be referred to as wireless device context. The UE context corresponding to network registration (maintained by the core network) may be different from the RRC context corresponding to RRC state (maintained by an access network, e.g., a base station). The UE context may comprise a UE identifier and a record of various information relating to the UE, for example, UE capability information, policy information for access and mobility management of the UE, lists of allowed or established slices or PDU sessions, and/or a registration area of the UE (i.e., a list of tracking areas covering the geographical area where the wireless device is likely to be found).

While the UE is RM registered 950, the network may store the UE context of the UE, and if necessary, use the UE context to reach the UE. Moreover, some services may not be provided by the network unless the UE is registered. The UE may update its UE context while remaining in RM registered 950 (registration update accept 955). For example, if the UE leaves one tracking area and enters another tracking area, the UE may provide a tracking area identifier to the network. The network may deregister the UE, or the UE may deregister itself (deregistration 954). For example, the network may automatically deregister the wireless device if the wireless device is inactive for a certain amount of time. Upon deregistration, the UE may transition to RM deregistered 940.

FIG. 9C is an example diagram showing connection management (CM) state transitions of a wireless device (e.g., a UE), shown from a perspective of the wireless device. The UE may be in CM idle 960 (e.g., CM-IDLE) or CM connected 970 (e.g., CM-CONNECTED).

In CM idle 960, the UE does not have a non access stratum (NAS) signaling connection with the network. As a result, the UE cannot communicate with core network functions. The UE may transition to CM connected 970 by establishing an AN signaling connection (AN signaling connection establishment 967). This transition may be initiated by sending an initial NAS message. The initial NAS message may be a registration request (e.g., if the UE is RM deregistered 940) or a service request (e.g., if the UE is RM registered 950). If the UE is RM registered 950, then the UE may initiate the AN signaling connection establishment by sending a service request, or the network may send a page, thereby triggering the UE to send the service request.

In CM connected 970, the UE can communicate with core network functions using NAS signaling. As an example, the UE may exchange NAS signaling with an AMF for registration management purposes, service request procedures, and/or authentication procedures. As another example, the UE may exchange NAS signaling, with an SMF, to establish and/or modify a PDU session. The network may disconnect the UE, or the UE may disconnect itself (AN signaling connection release 976). For example, if the UE transitions to RM deregistered 940, then the UE may also transition to CM idle 960. When the UE transitions to CM idle 960, the network may deactivate a user plane connection of a PDU session of the UE.

FIG. 9D is an example diagram showing CM state transitions of the wireless device (e.g., a UE), shown from a network perspective (e.g., an AMF). The CM state of the UE, as tracked by the AMF, may be in CM idle 980 (e.g., CM-IDLE) or CM connected 990 (e.g., CM-CONNECTED). When the UE transitions from CM idle 980 to CM connected 990, the AMF many establish an N2 context of the UE (N2 context establishment 989). When the UE transitions from CM connected 990 to CM idle 980, the AMF may release the N2 context of the UE (N2 context release 998).

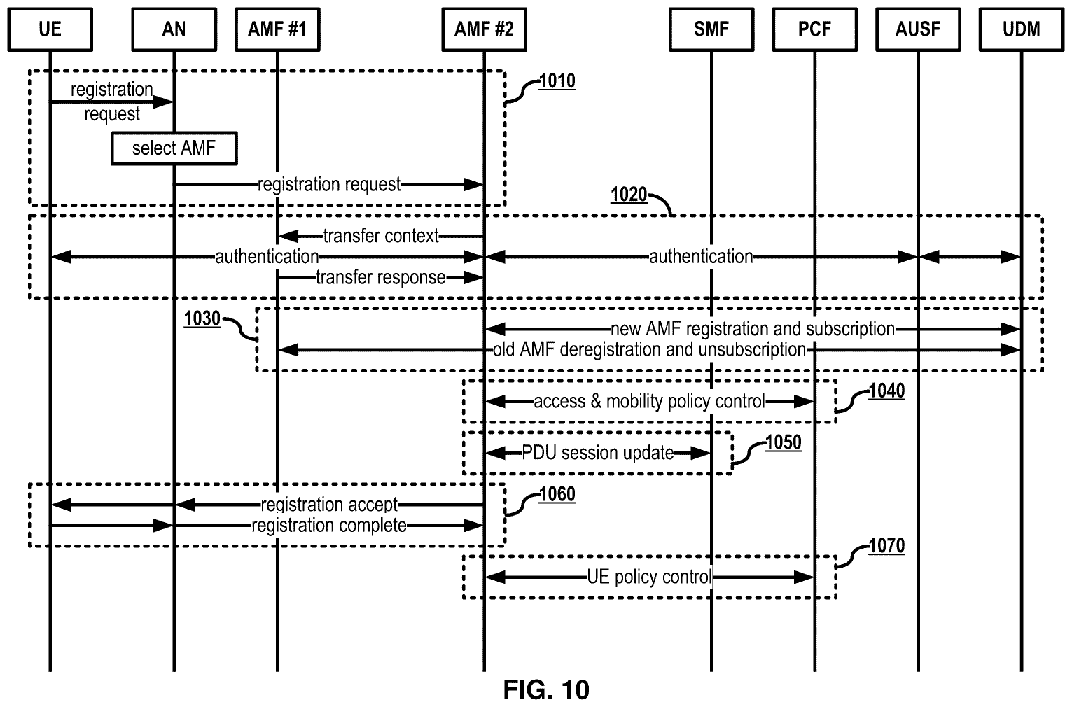

FIGS. 10-12 illustrate example procedures for registering, service request, and PDU session establishment of a UE.

FIG. 10 illustrates an example of a registration procedure for a wireless device (e.g., a UE). Based on the registration procedure, the UE may transition from, for example, RM deregistered 940 to RM registered 950.

Registration may be initiated by a UE for the purposes of obtaining authorization to receive services, enabling mobility tracking, enabling reachability, or other purposes. The UE may perform an initial registration as a first step toward connection to the network (for example, if the UE is powered on, airplane mode is turned off, etc.). Registration may also be performed periodically to keep the network informed of the UE's presence (for example, while in CM-IDLE state), or in response to a change in UE capability or registration area. Deregistration (not shown in FIG. 10) may be performed to stop network access.

At 1010, the UE transmits a registration request to an AN. As an example, the UE may have moved from a coverage area of a previous AMF (illustrated as AMF #1) into a coverage area of a new AMF (illustrated as AMF #2). The registration request may be a NAS message. The registration request may include a UE identifier. The AN may select an AMF for registration of the UE. For example, the AN may select a default AMF. For example, the AN may select an AMF that is already mapped to the UE (e.g., a previous AMF). The NAS registration request may include a network slice identifier and the AN may select an AMF based on the requested slice. After the AMF is selected, the AN may send the registration request to the selected AMF.

At 1020, the AMF that receives the registration request (AMF #2) performs a context transfer. The context may be a UE context, for example, an RRC context for the UE. As an example, AMF #2 may send AMF #1 a message requesting a context of the UE. The message may include the UE identifier. The message may be a Namf_Communication_UEContextTransfer message. AMF #1 may send to AMF #2 a message that includes the requested UE context. This message may be a Namf_Communication_UEContextTransfer message. After the UE context is received, the AMF #2 may coordinate authentication of the UE. After authentication is complete, AMF #2 may send to AMF #1 a message indicating that the UE context transfer is complete. This message may be a Namf_Communication_UEContextTransfer Response message.

Authentication may require participation of the UE, an AUSF, a UDM and/or a UDR (not shown). For example, the AMF may request that the AUSF authenticate the UE. For example, the AUSF may execute authentication of the UE. For example, the AUSF may get authentication data from UDM. For example, the AUSF may send a subscription permanent identifier (SUPI) to the AMF based on the authentication being successful. For example, the AUSF may provide an intermediate key to the AMF. The intermediate key may be used to derive an access-specific security key for the UE, enabling the AMF to perform security context management (SCM). The AUSF may obtain subscription data from the UDM. The subscription data may be based on information obtained from the UDM (and/or the UDR). The subscription data may include subscription identifiers, security credentials, access and mobility related subscription data and/or session related data.

At 1030, the new AMF, AMF #2, registers and/or subscribes with the UDM. AMF #2 may perform registration using a UE context management service of the UDM (Nudm_UECM). AMF #2 may obtain subscription information of the UE using a subscriber data management service of the UDM (Nudm_SDM). AMF #2 may further request that the UDM notify AMF #2 if the subscription information of the UE changes. As the new AMF registers and subscribes, the old AMF, AMF #1, may deregister and unsubscribe. After deregistration, AMF #1 is free of responsibility for mobility management of the UE.

At 1040, AMF #2 retrieves access and mobility (AM) policies from the PCF. As an example, the AMF #2 may provide subscription data of the UE to the PCF. The PCF may determine access and mobility policies for the UE based on the subscription data, network operator data, current network conditions, and/or other suitable information. For example, the owner of a first UE may purchase a higher level of service than the owner of a second UE. The PCF may provide the rules associated with the different levels of service. Based on the subscription data of the respective UEs, the network may apply different policies which facilitate different levels of service.

For example, access and mobility policies may relate to service area restrictions, RAT/frequency selection priority (RFSP, where RAT stands for radio access technology), authorization and prioritization of access type (e.g., LTE versus NR), and/or selection of non-3GPP access (e.g., Access Network Discovery and Selection Policy (ANDSP)). The service area restrictions may comprise a list of tracking areas where the UE is allowed to be served (or forbidden from being served). The access and mobility policies may include a UE route selection policy (URSP)) that influences routing to an established PDU session or a new PDU session. As noted above, different policies may be obtained and/or enforced based on subscription data of the UE, location of the UE (i.e., location of the AN and/or AMF), or other suitable factors.

At 1050, AMF #2 may update a context of a PDU session. For example, if the UE has an existing PDU session, the AMF #2 may coordinate with an SMF to activate a user plane connection associated with the existing PDU session. The SMF may update and/or release a session management context of the PDU session (Nsmf_PDUSession_UpdateSMContext, Nsmf_PDUSession_ReleaseSMContext).

At 1060, AMF #2 sends a registration accept message to the AN, which forwards the registration accept message to the UE. The registration accept message may include a new UE identifier and/or a new configured slice identifier. The UE may transmit a registration complete message to the AN, which forwards the registration complete message to the AMF #2. The registration complete message may acknowledge receipt of the new UE identifier and/or new configured slice identifier.

At 1070, AMF #2 may obtain UE policy control information from the PCF. The PCF may provide an access network discovery and selection policy (ANDSP) to facilitate non-3GPP access. The PCF may provide a UE route selection policy (URSP) to facilitate mapping of particular data traffic to particular PDU session connectivity parameters. As an example, the URSP may indicate that data traffic associated with a particular application should be mapped to a particular SSC mode, network slice, PDU session type, or preferred access type (3GPP or non-3GPP).

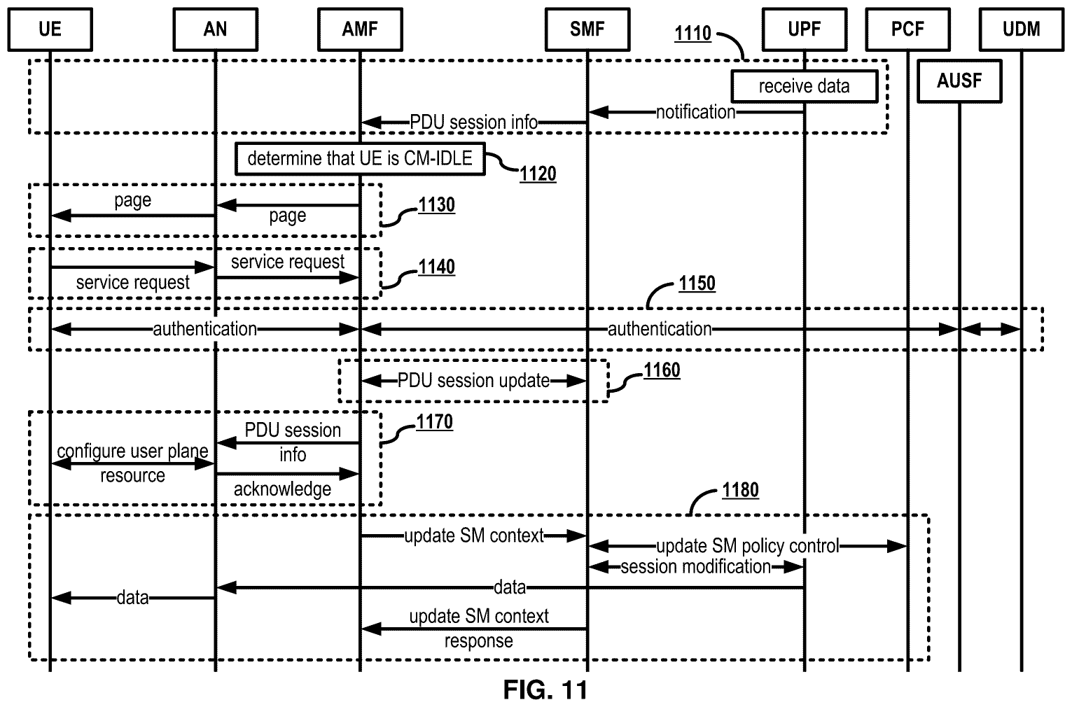

FIG. 11 illustrates an example of a service request procedure for a wireless device (e.g., a UE). The service request procedure depicted in FIG. 11 is a network-triggered service request procedure for a UE in a CM-IDLE state. However, other service request procedures (e.g., a UE-triggered service request procedure) may also be understood by reference to FIG. 11, as will be discussed in greater detail below.

At 1110, a UPF receives data. The data may be downlink data for transmission to a UE. The data may be associated with an existing PDU session between the UE and a DN. The data may be received, for example, from a DN and/or another UPF. The UPF may buffer the received data. In response to the receiving of the data, the UPF may notify an SMF of the received data. The identity of the SMF to be notified may be determined based on the received data. The notification may be, for example, an N4 session report. The notification may indicate that the UPF has received data associated with the UE and/or a particular PDU session associated with the UE. In response to receiving the notification, the SMF may send PDU session information to an AMF. The PDU session information may be sent in an N1N2 message transfer for forwarding to an AN. The PDU session information may include, for example, UPF tunnel endpoint information and/or QoS information.

At 1120, the AMF determines that the UE is in a CM-IDLE state. The determining at 1120 may be in response to the receiving of the PDU session information. Based on the determination that the UE is CM-IDLE, the service request procedure may proceed to 1130 and 1140, as depicted in FIG. 11. However, if the UE is not CM-IDLE (e.g., the UE is CM-CONNECTED), then 1130 and 1140 may be skipped, and the service request procedure may proceed directly to 1150.

At 1130, the AMF pages the UE. The paging at 1130 may be performed based on the UE being CM-IDLE. To perform the paging, the AMF may send a page to the AN. The page may be referred to as a paging or a paging message. The page may be an N2 request message. The AN may be one of a plurality of ANs in a RAN notification area of the UE. The AN may send a page to the UE. The UE may be in a coverage area of the AN and may receive the page.

At 1140, the UE may request service. The UE may transmit a service request to the AMF via the AN. As depicted in FIG. 11, the UE may request service at 1140 in response to receiving the paging at 1130. However, as noted above, this is for the specific case of a network-triggered service request procedure. In some scenarios (for example, if uplink data becomes available at the UE), then the UE may commence a UE-triggered service request procedure. The UE-triggered service request procedure may commence starting at 1140.

At 1150, the network may authenticate the UE. Authentication may require participation of the UE, an AUSF, and/or a UDM, for example, similar to authentication described elsewhere in the present disclosure. In some cases (for example, if the UE has recently been authenticated), the authentication at 1150 may be skipped.

At 1160, the AMF and SMF may perform a PDU session update. As part of the PDU session update, the SMF may provide the AMF with one or more UPF tunnel endpoint identifiers. In some cases (not shown in FIG. 11), it may be necessary for the SMF to coordinate with one or more other SMFs and/or one or more other UPFs to set up a user plane.

At 1170, the AMF may send PDU session information to the AN. The PDU session information may be included in an N2 request message. Based on the PDU session information, the AN may configure a user plane resource for the UE. To configure the user plane resource, the AN may, for example, perform an RRC reconfiguration of the UE. The AN may acknowledge to the AMF that the PDU session information has been received. The AN may notify the AMF that the user plane resource has been configured, and/or provide information relating to the user plane resource configuration.

In the case of a UE-triggered service request procedure, the UE may receive, at 1170, a NAS service accept message from the AMF via the AN. After the user plane resource is configured, the UE may transmit uplink data (for example, the uplink data that caused the UE to trigger the service request procedure).

At 1180, the AMF may update a session management (SM) context of the PDU session. For example, the AMF may notify the SMF (and/or one or more other associated SMFs) that the user plane resource has been configured, and/or provide information relating to the user plane resource configuration. The AMF may provide the SMF (and/or one or more other associated SMFs) with one or more AN tunnel endpoint identifiers of the AN. After the SM context update is complete, the SMF may send an update SM context response message to the AMF.

Based on the update of the session management context, the SMF may update a PCF for purposes of policy control. For example, if a location of the UE has changed, the SMF may notify the PCF of the UE's a new location.

Based on the update of the session management context, the SMF and UPF may perform a session modification. The session modification may be performed using N4 session modification messages. After the session modification is complete, the UPF may transmit downlink data (for example, the downlink data that caused the UPF to trigger the network-triggered service request procedure) to the UE. The transmitting of the downlink data may be based on the one or more AN tunnel endpoint identifiers of the AN.

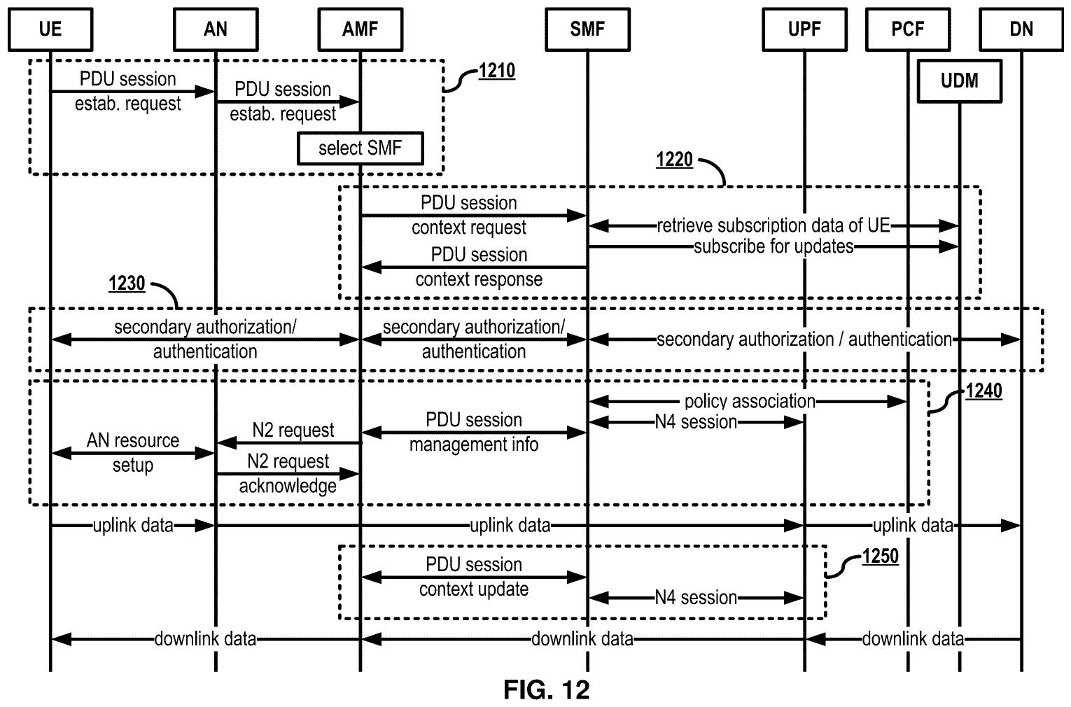

FIG. 12 illustrates an example of a protocol data unit (PDU) session establishment procedure for a wireless device (e.g., a UE). The UE may determine to transmit the PDU session establishment request to create a new PDU session, to hand over an existing PDU session to a 3GPP network, or for any other suitable reason.

At 1210, the UE initiates PDU session establishment. The UE may transmit a PDU session establishment request to an AMF via an AN. The PDU session establishment request may be a NAS message. The PDU session establishment request may indicate: a PDU session ID; a requested PDU session type (new or existing); a requested DN (DNN); a requested network slice (S-NSSAI); a requested SSC mode; and/or any other suitable information. The PDU session ID may be generated by the UE. The PDU session type may be, for example, an Internet Protocol (IP)-based type (e.g., IPV4, IPV6, or dual stack IPv4/IPv6), an Ethernet type, or an unstructured type.

The AMF may select an SMF based on the PDU session establishment request. In some scenarios, the requested PDU session may already be associated with a particular SMF. For example, the AMF may store a UE context of the UE, and the UE context may indicate that the PDU session ID of the requested PDU session is already associated with the particular SMF. In some scenarios, the AMF may select the SMF based on a determination that the SMF is prepared to handle the requested PDU session. For example, the requested PDU session may be associated with a particular DNN and/or S-NSSAI, and the SMF may be selected based on a determination that the SMF can manage a PDU session associated with the particular DNN and/or S-NSSAI.

At 1220, the network manages a context of the PDU session. After selecting the SMF at 1210, the AMF sends a PDU session context request to the SMF. The PDU session context request may include the PDU session establishment request received from the UE at 1210. The PDU session context request may be a Nsmf_PDUSession_CreateSMContext Request and/or a Nsmf_PDUSession_UpdateSMContext Request. The PDU session context request may indicate identifiers of the UE; the requested DN; and/or the requested network slice. Based on the PDU session context request, the SMF may retrieve subscription data from a UDM. The subscription data may be session management subscription data of the UE. The SMF may subscribe for updates to the subscription data, so that the PCF will send new information if the subscription data of the UE changes. After the subscription data of the UE is obtained, the SMF may transmit a PDU session context response to the AMG. The PDU session context response may be a Nsmf_PDUSession_CreateSMContext Response and/or a Nsmf_PDUSession_UpdateSMContext Response. The PDU session context response may include a session management context ID.

At 1230, secondary authorization/authentication may be performed, if necessary. The secondary authorization/authentication may involve the UE, the AMF, the SMF, and the DN. The SMF may access the DN via a Data Network Authentication, Authorization and Accounting (DN AAA) server.

At 1240, the network sets up a data path for uplink data associated with the PDU session. The SMF may select a PCF and establish a session management policy association. Based on the association, the PCF may provide an initial set of policy control and charging rules (PCC rules) for the PDU session. When targeting a particular PDU session, the PCF may indicate, to the SMF, a method for allocating an IP address to the PDU Session, a default charging method for the PDU session, an address of the corresponding charging entity, triggers for requesting new policies, etc. The PCF may also target a service data flow (SDF) comprising one or more PDU sessions. When targeting an SDF, the PCF may indicate, to the SMF, policies for applying QoS requirements, monitoring traffic (e.g., for charging purposes), and/or steering traffic (e.g., by using one or more particular N6 interfaces).

The SMF may determine and/or allocate an IP address for the PDU session. The SMF may select one or more UPFs (a single UPF in the example of FIG. 12) to handle the PDU session. The SMF may send an N4 session message to the selected UPF. The N4 session message may be an N4 Session Establishment Request and/or an N4 Session Modification Request. The N4 session message may include packet detection, enforcement, and reporting rules associated with the PDU session. In response, the UPF may acknowledge by sending an N4 session establishment response and/or an N4 session modification response.

The SMF may send PDU session management information to the AMF. The PDU session management information may be a session service request (e.g., Namf_Communication_N1N2MessageTransfer) message. The PDU session management information may include the PDU session ID. The PDU session management information may be a NAS message. The PDU session management information may include N1 session management information and/or N2 session management information. The N1 session management information may include a PDU session establishment accept message. The PDU session establishment accept message may include tunneling endpoint information of the UPF and quality of service (QOS) information associated with the PDU session.

The AMF may send an N2 request to the AN. The N2 request may include the PDU session establishment accept message. Based on the N2 request, the AN may determine AN resources for the UE. The AN resources may be used by the UE to establish the PDU session, via the AN, with the DN. The AN may determine resources to be used for the PDU session and indicate the determined resources to the UE. The AN may send the PDU session establishment accept message to the UE. For example, the AN may perform an RRC reconfiguration of the UE. After the AN resources are set up, the AN may send an N2 request acknowledge to the AMF. The N2 request acknowledge may include N2 session management information, for example, the PDU session ID and tunneling endpoint information of the AN.

After the data path for uplink data is set up at 1240, the UE may optionally send uplink data associated with the PDU session. As shown in FIG. 12, the uplink data may be sent to a DN associated with the PDU session via the AN and the UPF.

At 1250, the network may update the PDU session context. The AMF may transmit a PDU session context update request to the SMF. The PDU session context update request may be a Nsmf_PDUSession_UpdateSMContext Request. The PDU session context update request may include the N2 session management information received from the AN. The SMF may acknowledge the PDU session context update. The acknowledgement may be a Nsmf_PDUSession_UpdateSMContext Response. The acknowledgement may include a subscription requesting that the SMF be notified of any UE mobility event. Based on the PDU session context update request, the SMF may send an N4 session message to the UPF. The N4 session message may be an N4 Session Modification Request. The N4 session message may include tunneling endpoint information of the AN. The N4 session message may include forwarding rules associated with the PDU session. In response, the UPF may acknowledge by sending an N4 session modification response.

After the UPF receives the tunneling endpoint information of the AN, the UPF may relay downlink data associated with the PDU session. As shown in FIG. 12, the downlink data may be received from a DN associated with the PDU session via the AN and the UPF.

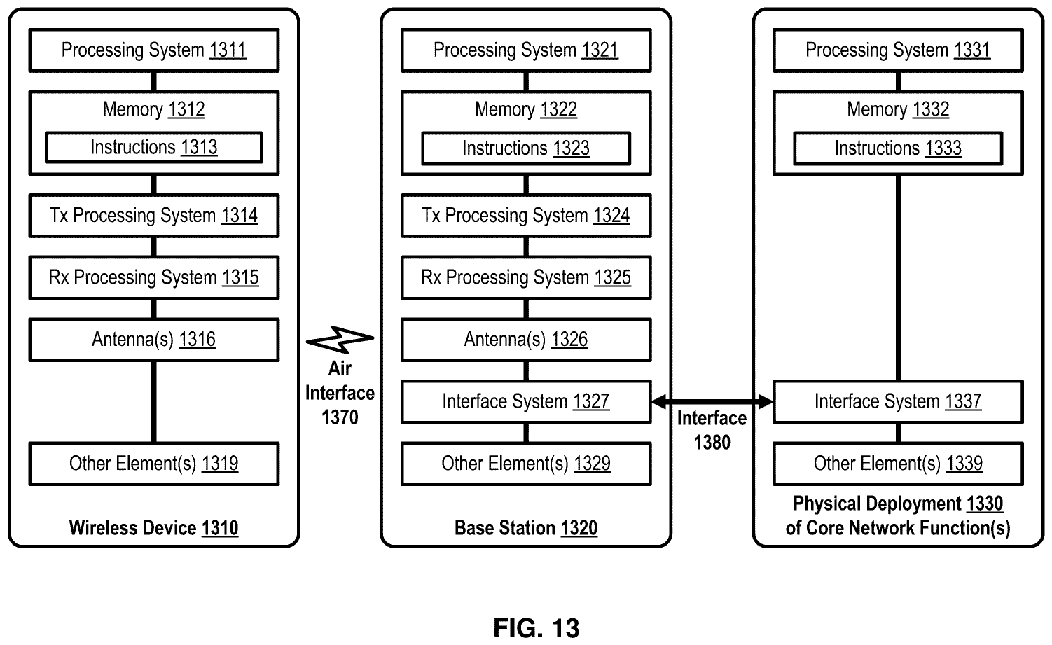

FIG. 13 illustrates examples of components of the elements in a communications network. FIG. 13 includes a wireless device 1310, a base station 1320, and a physical deployment of one or more network functions 1330 (henceforth “deployment 1330”). Any wireless device described in the present disclosure may have similar components and may be implemented in a similar manner as the wireless device 1310. Any other base station described in the present disclosure (or any portion thereof, depending on the architecture of the base station) may have similar components and may be implemented in a similar manner as the base station 1320. Any physical core network deployment in the present disclosure (or any portion thereof, depending on the architecture of the base station) may have similar components and may be implemented in a similar manner as the deployment 1330.

The wireless device 1310 may communicate with base station 1320 over an air interface 1370. The communication direction from wireless device 1310 to base station 1320 over air interface 1370 is known as uplink, and the communication direction from base station 1320 to wireless device 1310 over air interface 1370 is known as downlink. Downlink transmissions may be separated from uplink transmissions using FDD, TDD, and/or some combination of duplexing techniques. FIG. 13 shows a single wireless device 1310 and a single base station 1320, but it will be understood that wireless device 1310 may communicate with any number of base stations or other access network components over air interface 1370, and that base station 1320 may communicate with any number of wireless devices over air interface 1370.

The wireless device 1310 may comprise a processing system 1311 and a memory 1312. The memory 1312 may comprise one or more computer-readable media, for example, one or more non-transitory computer readable media. The memory 1312 may include instructions 1313. The processing system 1311 may process and/or execute instructions 1313. Processing and/or execution of instructions 1313 may cause wireless device 1310 and/or processing system 1311 to perform one or more functions or activities. The memory 1312 may include data (not shown). One of the functions or activities performed by processing system 1311 may be to store data in memory 1312 and/or retrieve previously-stored data from memory 1312. In an example, downlink data received from base station 1320 may be stored in memory 1312, and uplink data for transmission to base station 1320 may be retrieved from memory 1312. As illustrated in FIG. 13, the wireless device 1310 may communicate with base station 1320 using a transmission processing system 1314 and/or a reception processing system 1315. Alternatively, transmission processing system 1314 and reception processing system 1315 may be implemented as a single processing system, or both may be omitted and all processing in the wireless device 1310 may be performed by the processing system 1311. Although not shown in FIG. 13, transmission processing system 1314 and/or reception processing system 1315 may be coupled to a dedicated memory that is analogous to but separate from memory 1312, and comprises instructions that may be processed and/or executed to carry out one or more of their respective functionalities. The wireless device 1310 may comprise one or more antennas 1316 to access air interface 1370.

The wireless device 1310 may comprise one or more other elements 1319. The one or more other elements 1319 may comprise software and/or hardware that provide features and/or functionalities, for example, a speaker, a microphone, a keypad, a display, a touchpad, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, a global positioning sensor (GPS) and/or the like). The wireless device 1310 may receive user input data from and/or provide user output data to the one or more one or more other elements 1319. The one or more other elements 1319 may comprise a power source. The wireless device 1310 may receive power from the power source and may be configured to distribute the power to the other components in wireless device 1310. The power source may comprise one or more sources of power, for example, a battery, a solar cell, a fuel cell, or any combination thereof.

The wireless device 1310 may transmit uplink data to and/or receive downlink data from base station 1320 via air interface 1370. To perform the transmission and/or reception, one or more of the processing system 1311, transmission processing system 1314, and/or reception system 1315 may implement open systems interconnection (OSI) functionality. As an example, transmission processing system 1314 and/or reception system 1315 may perform layer 1 OSI functionality, and processing system 1311 may perform higher layer functionality. The wireless device 1310 may transmit and/or receive data over air interface 1370 using one or more antennas 1316. For scenarios where the one or more antennas 1316 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The base station 1320 may comprise a processing system 1321 and a memory 1322. The memory 1322 may comprise one or more computer-readable media, for example, one or more non-transitory computer readable media. The memory 1322 may include instructions 1323. The processing system 1321 may process and/or execute instructions 1323. Processing and/or execution of instructions 1323 may cause base station 1320 and/or processing system 1321 to perform one or more functions or activities. The memory 1322 may include data (not shown). One of the functions or activities performed by processing system 1321 may be to store data in memory 1322 and/or retrieve previously-stored data from memory 1322. The base station 1320 may communicate with wireless device 1310 using a transmission processing system 1324 and a reception processing system 1325. Although not shown in FIG. 13, transmission processing system 1324 and/or reception processing system 1325 may be coupled to a dedicated memory that is analogous to but separate from memory 1322, and comprises instructions that may be processed and/or executed to carry out one or more of their respective functionalities. The wireless device 1320 may comprise one or more antennas 1326 to access air interface 1370.

The base station 1320 may transmit downlink data to and/or receive uplink data from wireless device 1310 via air interface 1370. To perform the transmission and/or reception, one or more of the processing system 1321, transmission processing system 1324, and/or reception system 1325 may implement OSI functionality. As an example, transmission processing system 1324 and/or reception system 1325 may perform layer 1 OSI functionality, and processing system 1321 may perform higher layer functionality. The base station 1320 may transmit and/or receive data over air interface 1370 using one or more antennas 1326. For scenarios where the one or more antennas 1326 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The base station 1320 may comprise an interface system 1327. The interface system 1327 may communicate with one or more base stations and/or one or more elements of the core network via an interface 1380. The interface 1380 may be wired and/or wireless and interface system 1327 may include one or more components suitable for communicating via interface 1380. In FIG. 13, interface 1380 connects base station 1320 to a single deployment 1330, but it will be understood that wireless device 1310 may communicate with any number of base stations and/or CN deployments over interface 1380, and that deployment 1330 may communicate with any number of base stations and/or other CN deployments over interface 1380. The base station 1320 may comprise one or more other elements 1329 analogous to one or more of the one or more other elements 1319.

The deployment 1330 may comprise any number of portions of any number of instances of one or more network functions (NFs). The deployment 1330 may comprise a processing system 1331 and a memory 1332. The memory 1332 may comprise one or more computer-readable media, for example, one or more non-transitory computer readable media. The memory 1332 may include instructions 1333. The processing system 1331 may process and/or execute instructions 1333. Processing and/or execution of instructions 1333 may cause the deployment 1330 and/or processing system 1331 to perform one or more functions or activities. The memory 1332 may include data (not shown). One of the functions or activities performed by processing system 1331 may be to store data in memory 1332 and/or retrieve previously-stored data from memory 1332. The deployment 1330 may access the interface 1380 using an interface system 1337. The deployment 1330 may comprise one or more other elements 1339 analogous to one or more of the one or more other elements 1319.

One or more of the systems 1311, 1314, 1315, 1321, 1324, 1325, and/or 1331 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. One or more of the systems 1311, 1314, 1315, 1321, 1324, 1325, and/or 1331 may perform signal coding/processing, data processing, power control, input/output processing, and/or any other functionality that may enable wireless device 1310, base station 1320, and/or deployment 1330 to operate in a mobile communications system.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab and/or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise computers, microcontrollers, microprocessors, DSPs, ASICS, FPGAs, and complex programmable logic devices (CPLDs). Computers, microcontrollers and microprocessors may be programmed using languages such as assembly, C, C++ and/or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

The wireless device 1310, base station 1320, and/or deployment 1330 may implement timers and/or counters. A timer/counter may start at an initial value. As used herein, starting may comprise restarting. Once started, the timer/counter may run. Running of the timer/counter may be associated with an occurrence. When the occurrence occurs, the value of the timer/counter may change (for example, increment or decrement). The occurrence may be, for example, an exogenous event (for example, a reception of a signal, a measurement of a condition, etc.), an endogenous event (for example, a transmission of a signal, a calculation, a comparison, a performance of an action or a decision to so perform, etc.), or any combination thereof. In the case of a timer, the occurrence may be the passage of a particular amount of time. However, it will be understood that a timer may be described and/or implemented as a counter that counts the passage of a particular unit of time. A timer/counter may run in a direction of a final value until it reaches the final value. The reaching of the final value may be referred to as expiration of the timer/counter. The final value may be referred to as a threshold. A timer/counter may be paused, wherein the present value of the timer/counter is held, maintained, and/or carried over, even upon the occurrence of one or more occurrences that would otherwise cause the value of the timer/counter to change. The timer/counter may be un-paused or continued, wherein the value that was held, maintained, and/or carried over begins changing again when the one or more occurrence occur. A timer/counter may be set and/or reset. As used herein, setting may comprise resetting. When the timer/counter sets and/or resets, the value of the timer/counter may be set to the initial value. A timer/counter may be started and/or restarted. As used herein, starting may comprise restarting. In some embodiments, when the timer/counter restarts, the value of the timer/counter may be set to the initial value and the timer/counter may begin to run.

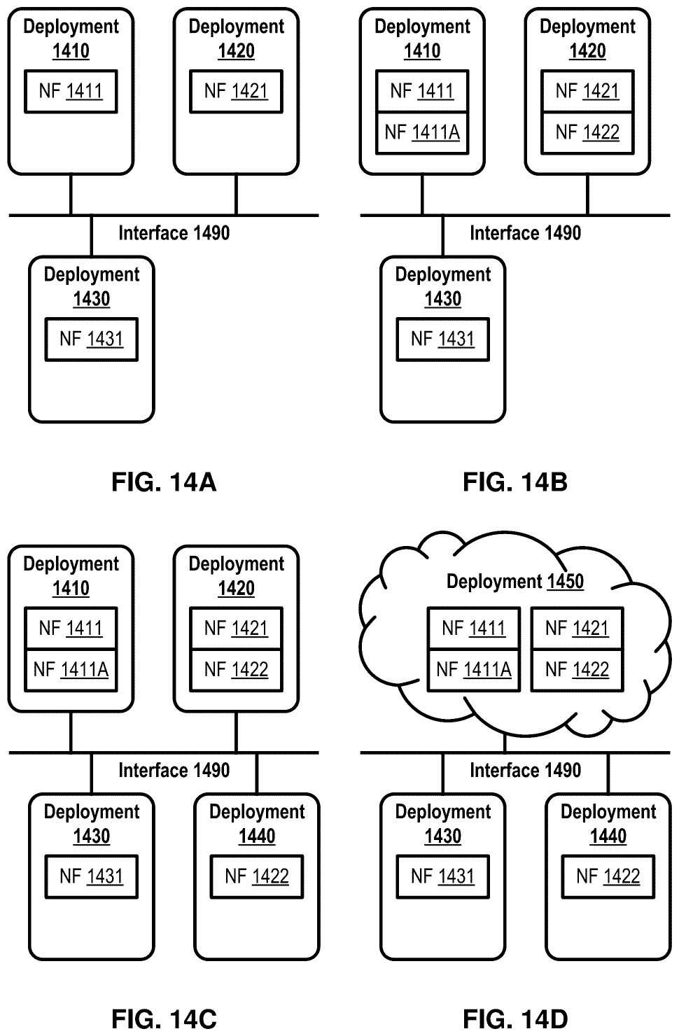

FIGS. 14A, 14B, 14C, and 14D illustrate various example arrangements of physical core network deployments, each having one or more network functions or portions thereof. The core network deployments comprise a deployment 1410, a deployment 1420, a deployment 1430, a deployment 1440, and/or a deployment 1450. Each deployment may be analogous to, for example, the deployment 1330 depicted in FIG. 13. In particular, each deployment may comprise a processing system for performing one or more functions or activities, memory for storing data and/or instructions, and an interface system for communicating with other network elements (for example, other core network deployments). Each deployment may comprise one or more network functions (NFs). The term NF may refer to a particular set of functionalities and/or one or more physical elements configured to perform those functionalities (e.g., a processing system and memory comprising instructions that, when executed by the processing system, cause the processing system to perform the functionalities). For example, in the present disclosure, when a network function is described as performing X, Y, and Z, it will be understood that this refers to the one or more physical elements configured to perform X, Y, and Z, no matter how or where the one or more physical elements are deployed. The term NF may refer to a network node, network element, and/or network device.

As will be discussed in greater detail below, there are many different types of NF and each type of NF may be associated with a different set of functionalities. A plurality of different NFs may be flexibly deployed at different locations (for example, in different physical core network deployments) or in a same location (for example, co-located in a same deployment). A single NF may be flexibly deployed at different locations (implemented using different physical core network deployments) or in a same location. Moreover, physical core network deployments may also implement one or more base stations, application functions (AFs), data networks (DNS), or any portions thereof. NFs may be implemented in many ways, including as network elements on dedicated or shared hardware, as software instances running on dedicated or shared hardware, or as virtualized functions instantiated on a platform (e.g., a cloud-based platform).

FIG. 14A illustrates an example arrangement of core network deployments in which each deployment comprises one network function. A deployment 1410 comprises an NF 1411, a deployment 1420 comprises an NF 1421, and a deployment 1430 comprises an NF 1431. The deployments 1410, 1420, 1430 communicate via an interface 1490. The deployments 1410, 1420, 1430 may have different physical locations with different signal propagation delays relative to other network elements. The diversity of physical locations of deployments 1410, 1420, 1430 may enable provision of services to a wide area with improved speed, coverage, security, and/or efficiency.

FIG. 14B illustrates an example arrangement wherein a single deployment comprises more than one NF. Unlike FIG. 14A, where each NF is deployed in a separate deployment, FIG. 14B illustrates multiple NFs in deployments 1410, 1420. In an example, deployments 1410, 1420 may implement a software-defined network (SDN) and/or a network function virtualization (NFV).

For example, deployment 1410 comprises an additional network function, NF 1411A. The NFs 1411, 1411A may consist of multiple instances of the same NF type, co-located at a same physical location within the same deployment 1410. The NFs 1411, 1411A may be implemented independently from one another (e.g., isolated and/or independently controlled). For example, the NFs 1411, 1411A may be associated with different network slices. A processing system and memory associated with the deployment 1410 may perform all of the functionalities associated with the NF 1411 in addition to all of the functionalities associated with the NF 1411A. In an example, NFs 1411, 1411A may be associated with different PLMNs, but deployment 1410, which implements NFs 1411, 1411A, may be owned and/or operated by a single entity.

Elsewhere in FIG. 14B, deployment 1420 comprises NF 1421 and an additional network function, NF 1422. The NFs 1421, 1422 may be different NF types. Similar to NFs 1411, 1411A, the NFs 1421, 1422 may be co-located within the same deployment 1420, but separately implemented. As an example, a first PLMN may own and/or operate deployment 1420 having NFs 1421, 1422. As another example, the first PLMN may implement NF 1421 and a second PLMN may obtain from the first PLMN (e.g., rent, lease, procure, etc.) at least a portion of the capabilities of deployment 1420 (e.g., processing power, data storage, etc.) in order to implement NF 1422. As yet another example, the deployment may be owned and/or operated by one or more third parties, and the first PLMN and/or second PLMN may procure respective portions of the capabilities of the deployment 1420. When multiple NFs are provided at a single deployment, networks may operate with greater speed, coverage, security, and/or efficiency.

FIG. 14C illustrates an example arrangement of core network deployments in which a single instance of an NF is implemented using a plurality of different deployments. In particular, a single instance of NF 1422 is implemented at deployments 1420, 1440. As an example, the functionality provided by NF 1422 may be implemented as a bundle or sequence of subservices. Each subservice may be implemented independently, for example, at a different deployment. Each subservices may be implemented in a different physical location. By distributing implementation of subservices of a single NF across different physical locations, the mobile communications network may operate with greater speed, coverage, security, and/or efficiency.

FIG. 14D illustrates an example arrangement of core network deployments in which one or more network functions are implemented using a data processing service. In FIG. 14D, NFs 1411, 1411A, 1421, 1422 are included in a deployment 1450 that is implemented as a data processing service. The deployment 1450 may comprise, for example, a cloud network and/or data center. The deployment 1450 may be owned and/or operated by a PLMN or by a non-PLMN third party. The NFs 1411, 1411A, 1421, 1422 that are implemented using the deployment 1450 may belong to the same PLMN or to different PLMNs. The PLMN(s) may obtain (e.g., rent, lease, procure, etc.) at least a portion of the capabilities of the deployment 1450 (e.g., processing power, data storage, etc.). By providing one or more NFs using a data processing service, the mobile communications network may operate with greater speed, coverage, security, and/or efficiency.

As shown in the figures, different network elements (e.g., NFs) may be located in different physical deployments, or co-located in a single physical deployment. It will be understood that in the present disclosure, the sending and receiving of messages among different network elements is not limited to inter-deployment transmission or intra-deployment transmission, unless explicitly indicated.

In an example, a deployment may be a ‘black box’ that is preconfigured with one or more NFs and preconfigured to communicate, in a prescribed manner, with other ‘black box’ deployments (e.g., via the interface 1490). Additionally or alternatively, a deployment may be configured to operate in accordance with open-source instructions (e.g., software) designed to implement NFs and communicate with other deployments in a transparent manner. The deployment may operate in accordance with open RAN (O-RAN) standards.

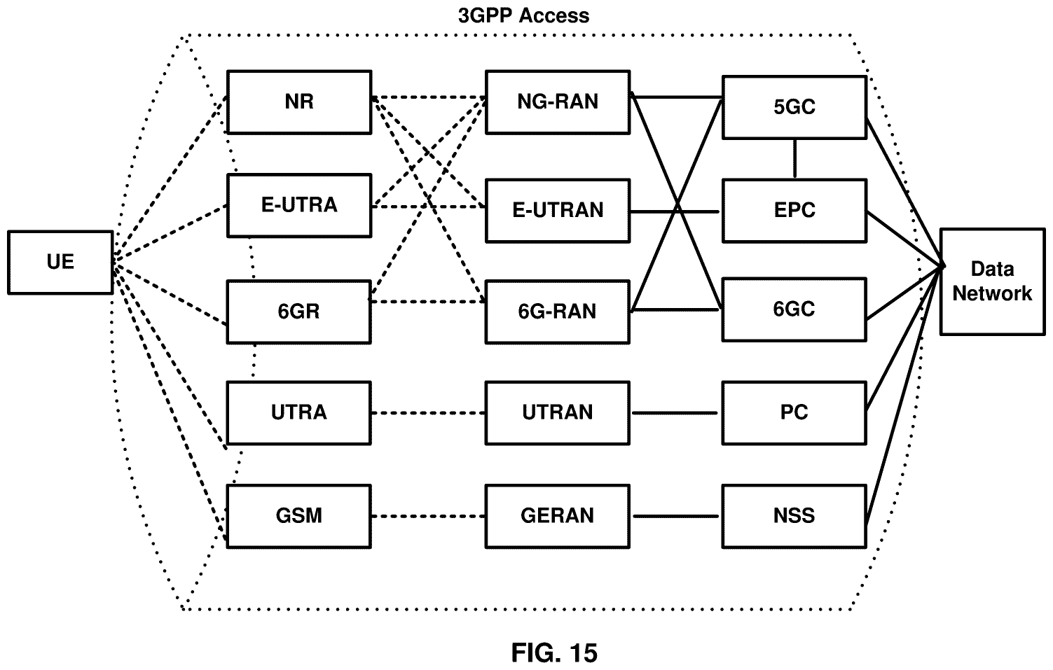

FIG. 15 illustrates an example as per an aspect of an embodiment of the present disclosure.

In an example embodiment as depicted in FIG. 15, the UE may exchange one or more data with a data network (DN), via a 3GPP access (type). The 3GPP access (type) may use one or more 3GPP RATs. The one or more 3GPP RATs may comprise at least one of 6GR (6G Radio, 6th generation radio and/or the like), NR, E-UTRA, UTRA, GSM, the like and/or a combination thereof. The 3GPP access may use one or more 3GPP RANs. The one or more 3GPP RANs may comprise at least one of a 6G-RAN (6G RAN, and/or the like), a NG-RAN, a E-UTRAN, a UTRAN, a GERAN, the like and/or a combination thereof. The 3GPP RANs may use the one or more 3GPP RATs. The one or more 3GPP RANs may interface with one or more core networks. The one or more core networks may comprise at least one of a 6G Core (6GC, 6th Generation Core and/or the like), a 5G core (5GC), an evolved packet core (EPC), a packet core (PC), a network switching system (NSS), and/or a combination thereof.

In an example embodiment, a UE may exchange one or more data with a data network, via a N3GPP access (type). The N3GPP access may use one or more N3GPP RATs. The one or more N3GPP RATs may comprise at least one of a trusted WiFi, an untrusted WiFi, a wireline broadband, the like and/or a combination thereof. The N3GPP access may use one or more N3GPP access network nodes. The one or more N3GPP access network nodes may comprise at least one of a N3IWF, an evolved packet data gateway (ePDG), a trusted non-3GPP gateway function (TNGF), a wireline access gateway function (W-AGF), the like and/or a combination thereof. The one or more N3GPP access nodes may interface with the one or more core networks (e.g., EPC and/or 5GC and/or 6GC). The N3IWF may provide similar functionalities as the 3GPP RAN. For example, the N3IWF may establish a signalling connection with the UE and/or may exchange signalling with the one or more core networks. In some embodiments in this disclosure, the N3IWF may be interpreted as a N3IWF, a TGNF, an ePDG, the likes and/or a combination thereof.

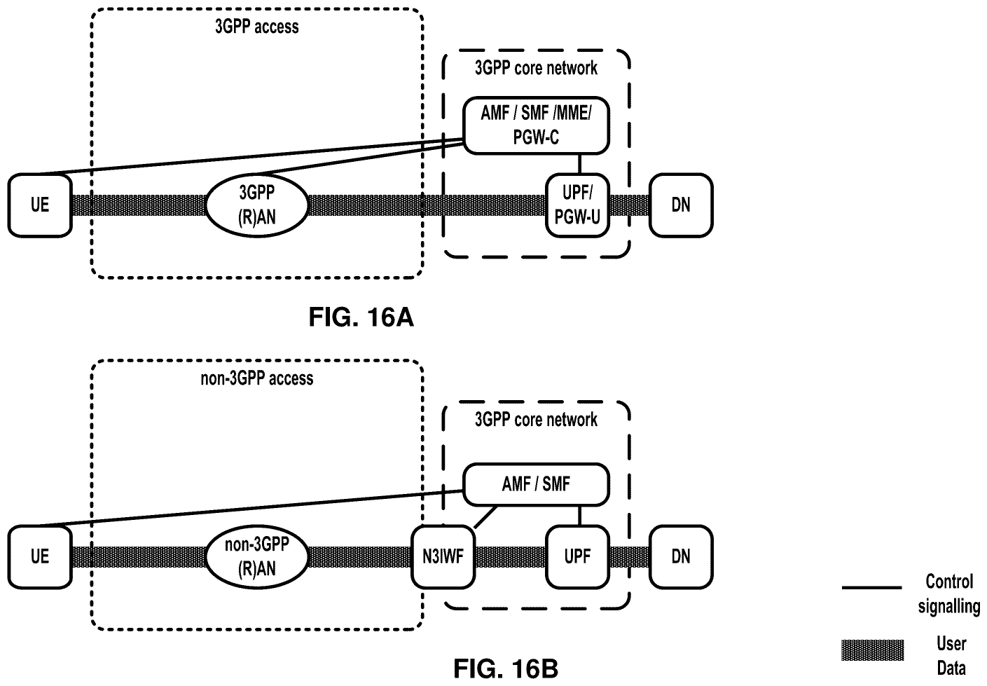

FIG. 16A and FIG. 16B illustrates an example as per an aspect of an embodiment of the present disclosure.

In an example embodiment as depicted in FIG. 16A and FIG. 16B, a UE may access a 3GPP system (network) via (using) one or more access types. For example, the one or more access types may comprise at least one of a 3GPP access type, a non-3GPP (N3GPP) access type, and/or a combination thereof.

For example, as shown in FIG. 16A, the UE may access a network via the 3GPP access type (e.g., 3GPP access). For example, the access to the network via the 3GPP access type may be an access to the network via one or more 3GPP RANs. For example, the one or more 3GPP RANs may comprise at least one of a global system for mobile communication (GSM) enhanced data-rates for global evolution (EDGE) radio access network (GERAN), a universal terrestrial radio access network (UTRAN), an evolved UTRAN (E-UTRAN), a next generation radio access network (NG-RAN), a 6th generation radio access network (6G-RAN) and/or a combination thereof. An operator of the network may trust the UE's access to the network via the 3GPP access type, because the one or more 3GPP RANs are securely managed and/or deployed by the operator.

For example, as shown in FIG. 16B, the UE may access the network via the N3GPP access (e.g., N3GPP access type). For example, the access to the network via the N3GPP access type may be an access to the network via one or more N3GPP RATs. One or more of the one or more N3GPP RATs may be associated with one or more N3GPP RAN. For example, the one or more N3GPP RANs may comprise at least one of a trusted WiFi, an untrusted WiFi, a wireline broadband, a WiMAX, and/or a combination thereof. The operator of the network may not trust the access to the network via the N3GPP access type, because the one or more N3GPP RANs may not be managed and/or deployed by the operator. For example, a WiFi equipment (e.g., router, access point) may not be managed or deployed by the operator. To prevent unauthorized access of the UE via the one or more N3GPP RANs (or RATs) and/or to securely protect data/signaling, a non-3GPP interworking function (N3IWF) may be employed for the N3GPP access type. For example, the N3IWF may be employed for interworking between the one or more non-3GPP RANs and a 5G core network. In some implementations, the N3GPP RANs may comprise the N3IWF. In other implementation, the N3GPP RANs may not comprise the N3IWF.

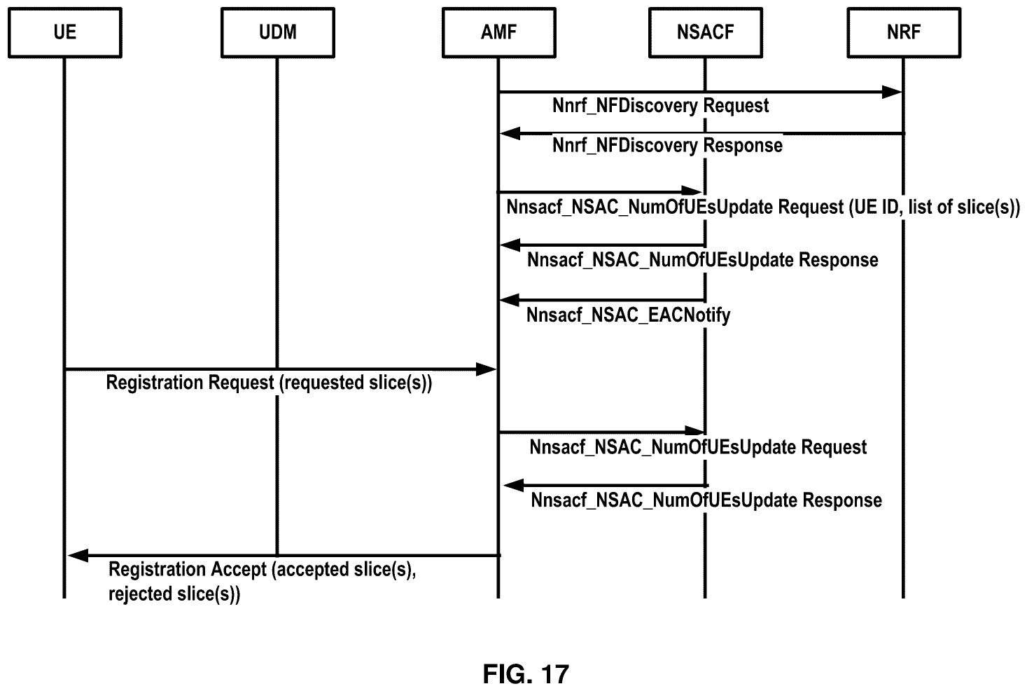

FIG. 17 illustrates an example as per an aspect of an embodiment of the present disclosure. In one implementation, controlling admission to a network slice may be supported by limiting the number of UEs registered for a network slice.

In an implementation, for a network slice, an AMF may be configured with the information indicating whether the network slice is subject to network slice admission control (NSAC). For the network slice subject to NSAC, to find a NSACF for the network slice, the AMF may perform NSACF discovery procedure. For example, the AMF may send Nnrf_NFDiscovery Request message to a NRF, requesting information of the NSACF which is in charge of the network slice. Based on the Nnrf_NFDiscovery Request, the AMF may receive Nnrf_NFDiscovery Response message from the NRF. The Nnrf_NFDiscovery Response message may comprise information of the NSACF. Based on the information of the NSACF received from the NRF, the AMF may send Nnsacf_NSAC_NumOfUEsUpdate Request message to the NSACF. The Nnsacf_NSAC_NumOfUEsUpdate Request may comprise at least one of identity of the network slice (e.g., S-NSSAI(s), identity of UE(s) (e.g., SUPI), NF ID, access type, update flag. The NF ID may indicate the identity of the network node which sends the Nnsacf_NSAC_NumOfUEsUpdate Request. The access type may indicate an access type over which the UE(s) requests registration. The update flag may indicate whether the number of UEs registered with the network slice needs to be increased or decreased. In response to the Nnsacf_NSAC_NumOfUEsUpdate Request, the AMF may receive Nnsacf_NSAC_NumOfUEsUpdate Response message from the NSACF. The Nnsacf_NSAC_NumOfUEsUpdate Response message may comprise a result indication. The result indication may comprise an outcome of update and/or check operation in the NSACF, may comprise indication of whether ‘maximum number of UEs for the S-NSSAI not reached’ or ‘maximum number of UEs for the S-NSSAI reached’.

In an example of FIG. 17, the NSACF may send Nnsacf_NSAC_EACNotify message to the AMF. The NSACF may send the Nnsacf_NSAC_EACNotify message to one or more network nodes (e.g., AMFs) to indicate activation or deactivation of Early Availability Check (EAC) mode for the network slice. The EAC mode may indicate whether the AMF needs to check with the NSACF before it determines to allow the UE to register with the network slice. For example, for the network slice subject to NSAC, when the number of the UEs registered with the network slice is above certain threshold (e.g., 100 UEs, 500 UEs, 20%, 50%), the NSACF may activate the EAC mode. The NSACF may send the Nnsacf_NSAC_EACNotify message to one or more network nodes (e.g., AMFs) to indicate deactivation of Early Availability Check (EAC) mode for the network slice. For example, for the network slice subject to NSAC, when the number of the UEs registered with the network slice is below certain threshold (e.g., 90 UEs, 400 UEs, 10%, 40%), the NSACF may deactivate the EAC mode. The Nnsacf_NSAC_EACNotify message may comprise at least one of the identity of the network slice and/or EAC flag. The EAC flag may indicate whether the EAC mode is deactivated or activated for the network slice. When the number of registered UE for the network slice is low, the EAC mode may be deactivated to reduce signaling between the AMF and the NSACF. In the example of FIG. 17, the NSACF may indicate to the AMF that the EAC mode is activated.

In an implementation, the AMF may receive a registration request message from a UE. The registration message may comprise at least one of the identity of the UE and/or the list of one or more identities of one or more requested network slices. One or more network slices requested by the UE may be subject to NSAC. For one or more network slices subject to NSAC, the AMF may determine for which one or more network slices NSAC is required. For one or more requested network slices which requires NSAC, the AMF may determine whether the EAC mode is activated.

In an implementation, for a requested network slice for which the EAC mode is activated, the AMF may send Nnsacf_NSAC_NumOfUEsUpdate Request message to the NSACF. The Nnsacf_NSAC_NumOfUEsUpdate Request may comprise the update flag indicating that the number of UEs registered for the network slice is to be increased. Based on the received Nnsacf_NSAC_NumOfUEsUpdate Request, the NSACF may determine whether the number of UEs registered for the network slice reaches the maximum number of UEs registered for the network slice. If the maximum number of UEs registered for the network slice is not reached, the NSACF may send to the AMF the Nnsacf_NSAC_NumOfUEsUpdate Response comprising indication of the maximum number of UEs registered with the network slice not reached. If the maximum number of UEs registered for the network slice is reached, the NSACF may send to the AMF the Nnsacf_NSAC_NumOfUEsUpdate Response comprising indication of the maximum number of UEs registered with the network slice reached.

In an implementation, based on the received Nnsacf_NSAC_NumOfUEsUpdate Response, the AMF may send a registration response message to the UE. For example, the registration response message may comprise at least one of a registration accept message or registration reject message to the UE. For example, the registration response message may comprise at least one of a list of one or more accepted network slices and/or a list of at least one or more rejected network slices. Based on the response from the NSACF indicating the maximum number of UEs registered with the network slice reached, the AMF may include the network slice in the list of one or more rejected network slices. Based on the response from the NSACF indicating the maximum number of UEs registered with the network slice not reached, the AMF may include the network slice in the list of one or more accepted network slices.

In an implementation, the AMF and/or the NSCAF may manage the number of the UEs registered with the network slice, per access type. For example, a first UE may perform a first registration via a 3GPP access path and/or a second registration via a N3GPP access path. Because the first UE is using a resource of the network slice of both the 3GPP access and the N3GPP access, the AMF and/or the NSCAF may increase the number of UEs registered with the network slice by 2. For example, because the first UE is using the 3GPP access, the AMF and/or the NSCAF may increase the number of UEs registered with the network slice by 1. For example, because the first UE is using the N3GPP access, the AMF and/or the NSCAF may increase the number of UEs registered with the network slice by 1. For example, a second UE may perform a third registration via the 3GPP access path and/or may not perform a fourth registration via the N3GPP access path. For example, because the second UE is using the 3GPP access, for the 3GPP access, the AMF and/or the NSCAF may increase the number of UEs registered with the network slice by 1. For example, for the N3GPP access, because the second UE is not using the N3GPP access, the AMF and/or the NSCAF may not increase the number of UEs registered with the network slice by 1.

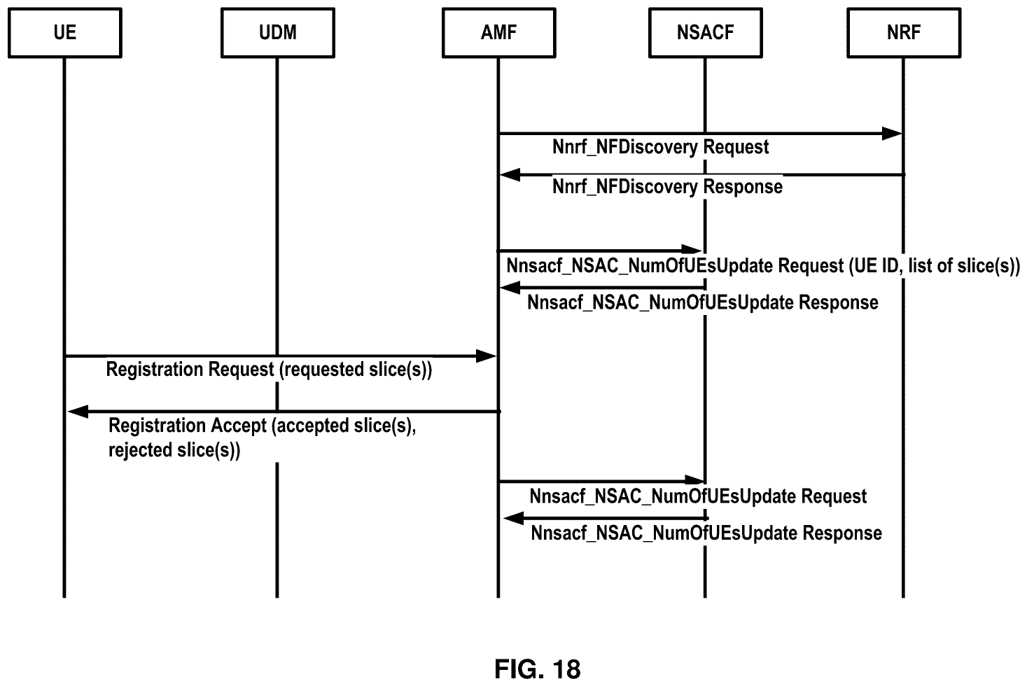

FIG. 18 illustrates an example as per an aspect of an embodiment of the present disclosure.

In the example of FIG. 18, a NSACF may determine not to activate an EAC mode for a network slice for which NSAC applies. For example, an AMF may determine that the EAC mode is deactivated for the network slice, based on that a NSACF does not send any Nnsacf_NSAC_EACNotify message to the AMF for the network slice. For example, the AMF may determine that the EAC mode is deactivated for the network slice, based on that the NSACF sends Nnsacf_NSAC_EACNotify message indicating deactivation of the EAC mode for the network slice.

In an implementation, the AMF may receive a registration request from a UE. The registration request may comprise one or more identities of one or more requested network slices. The one or more identities of one or more requested network slices may comprise at least the network slice for which NSAC applies. Based on that the EAC mode is deactivated for the network slice, the AMF may determine to allow the network slice for the UE. For example, the AMF may send to the UE, a registration accept message comprising a list of one or more accepted network slices including the network slice. Based on sending the registration accept message to the UE, the AMF may send to the NSACF, Nnsacf_NSAC_NumOfUEsUpdate Request message. The Nnsacf_NSAC_NumOfUEsUpdate Request may comprise at least of the update flag indicating that the number of UEs registered for the network slice is to be increased and/or the identity of the UE. Based on the received Nnsacf_NSAC_NumOfUEsUpdate Request, the NSACF may determine whether the UE is already included in the list of UEs registered for the network slice. Based on the received Nnsacf_NSAC_NumOfUEsUpdate Request, the NSACF may determine whether the number of UEs registered for the network slice reaches the maximum number of UEs registered for the network slice. If the maximum number of UEs registered for the network slice is not reached, the NSACF may send to the AMF the Nnsacf_NSAC_NumOfUEsUpdate Response comprising indication of the maximum number of UEs registered with the network slice not reached. If the maximum number of UEs registered for the network slice is reached, the NSACF may send to the AMF the Nnsacf_NSAC_NumOfUEsUpdate Response comprising indication of the maximum number of UEs registered with the network slice reached.

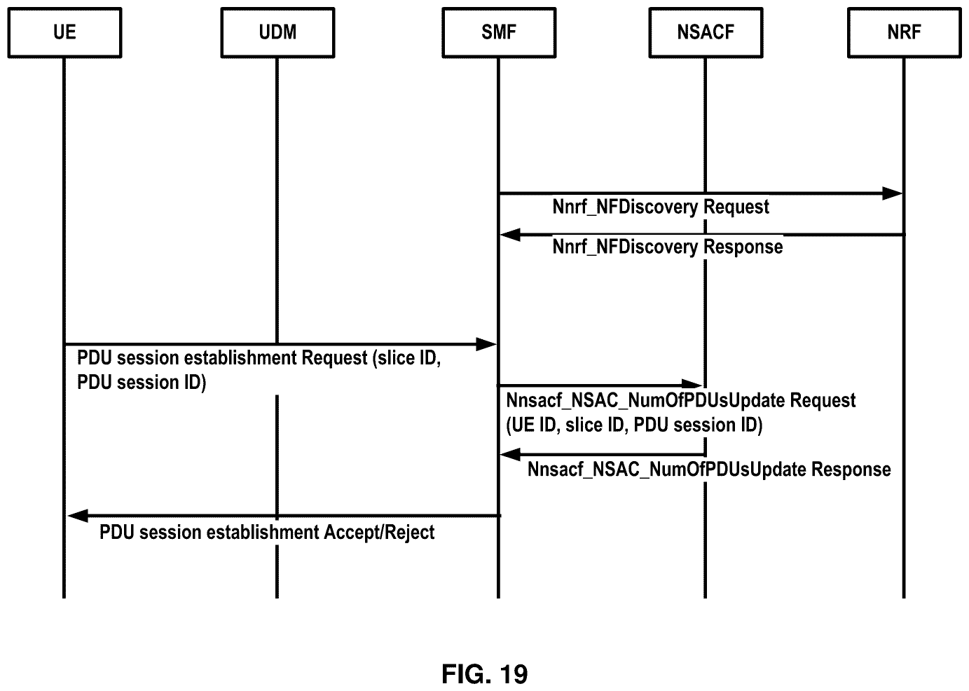

FIG. 19 illustrates an example as per an aspect of an embodiment of the present disclosure. In the example, controlling admission to a network slice may be supported by limiting the number of PDU sessions established for a network slice.

In an implementation, for a network slice, an SMF may be configured with an information indicating whether the network slice is subject to NSAC (Network slice admission control). For the network slice subject to NSAC, the SMF may perform NSACF discovery procedure. For example, the SMF may send Nnrf_NFDiscovery Request message to a NRF, requesting information of the NSACF which is in charge of the network slice. Based on the Nnrf_NFDiscovery Request, the SMF may receive Nnrf NFDiscovery Response message from the NRF. The Nnrf_NFDiscovery Response message may comprise information of the NSACF.

In an implementation, the SMF may receive a PDU session establishment request message from a UE. The PDU session establishment request may comprise at least one of a PDU session ID for a PDU session, identity of a network slice over which the PDU session is to be established, QoS parameter for the PDU session. Based on the identity of the network slice of the PDU session establishment request, the SMF may send Nnsacf_NSAC_NumOfPDUsUpdate Request message to the NSACF. The Nnsacf_NSAC_NumOfPDUsUpdate Request may comprise at least one of identity of the network slice (e.g., S-NSSAI(s)), identity of UE(s) (e.g., SUPI), PDU session ID, NF ID, access type, update flag. The NF ID may indicate the identity of the network node which sends the Nnsacf_NSAC_NumOfPDUsUpdate Request. The PDU session ID may indicate an identity of PDU session requested to be established by the UE. The access type may indicate an access type over which the UE(s) requests establishment of the PDU session. The update flag may indicate whether the number of PDU sessions established for the network slice needs to be increased or decreased. In response to the Nnsacf_NSAC_NumOfPDUsUpdate Request, the SMF may receive Nnsacf_NSAC_NumOfPDUsUpdate Response message from the NSACF. The Nnsacf_NSAC_NumOfPDUsUpdate Response message may comprise a result indication. The result indication may comprise an outcome of update and/or check operation in the NSACF for the network slice, may comprise indication of whether maximum number of PDU sessions for the S-NSSAI not reached or maximum number of PDU sessions for the S-NSSAI reached. Based on the received Nnsacf_NSAC_NumOfPDUsUpdate Response message, the SMF may send a response message to the UE. The response message may comprise at least one of PDU session establishment accept message and/or PDU session establishment reject message. For example, if the response from the NSACF comprises indication of maximum number of PDU sessions for the S-NSSAI not reached, the SMF may send to the UE the PDU session establishment accept message. For example, if the response from the NSACF comprises indication of maximum number of PDU sessions for the S-NSSAI reached, the SMF may send to the UE the PDU session establishment reject message.

In an implementation, the SMF and/or the NSCAF may manage the number of the PDU Sessions for the network slice, per access type. For example, a first UE may establish a first PDU session for multi-access, and the first PDU session is established using a 3GPP access path and/or a N3GPP access path. Because the first PDU session is using a resource of the network slice of both the 3GPP access and the N3GPP access, the SMF and/or the NSCAF may increase the number of PDU sessions for the network slice by 2. For example, because the first PDU session is using the 3GPP access, the SMF and/or the NSCAF may increase the number of PDU sessions for the network slice by 1. For example, because the first PDU session is using the N3GPP access, the SMF and/or the NSCAF may increase the number of PDU sessions for the network slice by 1. For example, a second UE may establish a second PDU session using the 3GPP access path and/or the second PDU session may not use a resource of the N3GPP access path. For example, because the second PDU session is using the 3GPP access, for the 3GPP access, the SMF and/or the NSCAF may increase the number of PDU sessions for the network slice by 1. For example, for the N3GPP access, because the second PDU session is not using the N3GPP access, the SMF and/or the NSCAF may not increase the number of PDU sessions for the network slice by 1.

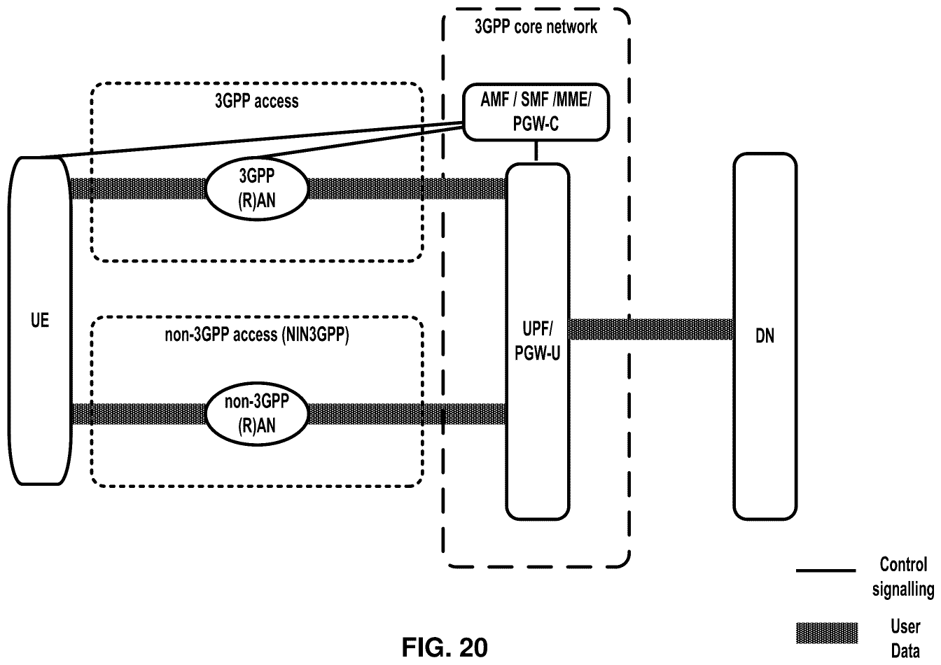

FIG. 20 illustrates an example as per an aspect of an embodiment of the present disclosure.

In one implementation, a N3GPP access may employ a N3IWF. For a UE to access a network via the N3GPP access, the UE may perform establishment of connection toward the N3IWF.

For example, the establishment of connection toward the N3IWF may requires one or more steps. The one or more steps may comprise at least of selection of selection of an access point (e.g., of a WiFi), identification of one or more candidate N3IWFs, selection of a the N3IWF among the one or more candidate N3IWFs, sending connection establishment request toward the N3IWF, receiving connection establishment confirm from the N3IWF, exchange security material for data protection, and/or the like.

After the establishment of the connection toward the N3IWF, the UE may send a registration request to an AMF via the N3IWF. For example, the UE may send the registration request to the N3IWF and/or the N3IWF may forward the registration request to the AMF.

In one implementation, many steps required for the UE to use the N3GPP access (e.g., the connection toward N3IWF, the registration to AMF, and/or the like) may incur delays until the UE can actually start data exchanges over the N3GPP access. In addition, existing implementations supporting the N3GPP access may require deployment of the N3IWF and available route from the UE to the N3IWF. If the access point where the UE access cannot be routed toward the N3IWF, the UE cannot use the N3GPP access.

One potential enhanced embodiment to address issues of existing implementation may be at least one of to support the UE's direct access to a core network (e.g., a user plane node, e.g., UPF) via the access point (e.g., a N3GPP RAN, a N3GPP RAT), to support the N3GPP access not comprising the N3IWF, to support the N3GPP access without registration via the N3IWF, to support the N3GPP access without registration via the N3GPP access, to control the use of N3GPP access via the 3GPP access, and/or the like.

The example embodiment shown in FIG. 20 may help to alleviate the issues of the existing implementation. The UE may perform registration toward the network (e.g., to a core network node, AMF, SMF) via the 3GPP access. After the UE finishes the registration via the 3GPP access, and/or while the UE is registered via the 3GPP access, the network may provide information for the N3GPP access without (e.g., not using) the N3IWF. For example, the information for the N3GPP access without the N3IWF may provide one or more IP addresses and/or one or more port information of one or more UPFs. The information for the N3GPP access without the N3IWF may comprise a NIN3GPP resource information, a resource information for NIN3GPP access, and/or the like.

The UE may utilize the information for the N3GPP access without the N3IWF, for the N3GPP access. For example, after selecting one or more WiFi networks (e.g., access points), without establishing a connection toward the N3IWF, without contacting the AMF via the N3GPP access, without performing registration for the N3GPP access, and/or the like, the UE may start establishment of connection of (or via, through) the N3GPP access toward the one or more UPFs, using the one or more IP addresses and/or the one or more port information of the one or more UPFs.

The embodiment shown in FIG. 20 may help operation to support efficiently UE's access to the network via the non-3GPP RAN. However, the embodiment of FIG. 20 to address a problem of the existing technologies may cause another issue with a network slice, explained below.

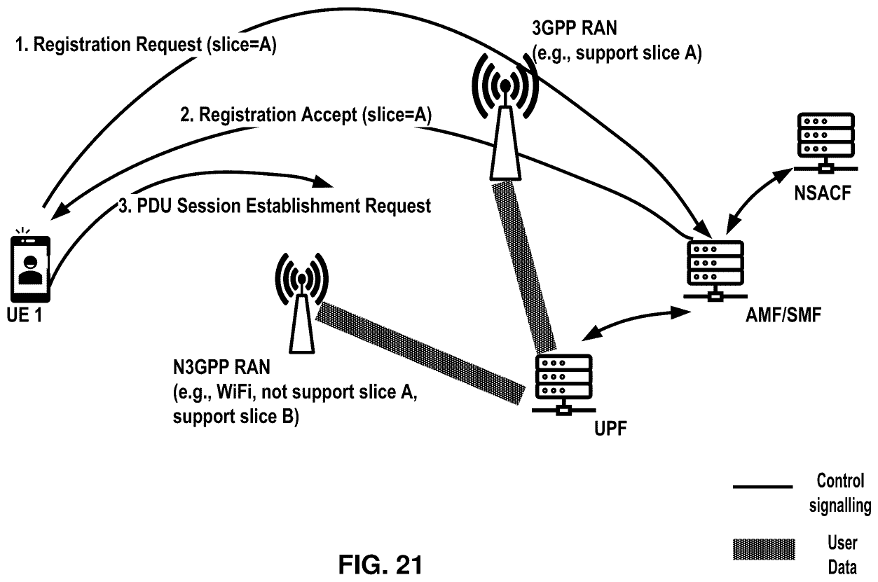

FIG. 21 illustrates an example as per an aspect of an embodiment of the present disclosure.

In one potential implementation of existing technologies, as shown in FIG. 21, a UE may perform registration via a 3GPP access (e.g., using NR, LTE, 6G radio, NG-RAN, E-UTRAN, and/or the like). For the registration, the UE may send a registration request message (e.g., step 1) to an AMF via a 3GPP RAN. The registration request message may comprise one or more slice information (e.g., S-NSSAI) that the UE requests. The one or more slice information may comprise a first S-NSSAI. For example, the first S-NSSAI may be an identifier of a network slice A.

In an example, the AMF may receive the registration request message via the 3GPP access. For example, the 3GPP access may comprise the 3GPP RAN. Because the 3GPP RAN supports the first S-NSSAI and/or because the UE requests the first S-NSSAI, the AMF may determine to allow the UE to use the first S-NSSAI. Based on the determination, the AMF may send to the UE a registration accept message. For example, the registration accept message may comprise an information that the first S-NSSAI is allowed to the UE.

In an example, after the UE receives the registration accept message, the UE may determine to establish a PDU session of the first S-NSSAI. For example, the UE may request the PDU session using both the 3GPP access and the N3GPP access. However, this may cause a first issue, because the UE may not be able to determine whether the first S-NSSAI is also allowed for the N3GPP access. Alternatively and/or additionally, this may cause a second issue with the UE, because the UE may not be able to determine whether the UE is registered for the N3GPP access or not. Alternatively and/or additionally, this may cause a third issue if the UE requests the PDU session if a N3GPP RAN of the N3GPP access (where the UE is located) does not support the first S-NSSAI. Alternatively and/or additionally, this may cause a fourth issue in determining how much quota is consumed (or increased, managed) for the first S-NSSAI. As a result, existing technologies may bring more signaling congestions, unnecessary request, inaccurate counting, and/or the like.

Embodiments of the present disclosure are related to an approach for solving the problems described above. These and other features of the present disclosure are described further below.

In an example embodiment, a UE may receive from a network node, an information indicating which network slices are allowed for a N3GPP access without N3IWF. In another embodiment, the UE may receive from the network node via a first access, an indication indicating whether a network slice is registered for other access. This may assist the UE in determining whether the UE can request a PDU session using resources of a plurality of accesses. In another embodiments, the UE may receive from a second network node a policy information assisting the UE to determine which network slice to use, based on one or more accesses. In another embodiment, the UE may receive from the network node, information of one or more ATSSS types allowed for a network slice, the UE may determine which ATSSS type to request, and/or the like. This may help in reducing unnecessary signalling between the UE and the network. In another embodiments, the network node may exchange information related to the ATSSS type, adjust a network slice quota of the network slice, and/or the like. This may help in accurately calculating used resources for the network slice.

In the specification, the term “network system” may be interpreted as, or may refer to, a communication system, and/or a generation of the communication system. For example, one or more network systems may comprise an EPS, a 5GS. For example, the first network system may be the EPS. The EPS may comprise of one or more UEs, one or more eNB, one or more en-gNBs, one or more EPCs. The one or more EPCs may comprise a MME, a SGW, a PGW, and/or the like. For example, the second network system may be the 5GS. The 5GS may comprise of one or more UEs, one or more gNB, one or more ng-eNBs, one or more 5G core networks. The one or more 5G core networks may comprise an AMF, a SMF, a PCF, and/or the like. For example, a 6th generation (6G) system may be the 6GS. The 6GS may comprise of one or more UEs, one or more 6G-RAN, one or more gNBs, one or more 6G core networks.

In the specification, the term “5G System” may be interpreted as, or may refer to, a 3GPP system consisting of at least one of 5G access network (or NG-RAN), 5G core network and/or a UE.

In the specification, the term “EPS” may be interpreted as, or may refer to, a 3GPP system consisting of at least one of EPC, E-UTRAN and/or a UE.

In the specification, the term “network node” may be interpreted as, or may refer to, at least one of a core network node, an access node, a UE, the like, and/or a combination thereof. A network may comprise one or more network nodes.

In the specification, the term “core network node” may be interpreted as, or may refer to, a core network device, which may comprise at least one of an AMF, a SMF, a NSSF, a UPF, a NRF a UDM, a PCF, a SoR-AF, an AF an DDNMF, an MB-SMF, an MB-UPF, a MME, a SGW, a PGW, a SMF+PGW-C, a SMF+PGW-U, a UDM+HSS and/or the like. The core network node may be a 5G core network node, a 6G core network node, a 4G core network node, the likes, and/or a combination thereof.

In the specification, the term “5G core network” may be interpreted as, or may refer to, a core network connecting to a 5G access network. This may be 5G core (5GC).

In the specification, the term “RAT type” may be interpreted as, or may refer to, identifying the transmission technology used in the access network for 3GPP accesses and/or for non-3GPP accesses. For example, RAT type for 3GPP access may comprise at least one of NR, NB-IoT, E-UTRA, and/or the like. For example, RAT type for non-3GPP access may comprise at least one of untrusted non-3GPP, trusted non-3GPP, trusted IEEE 802.11 non-3GPP access, Wireline, Wireline-Cable, Wireline-BBF, WiFi, etc.

In the specification, the term “3GPP RAT” may be interpreted as, or may refer to, a radio access technology based on 3rd generation partnership (3GPP) project. For example, this may comprise at least one of a NR, a E-UTRA, UTRA, GSM, 6GR (6G radio), the like, and/or a combination thereof.

In the specification, the term “N3GPP RAT” may be interpreted as, or may refer to, a radio access technology not based on 3rd generation partnership project. This may be an access technology not developed by 3GPP. For example, this may comprise a WiFi, trusted WiFi, non-trusted WiFi, fixed access, wireline broadband, the like, and/or a combination thereof.

In the specification, the term “5G access network” may be interpreted as, or may refer to, an access network comprising at least one of a NG-RAN and/or non-3GPP RAN, and connecting to a 5G core network.

In the specification, the term “3GPP RAN” may be interpreted as, or may refer to, a radio access network using 3GPP RAT. For example, this may comprise at least one of a gNB, an eNB, a ng-eNB, an en-gNB, the like, and/or a combination thereof. For example, this may be at least one of an E-UTRAN, NG-RAN, 6G-RAN (6th generation RAN), the like, and/or a combination thereof. The 3GPP RAN may be 3GPP access node.

In the specification, the term “NG-RAN” may be interpreted as, or may refer to, a base station, which may comprise at least one of a gNB, a ng-eNB, a relay node, a base station central unit (e.g., gNB-CU), a base station distributed unit (e.g., gNB-DU), and/or the like. This may be a radio access network that connects to 5GC, supporting at least one of NR, E-UTRA, and/or a combination thereof.

In the specification, the term “E-UTRAN” may be interpreted as, or may refer to, a base station, which may comprise at least one of an eNB, an en-gNB, and/or the like. This may be a radio access network that connects to evolved packet core (EPC), supporting at least one of NR, E-UTRA, and/or a combination thereof.

In the specification, the term “N3GPP RAN” may be interpreted as, or may refer to, an access network using non-3GPP (N3GPP) RAT. For example, the N3GPP RAT may comprise e.g., a WiFi, and/or one or more radio access technologies not defined (developed) by 3GPP and/or other radio access technologies than 3GPP RAT. This may be a N3GPP access network (AN). For example, in a first implementation, a first N3GPP RAN (e.g., a first type of N3GPP RAN) may comprise at least one of N3IWF, ePDG, TNGF, W-GAN, the like, and/or a combination thereof. In the first implementation, a first N3GPP access and/or a first N3GPP RAN may be associated with a signalling, the UE may send/receive one or more signalling message to/from a core network node via the N3GPP access, and/or the UE may send/receive one or more user data via the N3GPP RAT. In a second implementation, a second N3GPP RAN (e.g., a second type of N3GPP RAN) may not comprise N3IWF, ePDG, TNGF, W-GAN, the like, and/or a combination thereof. The second implementation may be a Non-Integrated Non-3GPP (NIN3GPP) access and/or a NIN3GPP RAN. For example, the NIN3GPP access may not be associated with a signalling, the UE may not send/receive one or more signalling messages to/from a core network node via the N3GPP access, and/or the UE may send/receive a user data via the N3GPP RAT.

In the specification, the term “access type” may be interpreted as, or may refer to, indicating a type of access used for communicating with a network. For example, this may comprise a 3GPP access type (or 3GPP access) and/or a N3GPP access type (or N3GPP access). For example, if the access type is the 3GPP access type, this may indicate that a UE is communicating with the network by using one or more 3GPP RATs, and/or via one or more 3GPP RANs. For example, if the access type is the N3GPP access type, this may indicate that a UE is communicating with the network by using one or more N3GPP RATs, and/or via one or more N3GPP RANs. In an example, access may comprise at least one of sending a data, receiving a data, sending a signalling message, receiving a signalling message, performing registration, and/or the like.

In the specification, the term “3GPP access type” may be interpreted as, or may refer to, an access using one or more 3GPP RATs, and/or via one or more 3GPP RANs.

In the specification, the term “N3GPP access type” may be interpreted as, or may refer to, an access using one or more N3GPP RATs, and/or via one or more N3GPP RANs.

In the specification, the term “Non-Integrated Non-3GPP Access” may be interpreted as a type of non-3GPP access network that provides direct IP connectivity between the UE and the UPF without any intermediate network function (NF) such as Non-3GPP interworking function (N3IWF) and trusted Non-3GPP gateway function (TNGF). When a UE is connected using Non-Integrated Non-3GPP Access, the UE data flows can be routed via this access to operator services. When a UE is connected using Non-Integrated Non-3GPP Access, the UE may not exchange signalling messages with a network via a N3GPP access.

In the specification, the term “access path” may be interpreted as, or may refer to, a path between a UE and a network for exchange of data and/or signalling. The access path may be an access leg, a path, an access route (route), an access track (track), an access channel (channel), an access corridor (corridor), an access link (link) and/or the like. The access path may indicate (be associated with) at least one of a path from a UE to a RAN, a path from a UE to a core network, a path from a RAN to a core network, the like, and/or a combination thereof. For example, the access path may be defined per a pair of a core network and/or an access network.

For example, for an access type, there may be one or more different types. For example, a first type of the access type (e.g., NIN3GPP) may support transporting of signalling message for the access type. For example, the signalling message may be one or more messages exchanged between a UE and one or more core network nodes. For example, the signalling message may not comprise one or more second messages of one or more applications outside of a core network. For example, the signalling message may be targeted to the UE and/or the one or more core network nodes. For example, a second type (e.g., non-NIN3GPP) of the access type may support transporting of signalling message for the access type.

For example, in one implementation, the access path may comprise at least a control plane. For example, in another implementation, the access path may not comprise the control plane. For example, the access path may or may not have a user plane. Before establishing a bearer transporting user data (e.g., voice data, IP packets), the access path may not have the user plane. After establishing the bearer, the access path may have the user plane.

For example, one or more N3GPP access paths may comprise a first type N3GPP access path and/or a second-type N3GPP access path. The first type N3GPP access path (e.g., Non-Integrated Non-3GPP Access) may not comprise a N3IWF. The second type N3GPP access path may comprise the N3IWF.

In the specification, the term “MA PDU Session” may be interpreted as, or may refer to, a PDU Session that provides a PDU connectivity service, which can use/establish one access type at a time, or simultaneously one 3GPP access and one N3GPP access, simultaneously more than one paths of 3GPP access type or simultaneously more than one paths of N3GPP access type.

In the specification, the term Access Traffic Steering, Switching, Splitting (ATSSS) may be a feature. The feature may enable a multi-access PDU connectivity service, which can exchange PDUs between the UE and a data network by simultaneously using one 3GPP access and one non-3GPP access and/or two independent N3/N9 tunnels between the PSA and RAN/AN (e.g., wifi access point). The multi-access PDU Connectivity Service may be realized by establishing a Multi-Access PDU (MA PDU) Session, i.e., a PDU Session that may have user-plane resources on two accesses (e.g., the 3GPP access and/or the non-3GPP access). For ATSSS, one or more ATSSS functionalities may be used. For example, the one or more ATSSS functionalities may comprise a first ATSSS functionality, a second ATSSS functionality, and/or the like. For example, the first ATSSS functionality may be an ATSSS-LL, the second ATSSS functionality may be a MPTCP functionality. For example, the ATSSS functionality may indicate which layer (e.g., entity, protocol, functionality of a UE and/or a UPF) is used for handling a traffic of a PDU session. For ATSSS, one or more steering modes may be used. For example, the one or more steering mode of the ATSSS may be Active-Standby, Smallest Delay, and/or the like. For example, the steering mode of the ATSSS may indicate which method may be used to distribute/steer a traffic of the PDU session.

In the specification, the term ATSSS type may be interpreted as an architecture, characteristics, and/or the like, used for supporting the ATSSS. The ATSSS type may be associated with a type of a PDU session, a feature of a PDU session, a characteristic of a MA PDU session, and/or the like. In one embodiments, a PDU session can be categorized non-MA PDU session (e.g., single PDU session), a MA PDU session of a first ATSSS type (e.g., NIN3GPP), a MA PDU session of a second ATSSS type (e.g., non-NIN3GPP), and/or the like. In one embodiments, a non-3GPP access of a PDU session can be categorized a NIN3GPP access, a non-NIN3GPP access, and/or the like.

For example, in supporting the feature of the ATSSS, a first ATSSS type (e.g., Non-Integrated Non-3GPP Access) may not comprise an N3IWF in a N3GPP access, the first ATSSS type may not use a signalling connection between a UE and a core network node (e.g., AMF, SMF) via the N3GPP access, the first ATSSS type may comprise (be, associated with) a first type PDU session established over at least the N3GPP access not using the N3IWF. For example, not using N3IWF may be that the UE and a UPF may exchange one or more PDUs, via the N3GPP access, and the one or more PDUs may not traverse the N3IWF. For example, not using N3IWF may be that the UE and an AMF (and/or SMF, and/or one or more core network node) may not exchange one or more signalling messages via the N3IWF (and/or via N3GPP access). The first ATSSS type may be an ATSSS-lite, a simplified ATSSS, a direct access, NIN3GPP, and/or the like. In some embodiments, the first ATSSS type may be Non-Integrated Non-3GPP Access (NIN3GPP).

In the specification, the term “NIN3GPP”, “NIN3GPP access”, “N3GPP access without N3IWF”, “first ATSSS type”, “simplified ATSSS”, “ATSSS-lite”, “first MA PDU session type” and/or the like may be used interchangeably.

For example, in supporting the feature of the ATSSS, a second ATSSS type (e.g., Integrated Non-3GPP Access) may comprise an N3IWF in a N3GPP access, the second ATSSS type may use a signalling connection between a UE and a core network node (e.g., AMF, SMF) via the N3GPP access, the second ATSSS type may comprise a second type PDU session using at least the N3GPP access using the N3IWF. For example, using the N3IWF may be that the UE and a UPF may exchange one or more PDUs, and the one or more PDUs may traverse the N3IWF. For example, using the N3IWF may be that the UE and an AMF (and/or SMF, and/or one or more core network node) may exchange one or more signalling messages via the N3IWF.

In the specification, the term “support of a ATSSS type” may be interpreted as, or may refer to, support of the ATSSS type. For example, the support of the ATSSS type may indicate a support of a first ATSSS type, a second ATSSS type, a plurality of ATSSS type, and/or the like. The indication of the support of the ATSSS type may be separate from an indication of support of ATSSS, from support of one or more ATSSS functionality, from support one or more steering modes. A UE supporting the ATSSS may further indicate which one or more ATSSS types (e.g., the first ATSSS type, the second ATSSS type, and/or the like) are supported by the UE. In another example, the support of the ATSSS may be interpreted as supporting the second ATSSS type. In another example, not supporting of the ATSSS may be interpreted as supporting the third ATSSS type.

For example, a feature of an ATSSS type (the first ATSSS type) may comprise at least one of sending/receiving a NAS message via a 3GPP access, not sending/receiving the NAS message via a N3GPP access, establishing a PDU which uses a first resource of the 3GPP access and a second resource of the N3GPP access, receiving configuration of the N3GPP access via the 3GPP access, and/or the like.

The ATSSS type may be interpreted as a type of MA PDU sessions, or a type of a PDU session.

In one embodiment, a third PDU session may be a single access (SA) PDU session. The SA PDU session may use (or be established using, use a resource of) a 3GPP access and/or may not use a N3GPP access. The third PDU session may be a PDU session of a third PDU session type. The third PDU session may be a PDU session of a third ATSSS type. The third PDU session may be a PDU session of a third MA PDU session type.

In one embodiment, a second PDU session may be a multi-access (MA) PDU session. The second PDU session may use (or be established using, use a resource of, be allowed to use) a 3GPP access and may use a N3GPP access. The N3GPP access may comprise (or use, use resource, communicate via) a N3IWF. The second PDU session may be a PDU session of a second PDU session type. The second PDU session may be a MA PDU session of a second MA PDU session type. The second PDU session may be a PDU session of a second ATSSS type.

In one embodiment, a first PDU session may be a multi-access (MA) PDU session. The first PDU session may use (or be established using, use a resource of, be allowed to use) a 3GPP access and may use a N3GPP access. The N3GPP access may not comprise (or use, use resource, communicate via) a N3IWF. The first PDU session may be a PDU session of a first PDU session type. The third PDU session may be a MA PDU session of a first MA PDU session type. The first PDU session may be a PDU session of a first ATSSS type.

One or more PDU session types (e.g., the first PDU session type, the second PDU session type, the third PDU session type) may corresponds to one or more ATSSS types. One or more MA PDU session types (e.g., the second MA PDU session type, the third MA PDU session type) may corresponds to one or more ATSSS types.

In one embodiment, support of ATSSS may be interpreted as supporting a MA PDU session. A node supporting the ATSSS may support one or more ATSSS types. A node not supporting the ATSSS may not support one or more ATSSS types. A first node of one or more nodes supporting the ATSSS may support a first ATSSS type and/or a second node of the one or more nodes supporting the ATSSS may not support the first ATSSS type.

In the specification, the term “mobility management node” may be interpreted as, or may refer to, a function and/or a node performing mobility management for a UE. For example, mobility management may be at least one of management of registration status, management of context, management of authorization, management of registration area, management of paging, and/or the like. For example, the mobility management node may comprise at least one of a MME, AMF, and/or the like.

In the specification, the term “network slice quota” for a network slice may be interpreted as a maximum number of UEs allowed to be registered for the network slice, a maximum number of PDU sessions allowed to be established for the network slice, a maximum number of PDU sessions allowed to be activated for the network slice, a maximum number of PDU sessions allowed to be deactivated for the network slice, and/or maximum number of countable resources for the network slice, and/or the like. In the specification, the term “quota” for a network slice may be interpreted as a network slice quota. In an example, the network slice quota may be counted considering an access type.

In the specification, the term “network slice admission control (NSAC)” may be interpreted as network slice quota management. In the specification, the network slice quota management for a network slice may comprise controlling access to the network slice. The network slice quota management for a network slice may comprise controlling admission to the network slice for a UE and/or for a PDU session and so on. For example, the network slice quota management may or may not allow establishment of a PDU session for the network slice. For example, the network slice quota management may or may not determine to allow a registration for the network slice.

In the specification, the UE may not perform registration procedure via the NIN3GPP access (e.g., N3GPP access). For example, in the example embodiments in this disclosure, the UE may not send the registration request via the N3GPP access, the UE may not receive the registration response via the N3GPP access and/or the UE may not communicate with a N3IWF.

In an example, a timer may begin running once it is started and continue running until it is stopped or until it expires. A timer may be started if it is not running or restarted if it is running. A timer may be associated with a value (e.g. the timer may be started or restarted from a value or may be started from zero and expire once it reaches the value). The duration of a timer may not be updated until the timer is stopped or expires (e.g., due to change of the value). A timer may be used to measure a time period/window for a process. When the specification refers to an implementation and procedure related to one or more timers, it will be understood that there are multiple ways to implement the one or more timers. For example, it will be understood that one or more of the multiple ways to implement a timer may be used to measure a time period/window for the procedure. For example, a network slice inactivity window timer (e.g., a NS UE monitoring timer, a NS PDU monitoring timer) may be used for measuring a window of time for measuring the network slice inactivity. In an example, instead of starting and expiry of a network slice inactivity window timer, the time difference between two time stamps may be used. When a timer is restarted, a process for measurement of time window may be restarted. Other example implementations may be provided to restart a measurement of a time window.

In an example, indication (e.g., indicate, indicating) may be achieved in various ways. For example, a first indication may be done by including a first field in a first signalling (e.g., a message). Alternatively and/or additional, a second indication may be done by not including the first field in the first signalling. For example, if a first message comprises the first field (e.g., used/assigned for the first indication, e.g., field A), the first indication (e.g., a timer is used) may be done (e.g., achieved, delivered from a sender to a receiver). For example, if the first field in the first message is set to a value A, a third indication (e.g., timer value is value A) may be done. For example, if the first message does not comprise the first field, the second indication (e.g., timer is not used) may be done. In another example, a fourth indication (e.g., a UE is allowed for action C) may be done by sending a second signalling (e.g., a message whose name comprises ‘C’ and/or ‘accept’). Alternatively and/or additionally, a fifth indication (e.g., a UE is not allowed for action C) may be done by not sending the second signalling (e.g., a message, a field (e.g., allowed bit)). For example, the sender can indicate A, by sending a message A1 comprising an indicator (e.g., an information element) indicating A and/or by sending a message A2. For example, the message A2 may be used only to indicate A and/or the message A2 itself may indicate the A. For example, when a first entity indicates to a second entity about first something, the first entity may send to the second entity, an indicator (e.g., an information element) indicating the first something, and/or may send to the second entity, a message comprising the indicator and/or may send a first dedicated message for the first something. In other example, when a first entity does not indicate to a second entity about second something, the first entity may not send to the second entity, a first indicator (e.g., an information element) indicating the second something, may not send to the second entity, a message comprising the first indicator, and/or may send to the second entity, a second indicator indicating that the second something does not apply, and/or may send a message not comprising the first indicator, and/or may send to the second entity, a second dedicated message for indicating the second something. In another example, not sending any message may be interpreted as an indication.

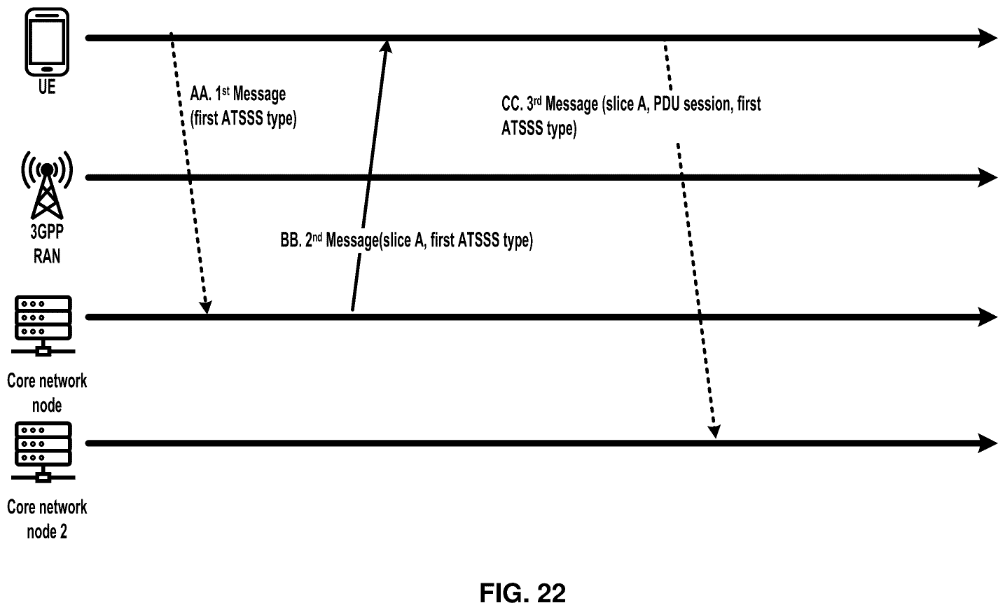

FIG. 22 illustrates an example as per an aspect of an embodiment of the present disclosure.

In an example, a UE may send a first message (1^{st} message) to a core network node. The first message may indicate at least one of a UE capability information and/or a UE request information. The UE capability information may indicate one or more capabilities supported by the UE and/or one or more features supported by the UE. The UE request information may indicate one or more requests of one or more features.

The one or more capabilities may indicate that the UE supports an ATSSS, that the UE supports one or more ATSSS types, that the UE supports a first ATSSS type, and/or the like. The one or more ATSSS type may comprise the first ATSSS type and/or a second ATSSS type. The first ATSSS type may be associated with a first PDU session using a first N3GPP access and/or the first N3GPP access may not employ (comprise) a N3IWF. The second ATSSS type may be associated with a second PDU session using a second N3GPP access and/or the second N3GPP access may employ at least one N3IWF. That the UE supports the ATSSS may be that the UE supports at least one of the one or more ATSSS type. If the UE indicates support of the ATSSS and/or if the UE does not indicate support of at least one of the one or more ATSSS type, the AMF may determine that the UE does not supports the first ATSSS type (e.g., using the N3GPP access without N3IWF). By separating an indication of the support of ATSSS type from an indication of the support of the ATSSS, may help the network to identify what is supported by the UE.

The one or more requests may comprise a first indication that the UE request a first configuration (policy) information associated with the one or more ATSSS type, and/or a second indication that the UE requests a second configuration information associated with the first ATSSS type. The one or more ATSSS type may comprise the first ATSSS type.

The first message may be a registration request message, a PDU session establishment request message, and/or the like. The first message may comprise an identifier of the UE. The first message may comprise one or more identifiers of one or more requested network slices.

In an example, the core network node may receive the first message from the UE. The core network node may be an AMF, a SMF, a PCF, and/or the like. The core network node may receive the first message via a 3GPP RAN and/or via a 3GPP access.

In an example, the core network node may determine to send a second message to the UE. The second message may comprise information of one or more network slices. The information of the one or more network slices may be an information of one or more allowed network slices and/or one or more configured network slices. The second message may comprise an indication indicating whether/which ATSSS type is allowed for the one or more network slices and/or an indication indicating whether/which ATSS type is allowed for each network slice of the one or more network slices. For example, the second message may comprise one or more identifiers of the one or more network slices and/or may indicate, for each network slice of the one or more network slices, whether the each network slice is allowed for the one or more ATSSS types, whether the each network slice is allowed for the first ATSSS type, and/or whether the each network slice is allowed for the second ATSSS type, and/or the like.

For example, the second message may indicate that a slice A (S-NSSAI A) is allowed for the first ATSSS type and/or that a slice B (S-NSSAI B) is not allowed for the second ATSSS type. For example, the first ATSSS type may be a direct access, a direct N3GPP access, a first N3GPP access without N3IWF, an ATSSS-lite, a simplified ATSSS, and/or the like. For example, the second ATSSS type may be a second N3GPP access with a N3IWF, an ATSSS, a normal ATSSS, and/or the like.

The second message may be a registration accept message, a UE configuration update message, a DL NAS transport message, and/or the like.

In an example, the UE may receive from the core network node, the second message.

The UE may perform a first registration procedure via a 3GPP access and/or the UE may not perform a second registration procedure via a N3GPP access. Based on first registration being successful, the UE may determine to initiate establishment of a PDU session.

In an example, based on the second message, based on the whether a network slice is allowed for an ATSSS type, the UE may determine whether to request the ATSSS for the PDU session, which ATSSS type to request for the PDU session, whether the network slice associated with the PDU session is allowed for the ATSSS type or not.

In an example, the UE may send a third message to a second core network. Because the slice A is allowed for the first ATSSS type, the third message may comprise an indication of the first ATSSS type, the identifier of the slice A, a request of a first PDU session, and/or the like.

In another example, the UE may send a fourth message to the second core network. Because the slice B is not allowed for the first ATSSS type, the third message may not comprise the indication of the first ATSSS type, may comprise the identifier of the slice B, the request of a second PDU session, and/or the like. If the slice B is allowed for the second ATSSS type, the third message may comprise an indication (request) of the second ATSSS type.

The example embodiment of the FIG. 22 may help in reducing unnecessary request of a UE for a PDU session, and/or unnecessary of an ATSSS type for the PDU session. For example, the UE may be able to determine whether a network slice is allowed for the ATSSS type (e.g., the first ATSSS type). This may prevent sending a request of the ATSSS type for a second network slice not supporting the first ATSSS type.

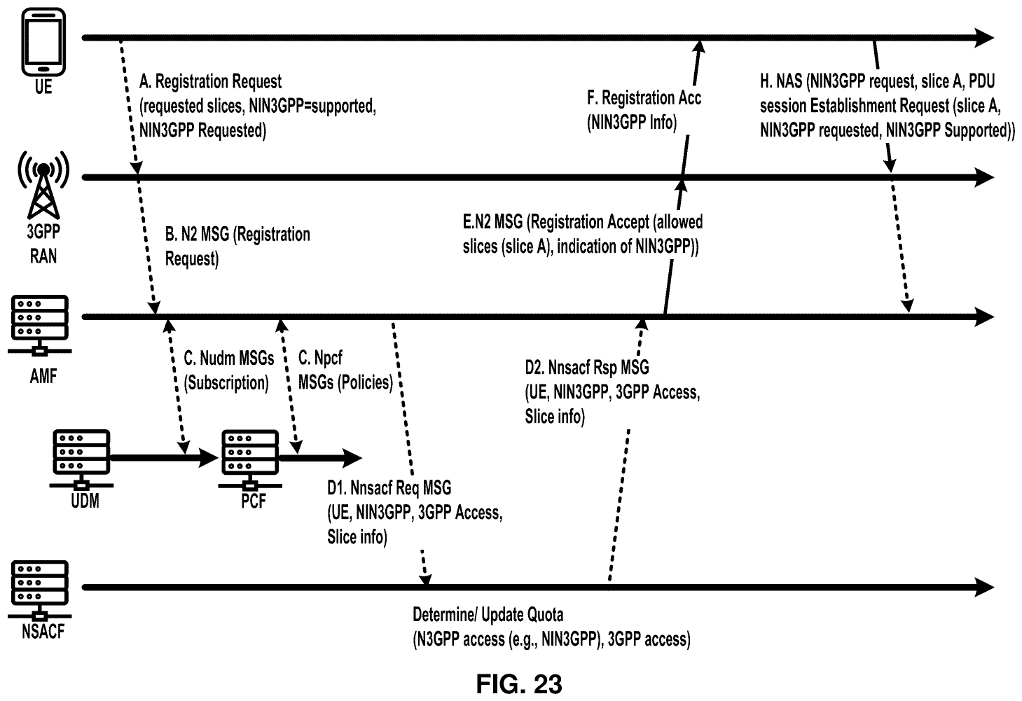

FIG. 23 illustrates an example as per an aspect of an embodiment of the present disclosure. For brevity, based on the other part of the present disclosure, redundant details will be omitted.

In an example, the UE may send a message A to a core network of a network, via a 3GPP RAN. For example, the message A may be at least one of a registration request message, a service request message, a PDU session establishment request message, a PDU session modification request message, a UL NAS transport message, and/or the like. For example, the message A may comprise at least one of an identifier (e.g., GUTI, TMSI, IMSI, IMEI, PEI) of the UE, one or more requested S-NSSAIs (e.g., one or more identifiers of one or more requested network slices), a request indication, a support indication, one or more PSIs, UE policy container, and/or the like. For example, the one or more requested S-NSSAIs may comprise a first S-NSSAI (e.g., first network slice) and/or a second S-NSSAI (e.g., a second network slice).

The request indication may indicate whether the UE requests an information associated with the feature of NIN3GPP, whether the UE requests the network to support the feature of the NIN3GPP, whether the UE requests a service via the NIN3GPP (e.g., the first N3GPP access, a MA PDU session not using a N3IWF) and/or the like. The request indication may be the one or more requests.

The feature of the NIN3GPP may be at least one of using an access of the NIN3GPP, using a PDU session of the NIN3GPP (access), using an ATSSS type (e.g., the first ATSSS type) associated with the NIN3GPP, using a MA PDU session (e.g., the first MA PDU session type) not comprising the N3IWF, using the MA PDU session comprising of the N3GPP access without the N3IWF, sending information associated with the NIN3GPP, receiving the information associated with the NIN3GPP, and/or the like. For example, the NIN3GPP may be an N3GPP access without a N3IWF, using a N3GPP access not comprising the N3IWF, not exchanging a signalling message via the N3GPP access, and/or the like.

The support indication may indicate whether the UE supports the feature of NIN3GPP. The support indication may be the one or more capabilities.

In one implementation, the request indication may be the support indication. In another implementation, the request information may be separate from the support indication. For example, the UE may want to indicate (e.g., by using the support indication) that the UE has a capability to support the feature of the NIN3GPP and/or the UE want to indicate (e.g., by using the request indication) that the UE does not want to use the feature of the NIN3GPP. This may help the network to determine whether to use the feature of the NIN3GPP for the UE and/or for the network slice.

The UE may send the message A to the 3GPP RAN. For example, the UE may send to the 3GPP RAN, a RRC message A comprising the message A. The 3GPP RAN may send to the AMF, a N2 message B. For example, the N2 message B may comprise the message A.

The AMF may receive the message A sent by the UE, via the 3GPP RAN.

In an embodiment, in response to receiving the message A, the AMF may send a message C1 to a UDM (or a HSS, UDR, user subscription management node, and/or the like). For example, the message C1 may be a first Ndum message. The first Nudm message may be at least one of Nudm_UECM_Registration request message, Nudm_UECM_Get request message, Nudm_UECM_Update request message, Nudm_SDM_Get request message, Nudm_SDM_Subscribe request message, and/or the like. The first Nudm message may comprise at least one of an identifier of the AMF, a SUPI of the UE, a GUTI of the UE, an access type, a GUAMI, a RAT type, a registration type, a location (e.g., cell ID, TA ID associated with the first 3GPP RAN) of the UE, and/or the like. For example, the access type may indicate the 3GPP access type, used by the UE for sending the message A.

In response to sending the message C1, the AMF may receive from the UDM, a message C2. The message C2 may be a second Nudm message (Nudm MSG 2). The second Nudm message may be at least one of Nudm_UECM_Registration response message, Nudm_UECM_Get response message, Nudm_UECM_Update response message, Nudm_SDM_Get response message, Nudm_SDM_Subscribe response message, and/or the like. The second Nudm message may comprise at least one of the identifier of the AMF, the access type, a subscription information, and/or the like. The subscription information may be a NIN3GPP subscription information (or a direct access subscription information, a MA PDU types subscription information, a ATSSS types subscription information, and/or the like). The subscription information may indicate whether the UE is allowed to use the feature of the NIN3GPP, whether the UE is allowed to use a PDU session associated with (e.g., using, configured with) the NIN3GPP access, whether the first ATSSS type (e.g., the first MA PDU session type) is allowed to the UE, whether a subscribed network slice of the UE is allowed for the NIN3GPP access, and/or the like. For example, the subscription information may indicate, for the UE, that the UE is allowed to use the NIN3GPP access, that the UE is allowed for the first ATSSS type, that the PDU using a resource of the NIN3GPP access is allowed for the UE, that the feature of the NIN3GPP is allowed for the UE, that the feature of the NIN3GPP is allowed for the subscribed network slice, and/or the like. The second Nudm message may indicate one or more network slices subscribed by the UE. The second Nudm message may further indicate whether a first network slice of the one or more network slices is allowed for the NIN3GPP access, whether the first ATSSS type is allowed for the first network slice, and/or the like. The second Nudm message may further indicate whether the first network slice is allowed for the second ATSSS type, for the ATSSS, and/or for a non-NIN3GPP access. For example, the second Nudm message may indicate that the first network slice is allowed for the NIN3GPP access and/or that the second network slice is not allowed for the NIN3GPP access. The second Nudm message may further indicate whether the UE is allowed for the feature of ATSSS, one or more steering modes allowed for the UE, one or more ATSSS functionalities allowed for the UE. In an embodiment, allowed may be interpreted as subscribed.

In an embodiment, in response to receiving the message A, the AMF may send a message C3 to a PCF (e.g., a policy and charging management node). For example, the message C3 may be at least one of a Npcf_AMPolicyControl_Create request message, Npcf_UEPolicyControl_Create request message, Namf_Communication_N1MessageNotify request message and/or the like. For example, the message C3 may comprise at least one of the identifier of the UE, the subscription information, a capability indication that the UE supports the feature of NIN3GPP, information of the one or more requested S-NSSAIs, a NIN3GPP policy request indication, the one or more PSIs (policy section indicator), the UE policy container and/or the like.

In one example, the UE policy container may comprise the NIN3GPP policy request indication and/or the one or more PSIs associated with the NIN3GPP. The one or more PSIs may indicate whether the UE has a stored NIN3GPP policy information or not, and/or may indicate that the UE requests the NIN3GPP policy information. The NIN3GPP policy request indication may indicate that the AMF requests the NIN3GPP policy information.

In response to sending the message C3, the AMF may receive from the PCF, a message C4. For example, the message C4 may be a Npcf message C4. The Npcf message C4 may comprise the NIN3GPP policy information and/or a second policy container associated with the NIN3GPP. The second policy container may comprise the NIN3GPP policy information. For example, the Npcf message D may be at least one of the Npcf_AMPolicyControl_Create response message, Npcf_UEPolicyControl_Create response message, Namd_Communication_N1N2MessageTransfer request message and/or the like.

The NIN3GPP policy information may indicate at least one of whether the UE is allowed for the NIN3GPP access. The NIN3GPP policy information may indicate, for each S-NSSAI of the one or more requested (or configured, subscribed)S-NSSAIs, whether the each S-NSSAI is allowed for the NIN3GPP access. The NIN3GPP policy information may indicate one or more locations where the UE is allowed to use the NIN3GPP access. The NIN3GPP policy information may indicate one or more time periods when the UE is allowed to use the NIN3GPP access. The NIN3GPP policy information may indicate one or more network identifiers for which the UE is allowed to use the NIN3GPP access, and/or the like. For example, based on the NIN3GPP policy information, when one or more information of the NIN3GPP policy information (e.g., condition (e.g., the network, the time periods, the locations) of the NIN3GPP policy information) are satisfied, the UE may request a service (e.g., registration, PDU session) of the each S-NSSAI (allowed for the NIN3GPP access) for the first ATSSS type. In an implementation, the second policy container may comprise the NIN3GPP access policy information.

In an embodiment, the AMF may determine, at least one of one or more allowed S-NSSAIs, one or more first S-NSSAIs allowed for the feature of the NIN3GPP access (e.g., the first ATSSS type), one or more second S-NSSAIs allowed for the second ATSSS type, one or more third S-NSSAIs not allowed for the feature of ATSSS, and/or the like. Because the UDM indicates that the first network slice is allowed for the NIN3GPP access, because the PCF indicates that the first network slice is allowed for the NIN3GPP access, and/or because the UE requests the first network slice, the AMF may determine that the first network slice is allowed for the NIN3GPP access, that the first network slice is allowed for the ATSSS, and/or the like. If the UDM indicates that the second network slice is not allowed for the NIN3GPP access, if the PCF indicates that the second network slice is not allowed for the NIN3GPP access, and/or if the UE requests the second network slice, the AMF may determine that the second network slice is not allowed for the NIN3GPP access, that the second network slice is allowed for the ATSSS, and/or the like.

In an embodiment, in response to receiving at least one of the message A, the message C2, and/or the message C4, the AMF may send a message D1 to a NSACF (or NSCAF). For example, the message D1 may be Nnsacf_NSAC_NumOfUEsUpdate Request message, and/or the like. The message D1 may comprise at least one of identity of the network slice (e.g., the first S-NSSAI, a first network slice), the identity of the UE, the access type, an update flag, indication of an ATSSS type, and/or the like. The access type may indicate an access type (the 3GPP access) over which the AMF receives the message A. The update flag may indicate whether the number of UEs registered with the network slice needs to be increased or decreased. The indication of the ATSSS type may indicate that the UE requests the first ATSSS type, that the first network slice (e.g., the first S-NSSAI) is requested for the first ATSSS type, and/or the like. Alternatively and/or additionally, the access type may be the indication of the ATSSS type. Alternatively and/or additionally, the access type may indicate the 3GPP access and the N3GPP access.

The NSCAF may receive the message D1. The NSCAF may send a message D2 to the AMF. The message D2 may be Nnsacf_NSAC_NumOfUEsUpdate Response message and/or the like. The message D2 may comprise at least one of the identifier of the network slice, a result indication, and/or the like. The result indication may indicate an outcome of update and/or check operation in the NSACF. The result indication may indicate at least one of ‘maximum number of UEs for the first S-NSSAI not reached’, ‘maximum number of UEs for the first S-NSSAI reached’, ‘maximum number of UEs for the first S-NSSAI not reached for the first ATSSS type’, ‘maximum number of UEs for the first S-NSSAI reached for the first ATSSS type’, ‘maximum number of UEs for the first S-NSSAI not reached for the 3GPP access, ‘maximum number of UEs for the first S-NSSAI reached for the N3GPP access’, ‘maximum number of UEs for the first S-NSSAI not reached for the NIN3GPP access’, ‘maximum number of UEs for the first S-NSSAI reached for the NIN3GPP access’, ‘the first ATSSS type is allowed for the first S-NSSAI’, ‘the first ATSSS type is not allowed for the first S-NSSAI’, and/or the like.

In response to sending the message D1, the AMF may receive from the NSCAF, a message D2.

In response to receiving at least one of the message A, the message C2, the message C4, and/or the message D2, the AMF may send to the UE, a message F. For example, the message F may be at least one of a registration accept message, a UE configuration update message, a DL NAS transfer message, and/or the like. For example, the message F may indicate that the UE is successfully registered. For example, the message F may comprise at least one of one or more allowed S-NSSAIs, an information of the direct access, an information of the ATSSS type, the NIN3GPP policy information, the second policy container, and/or the like. For example, the message H (e.g., via the information of the ATSSS type, the NIN3GPP policy information) may indicate at least one of whether the first S-NSSAI of the one or more allowed S-NSSAIs are allowed, whether the first S-NSSAI is allowed for the first ATSSS type (e.g., the NIN3GPP), whether the first S-NSSAI is allowed only for the 3GPP access, whether the first S-NSSAI is allowed for both the 3GPP access and the N3GPP access, whether the UE is allowed for the first ATSSS type, and/or the like. The direct access information may comprise the information of the ATSSS type, the NIN3GPP policy information, and/or the like. NIN3GPP policy information may be the second policy container,

In an example, the AMF may send a message E to the 3GPP RAN. The message E may comprise the message F. The 3GPP RAN may forward the message F to the UE.

In an embodiment, the UE may receive the message F, via the 3GPP RAN. Based on the message F, the UE may determine at least one of which network slices are allowed, which network slices are allowed for the first ATSSS type, which network slices are allowed for the second ATSSS type, which network slice are allowed for the third ATSSS type, which network slices are allowed for the 3GPP access, which network slices are allowed for the N3GPP access, which network slices are allowed for the NINN3GPP access, whether the network supports a feature of the ATSSS, and/or the like. For example, the message F may indicate at least one of that the first S-NSSAI is allowed, that the first S-NSSAI is allowed for the first ATSSS type (e.g., the NIN3GPP), that the first S-NSSAI is allowed (registered) for the 3GPP access, that the first S-NSSAI is allowed (registered) for the N3GPP, that the first S-NSSAI is allowed (registered) for the NIN3GPP, and/or the like. Based on the message F, the UE may determine that the UE is allowed for the first ATSSS type for the first S-NSSAI. In an embodiment, based on the message F, because the message F indicates the UE being registered for the N3GPP (or NIN3GPP), the UE may not perform registration procedure via the N3GPP access. In an embodiment, based on receiving the message F indicating the UE being allowed for the first ATSSS type, for the N3GPP access registration status, the UE may transit from RM-deregistered to RM-registered.

In an example, based on the message F, the UE may send a message H to a second AMF. The second AMF may be the AMF. The message H may be at least one of a second registration request message, a second service request message, a second PDU session establishment request, a second PDU session modification request, a second UL NAS transfer message, and/or the like. The message H may comprise at least one of; a first indication indicating of establishment of a new PDU session of the first ATSSS type; a second indication indicating of modification of an existing PDU session (e.g., of the second/third ATSSS type) to the first ATSSS type; a third indication of the first ATSSS type; a fourth indication indicating an identifier of a PDU session (of the new PDU session or of the existing PDU session); a fifth indication indicating the first S-NSSAI; a sixth indication indicating that the UE supports the first ATSSS type; a seventh indication indicating request of the first ATSSS type; and/or the like. Based on the message F, because the message F indicates that the first ATSSS type is allowed for the first S-NSSAI, the message H may indicate the first S-NSSAI. In another embodiment, if the message F indicates that the first ATSSS type is not allowed for the first S-NSSAI, the message H may not request a PDU session of the first ATSSS type and/or the second ATSSS type.

In an embodiment, because the message F indicates that the first ATSSS type is allowed for the first S-NSSAI, the UE may send a NAS message (e.g., the message H) to the AMF. For example, the NAS message may be the second UL NAS transfer message. The second UL NAS transfer message may comprise the first S-NSSAI, an indication requesting the first ATSSS type, a NAS container comprising a PDU session establishment (or modification) request message, one or more elements of the message H, and/or the like. The NAS container (e.g., the PDU session establishment (modification) request message) may comprise the first S-NSSAI, an indication indicating a request of the first ATSSS type.

In an embodiment, the AMF may receive the NAS message and/or the message H. In response to the NAS message and/or the message H, the AMF may send a Nsmf message to a SMF. For example, the Nsmf message may comprise the PDU session establishment (modification) request message. This may help the SMF to determine whether the UE is requesting a PDU session of the first ATSSS type, whether the UE supports the PDU session of the first ATSSS type. The Nsmf message may be at least one of Nsmf_PDUSession_CreateSMContext request message, a Nsmf_PDUSession_UpdateSMContext request message, and/or the like.

In another example, based on the message F (e.g., because the second network slice is not allowed for the first ATSSS type), the UE may not send a third PDU session establishment request message (or third PDU session modification request message) to the AMF (or the SMF). For example, the third PDU session establishment request message may request the third PDU session to be of the third ATSSS type, for the second network slice. Alternatively and/or additionally, based on the message F (e.g., because the second network slice is not allowed for the first ATSSS type), the UE may send a fourth PDU session establishment request message (or fourth PDU session modification request message) to the AMF (or the SMF). For example, the fourth PDU session establishment request message may request a fourth PDU session of the second ATSSS type, for the second network slice.

The example embodiment of the FIG. 23 may help a first core network node (e.g., AMF) to properly determine which network slice (or UE) can use an ATSSS type of a plurality of ATSSS types. The example embodiment of the FIG. 23 may help a second core network node (e.g., NSCAF) to properly manage a quota of a network slice. The example embodiment may help the UE to use resources of the N3GPP access, without performing registration procedure via the N3GPP access. The example embodiment may prevent the UE from requesting a PDU session for a network slice which is not allowed for the NIN3GPP access.

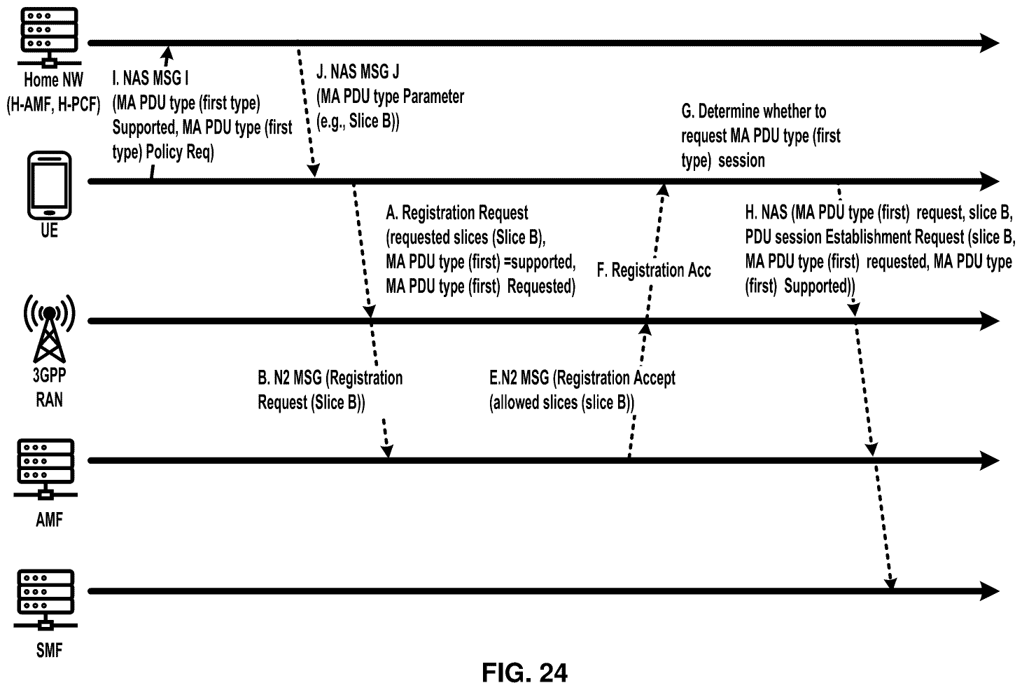

FIG. 24 illustrates an example as per an aspect of an embodiment of the present disclosure. For brevity, based on the other part of the present disclosure, redundant details will be omitted.

In an example, a UE may send a message I to a core network node. The core network node may be at least one of a first AMF, a first PCF, a first SMF, a first UDM, a first SoR-AF, and/or the like. The core network node may be of a home network (e.g., HPLMN) of the UE. The message I may be sent via a 3GPP access. The message I may be at least one of a registration request message, a service request message, a PDU session establishment request message, a PDU session modification request message, a UL NAS transport message, and/or the like. The message | may comprise at least one of an identifier (e.g., GUTI, TMSI, IMSI, IMEI, PEI) of the UE, a request indication, a support indication, one or more PSIs, a UE policy container, and/or the like. In an embodiment, the request indication of the message I may be similar to the request indication of the message A and/or the support indication of the message I may be similar to the support indication of the message A. For example, the request indication may indicate that the UE requests a NIN3GPP policy information. The request indication may be a request indication of the NIN3GPP policy information, and/or one or more PSIs of the NIN3GPP policy information.

In an example, the core network node may receive the message I. The core network may determine to send to the UE, a message J. For example, the message J may be at least one of a registration accept message, a UE configuration update message, a DL NAS transfer message, and/or the like. For example, the message J may comprise the NIN3GPP policy information. For example, the NIN3GPP policy information of the message J may be similar to the NIN3GPP policy information of the message F. The NIN3GPP policy information may be a configuration information of one or more MA PDU session type parameters, a configuration parameter of one or more direct access parameters, a configuration parameter of one or more ATSSS type parameters, a URSP, a network slice selection policy for MA PDU (for the direct access, for the ATSSS) and/or the like.

In an embodiment, the NIN3GPP policy information may comprise information of one or more configured S-NSSAIs. The information of the one or more configured S-NSSAIs may indicate, for each configured S-NSSAI of the one or more configured S-NSSAIs, whether the each configured S-NSSAI is allowed for a first MA PDU session type (e.g., a MA PDU session with the NIN3GPP access, a MA PDU session without non-NIN3GPP access, a PDU session with an N3GPP access without N3IWF, and/or the like), whether the each configured S-NSSAI is allowed for a second MA PDU session type (e.g., a MA PDU session with non-NIN3GPP access, with an N3GPP access with N3IWF), whether the each configured S-NSSAI is allowed only for the 3GPP access, whether the each configured S-NSSAI is not allowed for the NIN3GPP access, whether the each configured S-NSSAI is allowed for both the 3GPP access and the N3GPP access, whether the UE is allowed for MA PDU session (e.g., ATSSS), and/or the like.

In an example, the NIN3GPP policy information may comprise one or more QoS rules. Each QoS rule of the QoS rules may comprise a traffic filter (traffic description) indicating a service data flow. The traffic filter may indicate an application, one or more header field value of one or more data packet, an application name, and/or the like. The each QoS rule may comprise an information of a S-NSSAI, which is used for delivering a traffic (e.g., user packet, user PDU) matching the traffic filter of the each QoS rule. The information of the S-NSSAI may indicate whether the S-NSSAI is allowed for the first MA PDU session type, whether the S-NSSAI is allowed for the second MA PDU session type, whether the S-NSSAI is allowed for the third MA PDU session type, whether the S-NSSAI is allowed only for the 3GPP access, whether the S-NSSAI is not allowed for the NIN3GPP access, whether the S-NSSAI is allowed for both the 3GPP access and the N3GPP access, whether the UE is allowed for MA PDU session (e.g., ATSSS), and/or the like.

The NIN3GPP policy information may comprise one or more conditions. For example, the one or more conditions may comprise one or more location areas and/or one or more time periods, one or more network identifiers, and/or the like. The UE may apply the information of the NIN3GPP policy (e.g., using a network slice for a first MA PDU session type), when the one or more conditions are met. For example, if a first time periods of the one or more time periods is met, the UE may use the NIN3GPP policy and/or may use the each configured S-NSSAI (e.g., first S-NSSAI, the slice B) for the first ATSSS type. For example, if a first location of the one or more locations is met, the UE may use the NIN3GPP policy and/or may use the each configured S-NSSAI (e.g., first S-NSSAI, the slice B) for the first ATSSS type.

In an example, the NIN3GPP policy information may indicate a slice B. The NIN3GPP policy information may indicate that the slice B is configured for one or more packets of an application B. The NIN3 GPP policy information may indicate that the slice B is allowed for the first MA PDU session type (e.g., a MA PDU session not using the N3IWF)

In an example, the UE may receive the message J. The UE may store the information delivered by the message J. For example, the UE may use the information, when the UE connects to other networks than the home network. For example, because the home network manages subscription information of the UE, the message J may allow the home network to control behavior of the UE, when the UE moves into coverage of other networks than the home network.

In an example, the UE may select a second network. In some implementation, the second network may be the home network.

In an example, the UE may send the message A. For example, the message A may indicate that the UE requests the slice B (e.g., S-NSSAI B), that the UE requests the second network to support the first MA PDU session type (for the slice B or for the UE), that the UE supports the first MA PDU session type, and/or the like. The message A may be a registration request message, a service request message, a UL NAS message, and/or the like.

In an example, an AMF of the second network may receive the message A, via a 3GPP RAN.

In an example, in response to receiving the message A, the AMF may send the message F to the UE. For example, the message F may indicate that the slice B is allowed for the UE and/or the message F may indicate that the slice B is allowed for the first ATSSS type, and/or the message F may indicate that the second network supports a feature of the ATSSS.

In an example, the UE may determine whether to request a PDU session (of the first ATSSS type) or not. For example, the UE may determine whether to request the PDU session of the first MA PDU session type or not. The UE may consider the NIN3GPP policy information received from the home network, one or more information of the message F, and/or the like. For example, because the NIN3GPP policy information indicates that the slice B is allowed (configured) for the first MA PDU session type, because the message F indicates that the slice B is allowed (registered) for the second network, because a user data traffic associated with the slice B is generated (according to the QoS rule), because the NIN3GPP policy indicates that the second network is allowed for the first MA PDU session type, because the message F indicates that the second network supports the first MA PDU session type, and/or the like, the UE may determine to request a PDU session of the first MA PDU session type for the slice B.

In an example, the UE may send the message H, to the AMF of the second network. For example, the message H may indicate at least one of a first request of a PDU session, a second request of the PDU session being the first MA PDU session type, a third request of the ATSSS, a fourth request of the MA PDU session, a fifth request of the first ATSSS type, an identifier of the slice B, a PDU session message (e.g., the second PDU session establishment request message, the second PDU session modification request message), and/or the like. In one implementation, the PDU session message may comprise the first request, the second request, the third request, the fourth request, the fifth request, and/or the like.

The example embodiment of FIG. 24 may help a home network to control whether the UE can send to a second network (e.g., a visited network), a request requesting a MA PDU session type of one or more MA PDU session types. This may prevent the UE from sending a request requesting the MA PDU session type for a network slice, to a network whose AMF may not support the MA PDU session type.

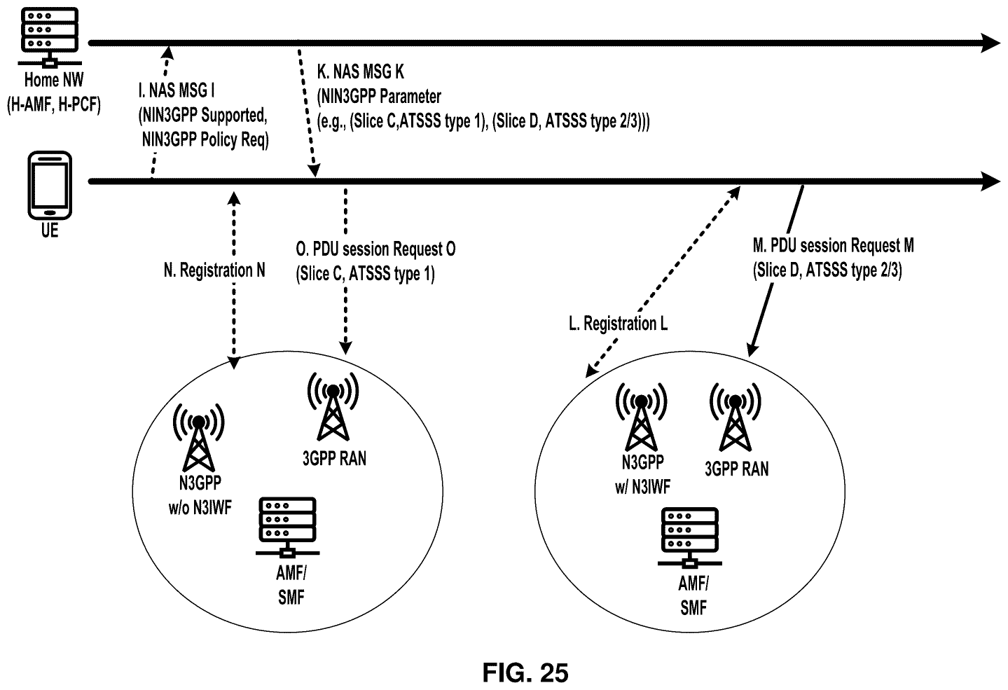

FIG. 25 illustrates an example as per an aspect of an embodiment of the present disclosure. For brevity, based on the other part of the present disclosure, redundant details will be omitted.

In an example, the UE may send the message I to the core network node. The message I may indicate that the UE supports a direct access and/or that the UE requests a policy information for the direct access. The direct access may indicate the first MA PDU session type, the first ATSSS type, the NIN3GPP access, the ATSSS-lite, the simplified ATSSS, and/or the like.

In an example, the UE may receive a message K. For example, the message k may be at least one of a registration accept message, a UE configuration update message, a DL NAS transfer message, and/or the like. The message K may comprise one or more information of the message J. For example, the message K may comprise a direct access parameter (e.g., NIN3GPP parameter). The direct access parameter may be similar to the NIN3GPP policy information. For example, the NIN3GPP policy information of the message K may be similar to the NIN3GPP policy information of the message J. The NIN3GPP policy information may be configuration information of one or more MA PDU session type parameters, configuration parameter of one or more direct access parameters, configuration parameter of one or more ATSSS type parameters, a URSP, a network slice selection policy for MA PDU (or direct access, an ATSSS) and/or the like.

In an example, the direct access parameter may indicate one or more network slices. The one or more network slices may comprise a slice C and/or a slice D. The direct access parameter may indicate that the slice C is configured (e.g., allowed) for the direct access (e.g., the first MA PDU session type, the first ATSSS type, and/or the like). The direct access parameter may indicate that the slice D is not configured (e.g., allowed) for the direct access (e.g., the first MA PDU session type, the first ATSSS type, and/or the like), that the slice D is configured (e.g., allowed) for a non-direct access (e.g., the second MA PDU session type, the second ATSSS type, the third MA PDU session type, the third ATSSS type, a single PDU session and/or the like).

In an example, the UE may select a cell of a third network. The third network may comprise a 3GPP access and/or the third network may comprise a N3GPP access without a N3IWF. Because the third network supports the N3GPP access without a N3IWF, the UE may determine that the third network supports the first MA PDU session type, that the third network supports the first ATSSS type, that the third network supports the direct access, and/or the like. For example, the third network may indicate to the UE via a system information block (e.g., SIB), whether the first MA PDU session type is supported or not.

In an example, the UE may send a third registration request message to the third network. The UE may receive a third registration accept message from the third network. The third registration accept message may indicate that the third network supports the N3GPP access without the N3IWF.

In an example, based on the third registration accept message and/or the direct access parameter, the UE may determine to request a PDU session of the first ATSSS type, using the slice C. For example, because the third registration accept message (or the SIB) indicates the support of the N3GPP access without the N3IWF, because the direct access parameter indicates that the slice C is configured for the direct access, and/or the like, the UE may send a third PDU session establishment request message. For example, the third PDU session establishment request message may indicate at least one of the slice C, the request of the direct access (e.g., the first ATSSS type, the first MA PDU session type, and/or the like), and/or the like.

In an example, the UE may select a fourth cell of a fourth network. The fourth network may comprise a 3GPP access and/or the fourth network may comprise (or support) a N3GPP access with a N3IWF and/or the fourth network may not comprise (or support) a N3GPP access without a N3IWF. Because the fourth network supports the N3GPP access with a N3IWF, and/or because the fourth network does not support the N3GPP access without a N3IWF, the UE may determine that the fourth network supports the second MA PDU session type (or the third MA PDU session type), that the fourth network supports the second ATSSS type (or the third ATSSS type), that the fourth network does not support the direct access, and/or the like.

In an example, based on the determination, the UE may send a fourth registration request message to the fourth network. The UE may receive a fourth registration accept message from the fourth network. The fourth registration accept message may indicate that the fourth network supports the N3GPP access with the N3IWF and/or that the fourth network does not support the N3GPP access without the N3IWF.

In an example, based on the fourth registration accept message and/or based on the direct access parameter, the UE may determine to request a PDU session of the second ATSSS type (or the third ATSSS type), using the slice D. For example, because the fourth registration accept message indicates the support of the N3GPP access with the N3IWF, because the direct access parameter indicates that the slice D is configured for the second MA PDU session type (or the third MA PDU session type), and/or the like, the UE may send a fourth PDU session establishment request message. For example, the fourth PDU session establishment request message may indicate at least one of the slice D, the request of the second MA PDU session type (or the third MA PDU session type, the third ATSSS type, the second ATSSS type, the non-direct access, and/or the like), and/or the like.

The example embodiment of FIG. 25 may help a UE to determine when to request which network slice for which PDU session type. This may prevent the UE from sending a request requesting the MA PDU session type for a network slice, to a network not supporting the MA PDU session type.

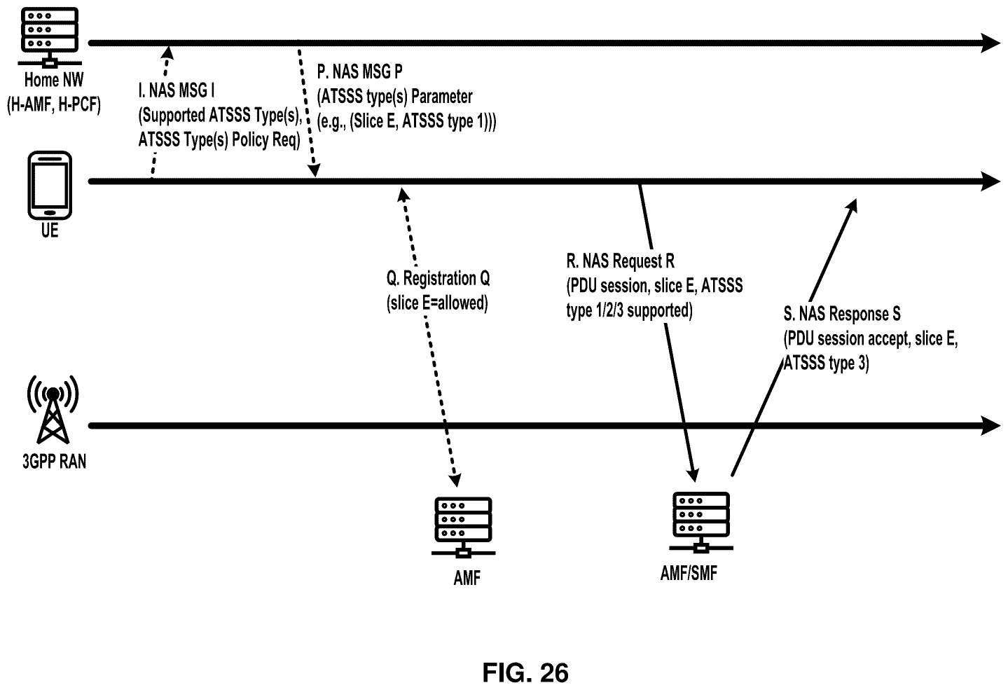

FIG. 26 illustrates an example as per an aspect of an embodiment of the present disclosure. For brevity, based on the other part of the present disclosure, redundant details will be omitted.

In an example, the UE may send the message I to the core network node. The message I may indicate that the UE supports one or more ATSSS types of the feature of ATSSS and/or that the UE requests the policy of one or more ATSSS types. The policy of the one or more ATSSS types may be the policy information for the direct access, the NIN3GPP policy information, a policy of one or more MA PDU session types, and/or the like. The term ‘direct access’, ‘first MA PDU session type’, ‘first ATSSS type’, ‘NIN3GPP access’, ‘ATSSS-lite’, ‘simplified ATSSS’ may be used interchangeably.

In an example, the UE may receive a message P. For example, the message P may be at least one of a registration accept message, a UE configuration update message, a DL NAS transfer message, and/or the like. The message P may comprise one or more information of the message K. For example, the message P may comprise ATSSS types parameter (one or more parameters for one or more ATSSS types). The ATSSS types parameters may be the direct access parameter. The ATSSS types parameters may be the configuration information of one or more MA PDU session type parameters, the configuration parameter of one or more direct access parameters, the configuration parameter of one or more ATSSS type parameters, the URSP, a network slice selection policy for MA PDU (or direct access, an ATSSS) and/or the like.

In an example, the ATSSS types parameter may indicate one or more network slices. The one or more network slices may comprise a slice E and/or a slice E1. The ATSSS types parameter may indicate that the slice E is configured (e.g., allowed) for a one or more first ATSSS types (e.g., the first ATSSS type (e.g., a PDU session using the 3GPP access and the N3GPP access without the N3IWF), the second ATSSS types (e.g., a PDU session using the 3GPP access and the N3GPP access with the N3IWF), the third ATSSS types (e.g., a PDU session using the 3GPP access and not using the N3GPP access) and/or the like). The ATSSS types parameter may indicate that the slice E1 is not configured (e.g., allowed) for one or more second ATSSS types (e.g., the first ATSSS type, the second ATSSS type, and/or the like), that the slice E1 is configured (e.g., allowed) for one or more third ATSSS types (e.g., the third ATSSS type (e.g., a PDU session not using the N3GPP access and/or the like).

In an example, the UE may select the cell of a fifth network.

In an example, the UE may send a NAS message Q to a fifth AMF of the fifth network. The NAS message Q may be at least one of a registration request message Q, a service request message Q, a UL NAS transport message Q, and/or the like. The NAS message Q may indicate that the UE requests registration of the slice E.

In an example, the UE may receive a NAS message Q1, in response to sending the NAS message Q. The NAS message Q1 may comprise an indication that the slice E is allowed for the UE. The NAS message Q1 may be received via a 3GPP RAN. Because the NAS message Q1 is received via the 3GPP RAN (or a 3GPP RAN), the UE may determine that the slice E is allowed for the 3GPP access. The NAS message Q1 may be at least one of a registration accept message Q, a service accept message Q, a DL NAS transport message Q, a UE configuration update message Q, and/or the like.

In an example, in response to receiving the NAS message Q1 indicating that the slice E is allowed, in response to receiving one or more packets from upper layer of the UE, in response to the ATSSS types parameter indicating that the one or more packets use (are configured for) the slice E, in response to the ATSSS types parameter indicating that the first ATSSS type is allowed for the slice E, the UE may determine to send a NAS message R, via the 3GPP access, to the AMF (or a SMf).

The NAS message R may be at least one of a registration request message R, a service request message R, a UL NAS transport message R, a PDU session request R and/or the like. The PDU session request R may be at least one of a PDU session establishment request message R, a PDU session modification request message R, and/or the like. The NAS message R may indicate at least one of that the UE requests establishment of a PDU session, that the UE requests modification of the PDU session, that the PDU session is associated with the slice E, that the UE supports one or more ATSSS types (e.g., the first ATSSS type, the second ATSSS type, the third ATSSS type), that one or more requested ATSS types (e.g., the first ATSSS type) are requested, and or the like.

The SMF may receive the NAS message R and/or one or more information elements of the NAS message R, via the AMF. The SMF may determine which one of the one or more requested ATSSS types to use for the PDU session. To determine, the SMF may send a SM policy establishment request message to a PCF. For example, the SM policy establishment request message may comprise one or more informations of the NAS message R. The SMF may receive a SM policy establishment response message from the PCF. The SM policy establishment response may indicate whether the PDU session is allowed, whether the slice E is allowed for the PDU session, which one or more allowed ATSSS types are allowed for the PDU session, and/or the like.

In an example, in response to receiving the NAS request message R, the SMF may send to the UE, a NAS response message S. The NAS response message S may be at least one of a registration accept message S, a service accept message S, a DL NAS transport message S, a PDU session response message S and/or the like. The PDU session response message S may be at least one of a PDU session establishment accept message S, a PDU session modification accept message S, and/or the like.

In one example, if the SMF policy establishment response message indicates that the first ATSSS type is allowed for the PDU session, the SMF may determine to apply the first ATSSS type for the PDU session and/or may determine to apply the first ATSS for the slice E. The NAS response message S may indicate that the PDU session is accepted, that the slice E is used for the PDU session, that the PDU session is of the first ATSSS type, that the slice E is allowed (registered) for the N3GPP access, and/or the like. The NAS response message S may comprise one or more parameters for configuring (establishing) a N3GPP resource for the N3GPP access without the N3IWF. In an embodiment, based on receiving the NAS response message S (e.g., comprising the one or more parameters), for the N3GPP access registration status, the UE may transit from RM-deregistered to RM-registered. This may help for the UE to manage the N3GPP access registration status, without exchanging signalling message with the AMF via the N3GPP access. For example, by transitioning to the RM-registered, the UE may monitor activity (or inactivity) of the slice E for the N3GPP access.

In another example, if the SMF policy establishment response message indicates that the first ATSSS type is not allowed for the PDU session (or for the slice E), the SMF may determine to apply one of the second ATSSS type or the third ATSSS type, for the PDU session. The NAS response message S may indicate that the PDU session is accepted, that the slice E is used for the PDU session, that the PDU session is of the third (or the second) ATSSS type, and/or the like. The NAS response message S may not comprise one or more parameters for configuring (establishing) a N3GPP resource for the N3GPP access without the N3IWF. In an embodiment, based on receiving the NAS response message S (e.g., not allowing the first ATSSS type, not comprising the one or more parameters), for the N3GPP access registration status, the UE may not transit from RM-deregistered to RM-registered and/or the UE may stay in the RM-deregistered state.

In one example, the UE may receive the NAS response message S. If the NAS response message S indicates that the PDU session is established and that the PDU session is of the first ATSSS type, the UE may establish the N3GPP resource for the PDU session, the UE may determine that the UE is registered via the N3GPP access, and/or the like. For example, the UE may run N3GPP de-registration timer. For example, if the NAS response message received via the 3GPP RAN comprises a time value for the N3GPP de-registration timer, the UE may run the time period. When the time period expires, the UE may transit to RM-deregistered.

In another example, the UE may receive the NAS response message S. If the NAS response message S indicates that the PDU session is established and that the PDU session is not of the first ATSSS type, the UE may not establish the N3GPP resource for the PDU session, the UE may determine that the UE is not registered via the N3GPP access, and/or the like.

The example embodiment of FIG. 26 may help to provide a PDU session of the first ATSSS type, when an AMF does not support the first ATSSS type, and/or when an SMF supports the first ATSSS type. This may help to manage status of the UE.

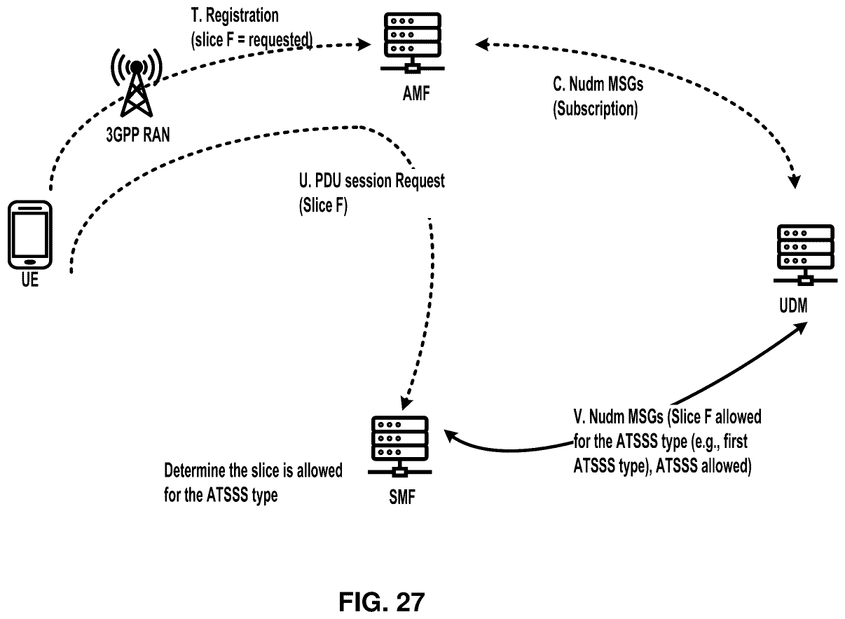

FIG. 27 illustrates an example as per an aspect of an embodiment of the present disclosure. For brevity, based on the other part of the present disclosure, redundant details will be omitted.

In an example, a UE may perform a registration procedure via a 3GPP RAN. For example, the UE may send a NAS message T to an AMF. The NAS message T may be a registration request message requesting a slice F. The AMF may request a UDM to provide a subscription information of the UE. The UDM may provide to the AMF, the subscription information. The subscription information may indicate that the UE subscribes to the slice F. The UE may receive a registration accept message from the AMF. The registration accept message may indicate that the UE is registered via the 3GPP access and/or that the slice F is allowed for the 3GPP access.

In an example, the UE may send a NAS message U to a SMF via the AMF. For example, the NAS message U may be a PDU session request message. The PDU session request message may be at least one of a PDU session establishment request message, a PDU session modification request message, and/or the like. The PDU session request message may indicate that a PDU session is associated with the slice F. Alternatively and/or additionally, the AMF may indicate to the SMF, that the PDU session is associated with the slice F. The PDU session request message may indicate that the UE requests the PDU session, and/or that the PDU session is the first ATSSS type (e.g., a PDU session using a N3GPP access, the N3GPP access not comprising the N3IWF).

In an example, the SMF may send a request to a UDM. For example, the request may indicate that the SMF requests the subscription information of the UE. The request may indicate an identifier of the UE, an identifier of the SMF, the slice F, and/or the like. The SMF may receive from the UDM, a response. The response may indicate whether the UE is allowed for the slice F, whether the UE is allowed for the PDU session for the slice F, whether the UE is allowed for the PDU session of the first ATSSS type, whether the slice F is allowed for the first ATSSS type, whether a feature of the ATSSS is allowed for the UE (or the slice F), and/or the like.

In an example, the SMF may determine which ATSSS type is applied for the PDU session. If the response message indicates that the slice F is allowed for the first ATSSS type, the SMF may determine to apply (to establish) the first ATSSS type to the PDU session. If the response message indicates that the slice F is not allowed for the first ATSSS type, the SMF may determine to apply the second ATSSS type (or the third ATSSS type) to the PDU session.

In an example, the SMF may send a NAS message U1 to the UE. For example, the NAS message U1 may be a PDU session response message. The PDU session response message may be at least one of a PDU session establishment response (e.g., command, accept, reject) message, a PDU session modification response message, and/or the like. The NAS message U1 may indicate at least one of whether the PDU session is accepted, whether the PDU session is modified, whether the first ATSSS type is used for the PDU session, whether the second ATSS type is used for the PDU session, whether the third ATSSS type is used for the PDU session, and/or the like.

In an example, if the first ATSSS type is applied for the PDU session, the NAS message U1 may comprise a N3GPP resource information. If the first ATSSS type is applied for the PDU session, the NAS message U1 may indicate that the slice F is allowed for the first ATSSS type and/or the NAS message UE may indicate that ATSSS (e.g., MA-PDU session) applies. If the third ATSSS type is applied for the PDU session, the NAS message U1 may not comprise a N3GPP resource information.

In an example, the UE may receive the NAS message U1. In response to the NAS message U1 comprising the N3GPP resource information, in response to the NAS message U1 indicates the first ATSSS type for the PDU session, and/or the like, the UE may determine that the first ATSSS type applies to the PDU session, that the UE is registered for the N3GPP access, that the slice F is registered (allowed) for the N3GPP access, and/or the like.

In another example, the UE may receive the NAS message U1. In response to the NAS message U1 not comprising the N3GPP resource information, in response to the NAS message U1 indicates the third ATSSS type for the PDU session, and/or the like, the UE may determine that the first ATSSS type does not apply to the PDU session, that the slice F is not registered for the N3GPP access, that the UE is not registered for the N3GPP access, and/or the like.

The example embodiment of FIG. 27 may allow use of a PDU session of the first ATSSS type, when an AMF does not support the first ATSSS type. The example embodiment of FIG. 27 may help an SMF in determining whether to apply the first ATSSS type to the PDU session.

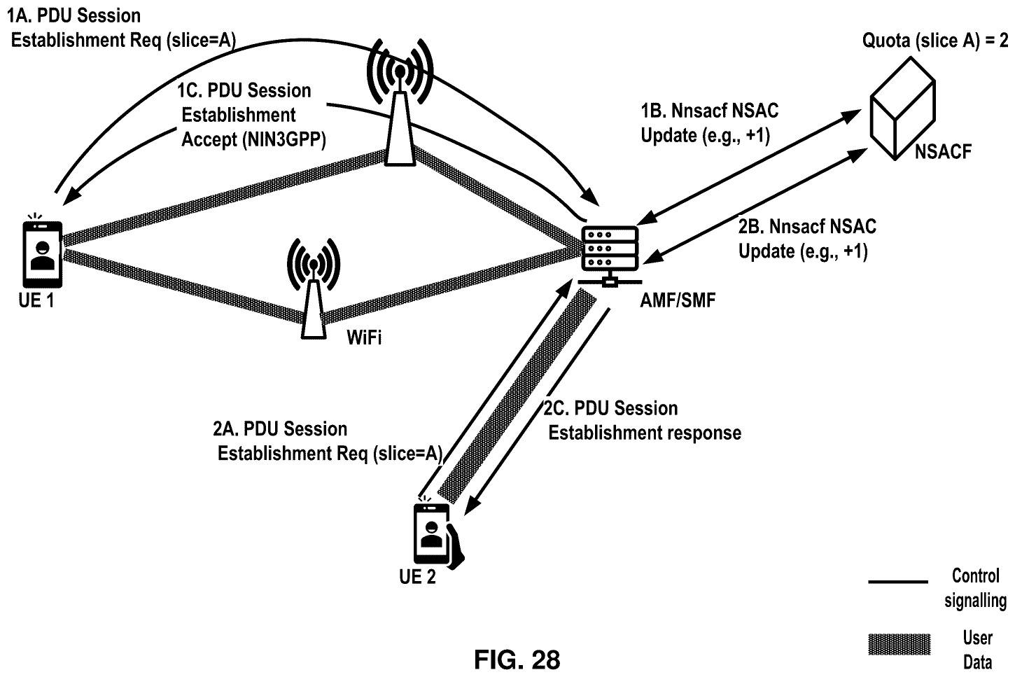

FIG. 28 illustrates an example as per an aspect of an embodiment of the present disclosure. For brevity, based on the other part of the present disclosure, redundant details will be omitted.

In an example implementation, a UE may send a PDU session establishment request to a core network node (e.g., AMF, SMF), via a 3GPP RAN. When the UE is registered, and/or when the UE establishes a PDU session of a first MA PDU session type, the PDU session may use a 3GPP access resource of a network slice and/or may use a N3GPP access resource of the network slice. In case of using NIN3GPP access, in case of using the first MA PDU session type, in case of using the direct access, and/or in case of using the first ATSSS type, the UE may not perform registration via the N3GPP access and/or the UE may not perform a PDU session establishment (or modification) procedure via the N3GPP access. This may cause inaccurate calculation of how many PDU sessions are established for the network slice and/or of how many UEs are registered for the network slice. This may cause overuse of a network resource for the network slice (e.g., UE2 is allowed after the UE 1 uses all quota). In an example embodiment, a first network may report use of a N3GPP access to a second network node. This may assist for a third network node to properly manage a use of the network slice.

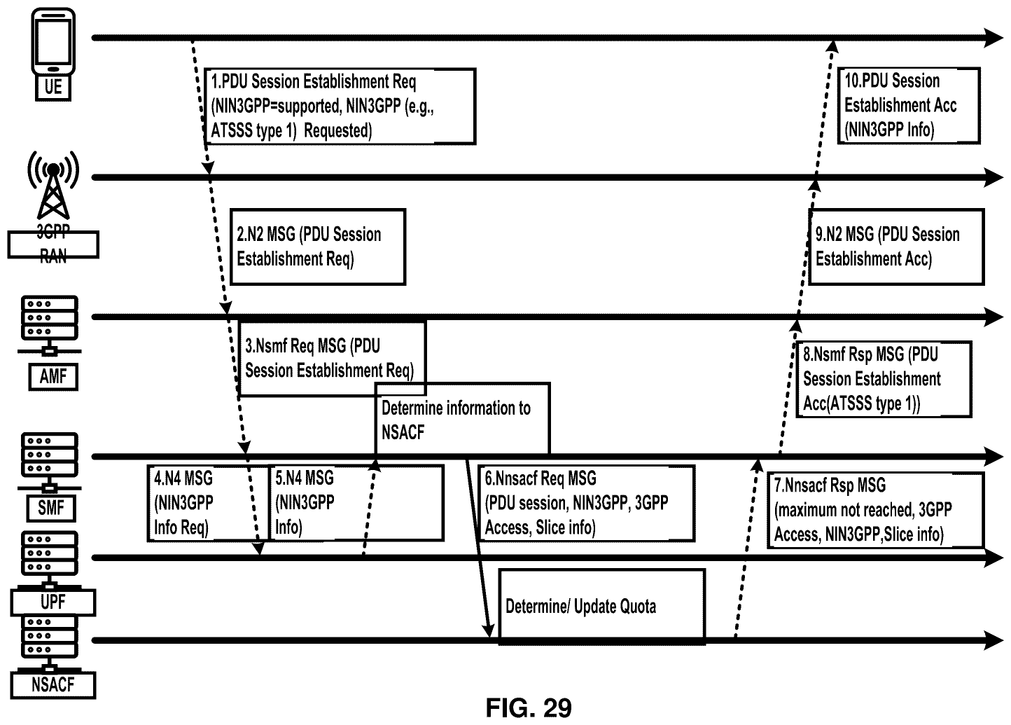

FIG. 29 illustrates an example as per an aspect of an embodiment of the present disclosure. For brevity, based on the other part of the present disclosure, redundant details will be omitted.

In an example, a UE may send a message 1 to a core network node via a 3GPP RAN. The core network may be at least one of an AMF, a SMF, a PCF, a UDM, a SoR-AF, and/or the like. The message 1 may be at least one of a PDU session establishment request message 1, a PDU session modification request message 1, and/or the like. The message 1 may comprise at least one of a first indication indicating that the UE supports a feature of direct access (e.g., the NIN3GPP, the first MA PDU type, the first ATSSS type, and/or the like), a second indication indicating that the UE requests a PDU session, a third indication indicating that a network slice 1 is associated with the PDU session, a fourth indication indicating that the direct access is requested for the PDU session, a fifth indication indicating that a type of the PDU session is a MA PDU session, and/or the like.

In an example, the core network node may receive the message 1. In response to receiving the message 1, the AMF may send a Nsmf request message 3 to the SMF. The Nsmf request message 3 may be at least one of a Nsmf_PDUSession_CreateSMContext request message, a Nsmf_PDUSession_UpdateSMContext request message, and/or the like. The SMF request message 3 may comprise at least one of an identifier of the UE, a DNN, the network slice 1 (slice 1), one or more information element of the message 1, the message 1, indication of 3GPP access, indication of whether the AMF supports the feature of the NIN3GPP, and/or the like.

In an example, the SMF may receive the Nsmf request message 3. The SMF may send to a UPF, a N4 message 4. The N4 message 4 may be at least one of a N4 session establishment request message (e.g., PFCP session establishment request message), N4 session modification request message (e.g., PFCP session modification request message), and/or the like. For example, the N4 message 4 may comprise a direct access resource information request and/or information of the slice 1. The direct access resource information request may indicate that the UPF allocates a resource (e.g., IP address, port, of QUIC) or a NIN3GPP access, and/or that the SMF requests the UPF to provide information of the resource for the NIN3GPP access.

In an example, the SMF may receive a N4 message 5. The N4 message 5 may be at least one of a N4 session establishment response message, N4 session modification response message, and/or the like. For example, the N4 message 5 may comprise a direct access resource information. The direct access resource information may comprise the information of the resource for the NIN3GPP access. Alternatively and/or additionally, if the UPF does not support the feature of the NIN3GPP access, the N4 message 5 may indicate that the UPF does not support the feature of the NIN3GPP access and/or the N4 message 5 may not comprise the information of the resource for the NIN3PP access. This may help the SMF to be aware of whether the UPF supports the slice 1 for the NIN3GPP access (e.g., direct access).

In an example, in response to receiving the Nsmf message 3, the SMF may determine whether to contact a NSACF or not. For example, if the Nsmf message 3 indicates the network slice 1, and/or if a quota is managed for the network slice 1, the SMF may determine to send a Nnsacf request message 6 to the NSACF.

In an example, the Nnsacf request message 6 may be at least one of Nnsacf_NSAC_NumOfUEsUpdate request message 6, Nnsacf_NSAC_NumOfPDUsUpdate request message 6, Nnsacf_NSAC_EACNotify request message 6, Nnsacf_NSAC_QuotaUpdate request message 6, Nnsacf_NSAC_LocalNumberUpdate request message 6, and/or the like.

The Nnsacf request message 6 may comprise at least one of an identifier of a network slice (e.g., identifier of the network slice 1, the slice 1, S-NSSAI 1, and/or the like), the identifier of the UE, an identifier of the PDU session (e.g., PDU session ID 1), an information of access type, update flag, and/or the like.

The information of access type may indicate at least one of one or more access types, an MA-PDU type, an ATSSS type (e.g., the first ATSSS type), an indication of NIN3GPP access, the direct access, and/or the like. For example, the information of access type may indicate at least one of whether the UE is associated with the first MA-PDU type (or, the first ATSSS type, the direct access, the NIN3GPP access), whether the PDU session is associated with the first MA-PDU type (or, the first ATSSS type, the direct access, the NIN3GPP access), whether the network slice (e.g., the S-NSSAI 1, the network slice 1) is associated with the first MA-PDU type (or, the first ATSSS type, the direct access, the NIN3GPP access), whether a 3GPP access is associated, whether a N3GPP access is associated, whether a N3GPP access of the PDU session does not comprise the N3IWF, whether a N3GPP access of the UE does not comprise the N3IWF, and/or the like. The information of access type may not only indicate whether the N3GPP access is used or not, but also may indicate the type of N3GPP access.

In an example, the NSACF may receive the Nnsacf request message 6. Based on the Nnsacf request message 6, the NSACF may determine whether to increase a number of UEs for the network slice (e.g., the network slice 1) for the N3GPP access, whether to increase a number of UEs for the network slice for the N3GPP access, whether to increase a number of UEs for the network slice for the 3GPP access, whether to increase a number of UEs for the network slice for the 3GPP access, whether to increase a number of UEs for the network slice for the NIN3GPP access, whether to increase a number of UEs for the network slice for the NIN3GPP access, and/or the like.

In another example, the NSACF may receive the Nnsacf request message 6. Based on the Nnsacf request message 6, the NSACF may determine whether to increase a number of PDUs for the network slice for the N3GPP access, whether to increase a number of PDUs for the network slice for the 3GPP access, whether to increase a number of PDUs for the network slice for the NIN3GPP access, and/or whether to increase a number of PDUs for the network slice for the MA PDU sessions, and/or the like.

In an example, based on that the Nnsacf request message 6 indicates the first ATSSS type (e.g., the first MA PDU session type, the NIN3GPP access, the direct access), based on that the 3GPP access are indicated, based on that the NIN3GPP access are indicated, and/or based on that the N3GPP access and the 3GPP access are indicated, the NSACF may increase by 1 the number of UEs for the network slice 1 for the 3GPP access, the NSACF may increase by 1 the number of UEs for the network slice 1 for the N3GPP access, the NSACF may increase by 1 the number of UEs for the network slice 1 for the NIN3GPP access, and/or the NSACF may increase by 2 the number of UEs for the network slice 1. In alternative embodiment, for the PDU session of the first MA PDU type, the NSACF may increase by 1 the number of UEs for the network slice.

In an example, based on that the Nnsacf request message 6 indicates the first ATSSS type (e.g., the first MA PDU session type, the NIN3GPP access, the direct access), based on that the 3GPP access are indicated, and/or based on that the N3GPP access and the 3GPP access are indicated, the NSACF may increase by 1 the number of PDU sessions for the network slice 1 for the 3GPP access, the NSACF may increase by 1 the number of PDU sessions for the network slice 1 for the N3GPP access, the NSACF may increase by 1 the number of PDU sessions for the network slice 1 for the NIN3GPP access, and/or the NSACF may increase by 2 the number of PDU sessions for the network slice 1, and/or the like. In alternative embodiment, for the PDU session of the first MA PDU type, the NSACF may increase by 1 the number of PDU sessions for the network slice.

In an example, the NSACF may send a Nnsacf response message 7 to the SMF. The Nnsacf response message 7 may be at least one of a Nnsacf_NSAC_NumOfUEsUpdate response message 7, Nnsacf_NSAC_NumOfPDUsUpdate response message 7, Nnsacf_NSAC_EACNotify response message 7, Nnsacf_NSAC_QuotaUpdate response message 7, Nnsacf_NSAC_LocalNumberUpdate response message 7, and/or the like. For example, the Nnsacf response message 7 may comprise a result indication.

In an example, the NSACF may determine whether the increased number of PDU sessions for the network slice 1 exceeds (or equal to) a maximum number of PDU sessions for the network slice. If the increased number of PDU sessions for the network slice 1 does not exceeds (or less than) a maximum number of PDU sessions for the network slice, the NSACF may determine to allow the PDU session to be established. For example, the result indication of the Nnsacf response message 7 may indicate at least one of that maximum number of PDU sessions for the S-NSSAI is not reached, that maximum number of PDU sessions for the S-NSSAI is not reached for the 3GPP access, that maximum number of PDU sessions for the S-NSSAI is not reached for the N3GPP access, that maximum number of PDU sessions for the S-NSSAI is not reached for the NIN3GPP access, and/or the like. The result indication may indicate to the SMF that the PDU session of the UE is allowed for the 3GPP access, that the PDU session of the UE is allowed for the N3GPP access, that the PDU session of the UE is allowed for the NIN3GPP access, that the PDU session of the network slice 1 is allowed, and/or the like.

In an example, the NSACF may determine whether the increased number of UEs for the network slice 1 exceeds (or equal to) a maximum number of UEs for the network slice. If the increased number of UEs for the network slice 1 does not exceeds (or less than) a maximum number of UEs for the network slice, the NSACF may determine to allow the UE to be registered. For example, the result indication of the Nnsacf response message 7 may indicate at least one of that maximum number of UEs for the S-NSSAI is not reached, that maximum number of UEs for the S-NSSAI is not reached for the 3GPP access, that maximum number of UEs for the S-NSSAI is not reached for the N3GPP access, that maximum number of UEs for the S-NSSAI is not reached for the NIN3GPP access, and/or the like. The result indication may indicate to the SMF that UE is allowed for the 3GPP access, that the UE is allowed for the N3GPP access, that the UE is allowed for the NIN3GPP access, and/or the like. The NSACF may store the context of the UE and/or may store the identifier of the UE in the list of UEs for the network slice 1 and/or may store in the context for the network slice 1, an indication that the UE uses the N3GPP access.

In an example, in response to receiving the Nnsacf response message 7, the SMF may determine whether to allow the PDU session, which ATSSS types is applied to the PDU session, and/or the like.

For example, because the result indication indicates that maximum number of the UEs for the slice 1 is not reached, because the result indication indicates that maximum number of the UEs for the 3GPP access for the slice 1 is not reached, because the result indication indicates that maximum number of the UEs for the N3GPP access for the slice 1 is not reached, because the result indication indicates that maximum number of the UEs for the NIN3GPP access for the slice 1 is not reached, because the result indication indicates that maximum number of the PDU sessions for the 3GPP access for the slice 1 is not reached, because the result indication indicates that maximum number of the PDU sessions for the N3GPP access for the slice 1 is not reached, because the result indication indicates that maximum number of the PDU sessions for the NIN3GPP access for the slice 1 is not reached, and/or because the result indication indicates that maximum number of the PDU sessions for the slice 1 is not reached, the SMF may determine to allow the PDU session. For example, the PDU session may be of the first ATSSS type.

In an example, the SMF may send to the UE a message 10 via the 3GPP RAN and/or the core network node. The message 10 may be at least one of a PDU session establishment response message 10, a PDU session modification response message 10, and/or the like. The message 10 may comprise at least one of a sixth indication indicating that the UE is allowed for the feature of direct access, a seventh indication indicating that the PDU session is established/modified; a eighth indication indicating that the PDU session is of the first ATSSS type, a ninth indication indicating that the UE is allowed (registered) for the network slice for the N3GPP access, and/or the like.

The example embodiment of FIG. 29 may help a network to control a quota of a network slice, when a UE does not perform a registration procedure via a N3GPP access and/or when an AMF does not support the feature of the direct access. The example embodiment may help the AMF and/or the SMF, to reduce signalling transaction with the NSACF, by indication e.g., an ATSSS type. The example embodiment may help the SMF, to check whether a quota for the UE is available for the N3GPP access.

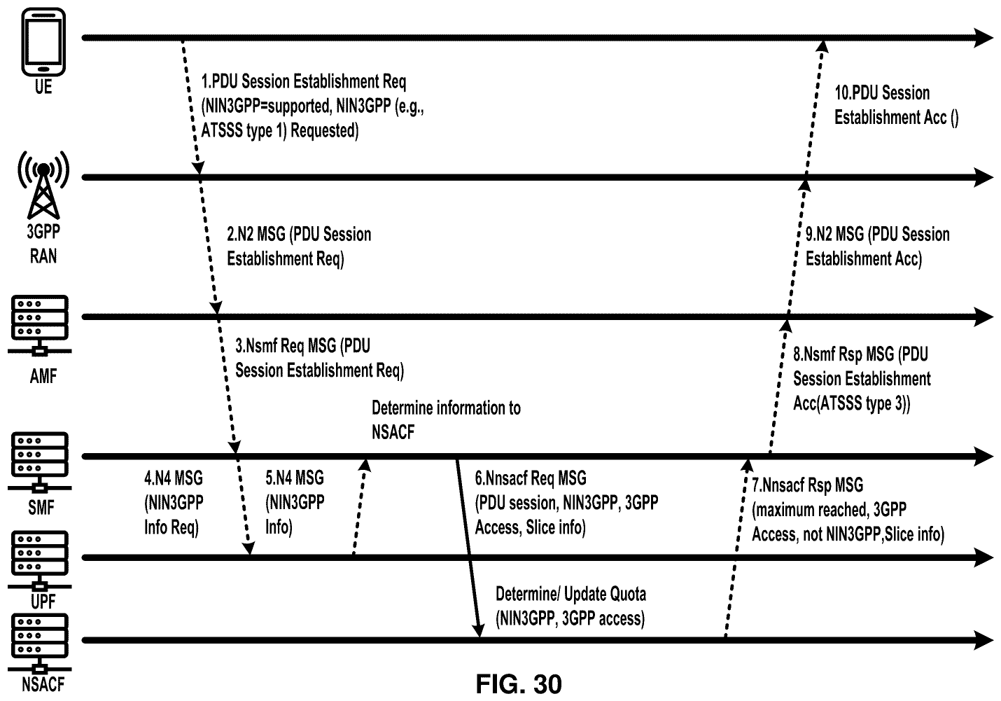

FIG. 30 illustrates an example as per an aspect of an embodiment of the present disclosure. For brevity, based on the other part of the present disclosure, redundant details will be omitted.

In an example, the SMF may receive the message 1 from the UE.

In an example, the SMF may send the Nnsacf request message 6 to the NSACF.

In an example, the NSACF may determine whether the increased number of PDU sessions for the network slice 1 exceeds (or equal to) the maximum number of PDU sessions for the network slice (e.g., the network slice 1). If the increased number of PDU sessions for the network slice 1 exceeds (or equal to) the maximum number of PDU sessions for the network slice, the NSACF may determine not to allow the PDU session to be established for the UE. Alternatively and/or additionally, the NSACF may determine to allow the PDU session to be established for the 3GPP access and/or may determine not to allow the PDU session to be established for the N3GPP access. For example, the result indication of the Nnsacf response message 7 may indicate at least one of that maximum number of PDU sessions for the S-NSSAI is reached, that maximum number of PDU sessions for the S-NSSAI is not reached for the 3GPP access, that maximum number of PDU sessions for the S-NSSAI is reached for the N3GPP access, that maximum number of PDU sessions for the S-NSSAI is reached for the NIN3GPP access, that maximum number of PDU sessions for the S-NSSAI is reached for the NIN3GPP access and not reached for the 3GPP access, that the third ATSSS type is allowed, that the first ATSSS type is not allowed and/or the like.

In another example, the NSACF may determine whether the increased number of UEs for the network slice 1 exceeds (or equal to) the maximum number of UEs for the network slice. If the increased number of UEs for the network slice 1 exceeds (or equal to) the maximum number of UEs for the network slice, the NSACF may determine not to allow the UE for the network slice 1 and/or the NSACF may determine not to allow the PDU session for the network slice 1. Alternatively and/or additionally, the NSACF may determine to allow the UE for the 3GPP access and/or may determine not to allow the UE for the N3GPP access. For example, the result indication of the Nnsacf response message 7 may indicate at least one of that maximum number of UEs for the S-NSSAI is reached, that maximum number of UEs for the S-NSSAI is not reached for the 3GPP access, that maximum number of UEs for the S-NSSAI is reached for the N3GPP access, that maximum number of UEs for the S-NSSAI is reached for the NIN3GPP access, that maximum number of UEs for the S-NSSAI is reached for the NIN3GPP access and not reached for the 3GPP access, that the third ATSSS type is allowed, that the first ATSSS type is not allowed, and/or the like.

In an example, in response to receiving the Nnsacf response message 7, the SMF may determine whether to allow the PDU session, which ATSSS types is applied to the PDU session, and/or the like.

For example, for the network slice (e.g., the network slice 1), because the result indication indicates that maximum number of the UEs is reached, because the result indication indicates that maximum number of the UEs for the 3GPP access is not reached, because the result indication indicates that maximum number of the UEs for the N3GPP access is reached, because the result indication indicates that maximum number of the UEs for the NIN3GPP access is reached, because the result indication indicates that maximum number of the PDU sessions for the 3GPP access is reached, because the result indication indicates that maximum number of the PDU sessions for the N3GPP access is reached, because the result indication indicates that maximum number of the PDU sessions for the NIN3GPP access is reached, and/or because the result indication indicates that maximum number of the PDU sessions is reached, the SMF may determine not to allow the PDU session and/or the SMF may determine to not to allow the PDU session of the first ATSSS type. Alternatively and/or additionally, the SMF may determine to allow the PDU session of the third ATSSS type.

In an example, the SMF may send to the UE a message 10 via the 3GPP RAN and/or the core network node. The message 10 may be at least one of a PDU session establishment response message 10, a PDU session modification response message 10, and/or the like. The message 10 may comprise at least one of a sixth indication indicating that the UE is not allowed for the feature of the direct access, a seventh indication indicating that the PDU session is established/modified; a eighth indication indicating that the PDU session is of the third ATSSS type, a ninth indication indicating that the UE is not allowed (registered) for the network slice for the N3GPP access; a tenth indication indicating that the PDU session of the first ATSSS type is rejected (e.g., not allowed), and/or the like.

The example embodiment of FIG. 30 may help a core network to properly manage a quota of a network slice, may help to the UE to determine allowed (established) ATSSS type of a PDU session, may help to manage registration of N3GPP access without registration via the N3GPP access.

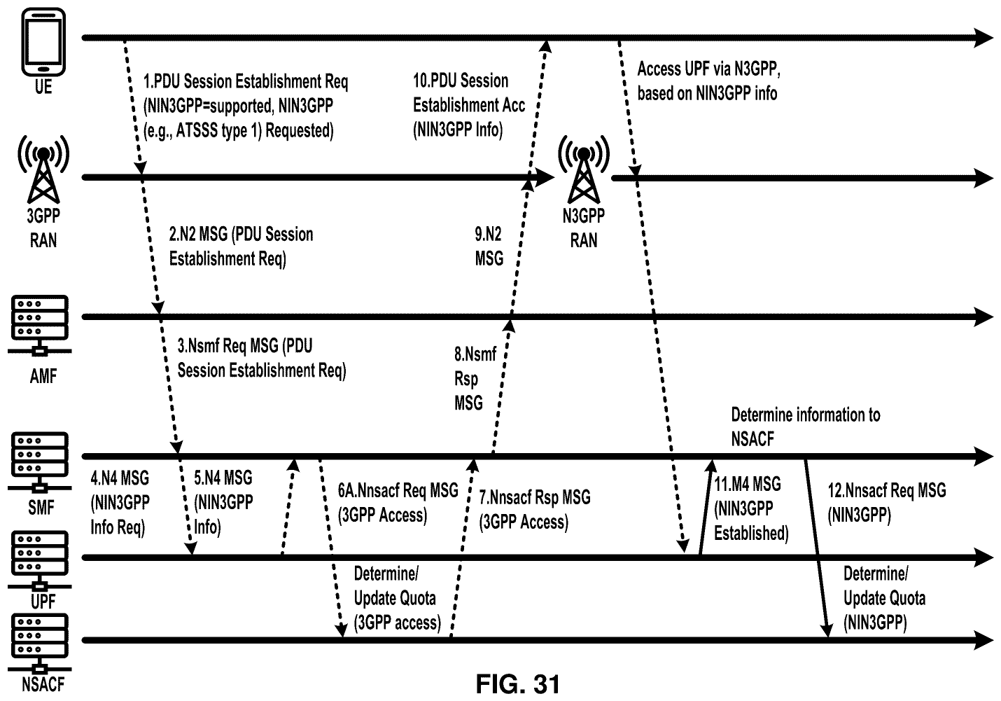

FIG. 31 illustrates an example as per an aspect of an embodiment of the present disclosure. For brevity, based on the other part of the present disclosure, redundant details will be omitted.

In an example, the SMF may receive the message 1 from the UE.

In an example, the SMF may send a Nnsacf request message 6A to the NSACF. One or more information elements of the Nnsacf message 6A may be similar to one or more information elements of the Nnsacf message 6. The Nnsacf message 6A may comprise an information of access type. Because the message 1 is received by the 3GPP access, and/or because the UE is not using a N3GPP resources, the information of access type may indicate the 3GPP access and/or may not indicate the N3GPP access.

In an example, the SMF may receive a Nnsacf response message 6B from the NSACF. For example, the Nnsacf response message 6A may indicate that the maximum number of PDU sessions for the network slice is not reached and/or may indicate that the maximum number of UEs for the network slice (e.g., the network slice 1) is not reached. For example, the NSACF may update the number of PDU session for the network slice for the 3GPP access and/or the NSACF may not update the number of PDU session for the network slice for the N3GPP access.

In response to receiving the Nnsacf response message 6B, the SMF may send a NAS message 10 to the UE. For example, the NAS message 10 may be a PDU session response message. The PDU session response message may be at least one of a PDU session establishment response (e.g., command, accept, reject) message, a PDU session modification response message, and/or the like. The NAS message 10 may indicate at least one of that the PDU session is accepted, that the PDU session is modified, that the first ATSSS type is used for the PDU session, that the first ATSSS type is used/allowed for the slice 1, and/or the like. For example, the NAS message 10 may comprise a NIN3GPP parameter. The NIN3GPP parameter may comprise a resource information (e.g., IP address, port number) for the NIN3GPP access.

In an example, the UE may receive the NAS message 10. Because the NAS message 10 indicates that the first ATSSS type is allowed/used for the PDU session, and/or because the NAS message 10 comprises the NIN3GPP parameter, the UE may start establishment of connection to a UPF (e.g., relevant for the IP address, the port number, for the QUIC). For example, the UE may initiate QUIC connection establishment using the resource information of the NIN3GPP access, via the N3GPP access. In an embodiment, based on receiving the message 10 comprising the NIN3GPP parameter, for the N3GPP access registration status, the UE may transit from RM-deregistered to RM-registered. For example, in response to receiving the NIN3GPP parameter via the 3GPP access, the UE may consider being registered via the N3GPP access. This may help for the UE to manage the N3GPP access registration status, without exchanging signalling message with the AMF via the N3GPP access.

In an example, the UPF may establish the connection toward the UE via the N3GPP access. For example, the N3GPP access may not comprise/use the N3IWF. For example, when the UPF establishes the QUIC connection with the UE via the IP address and/or the port number, the UPF may determine that the N3GPP connection and/or the NIN3GPP access is established. Based on the determination, the UPF may send to the SMF, a report (e.g., N4 session report, PFCP session report, and/or the like). For example, the report may indicate that the UE accesses the UPF via the N3IWF, that the NIN3GPP resources is used by the UE, that the N3GPP access of the UE is successful, that the UPF and the UE establishes N3GPP connection, and/or that N3GPP resources is added to the PDU session, and/or the like.

In an example, the SMF may receive the report from the UPF.

In response to receiving the report, the SMF may send a Nnsacf request message 12A to the NSACF. One or more information elements of the Nnsacf message 12A may be similar to one or more information elements of the Nnsacf message 6A. The Nnsacf message 12A may comprise an information of access type. Because sending of the Nnsacf message 12A is triggered by the report from the UPF, because the UE established the N3GPP connection (e.g., NIN3GPP access) with the UPF, because the PDU session associated with the N3GPP access is associated with the slice 1, because the N3GPP access (e.g., the NIN3GPP access) is not notified to the NSACF for the PDU session, the information of the access type may indicate the N3GPP access, may indicate that the PDU session is for the first ATSSS type, may indicate that the PDU session is for the slice 1, may indicate that the PDU session is using both the 3GPP access and the N3GPP access, may indicate that the N3GPP resource is established for the PDU session, and/or the like.

In response to receiving the Nnsacf message 12, the NSACF may increase the number of the UEs for the network slice (e.g., the slice 1), may increase the number of PDU sessions for the network slice, may increase the number of the UEs for the network slice for the N3GPP access, may increase the number of PDU sessions for the network slice for the N3GPP access, and/or the like.

The example embodiment of FIG. 31 may help the SMF and/or the NSACF to update a number of UEs for a network slice, and/or a number of PDU session for the network slice, based on whether a N3GPP resources is successfully used by the UE or not.

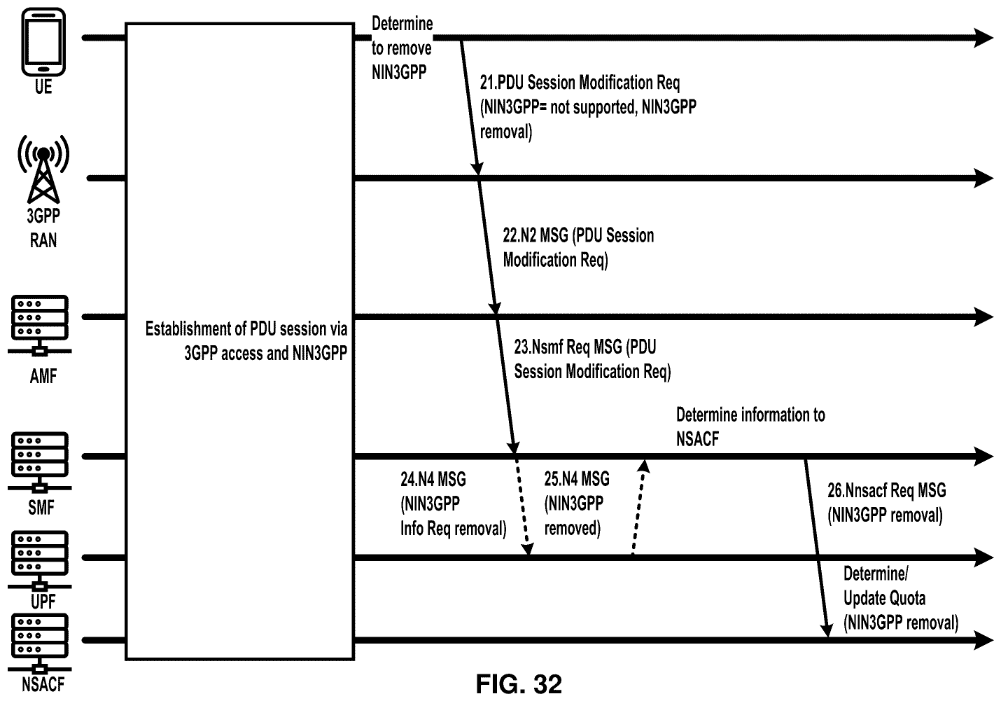

FIG. 32 illustrates an example as per an aspect of an embodiment of the present disclosure. For brevity, based on the other part of the present disclosure, redundant details will be omitted.

In an example, the UE may establish a PDU session of the first ATSSS type. The PDU session may be for the slice 1. The PDU session may use the 3GPP access and the N3GPP access without the N3IWF.

In an example, the UE may send a NAS message 21 to an AMF and/or a SMF. The NAS message 21 may indicate at least one of that the PDU session is modified to the second (or third) ATSSS type, that the NIN3GPP access (or N3GPP access) is requested to be removed from the PDU session, that the N3GPP access not available, that the first ATSSS type is not supported any more by the UE, and/or the like. For example, due to power consumption issue, the UE may determine not to use the N3GPP access (e.g., the NIN3GPP access). For example, when the UE moves out of a coverage of the N3GPP access, the UE may determine to report unavailability of the N3GPP access. The NAS message 21 may be at least one of a registration request message, a PDU session establishment request message, a PDU session modification request message, and/or the like.

In an example, the SMF (or the AMF) may receive the NAS message 21 from the UE.

In response to receiving the NAS message 21, the SMF may determine to remove the N3GPP access (e.g., of the NIN3GPP access) from the PDU session of the UE for the slice 1. In response to the determination, the SMF may send a N4 session modification request message to the UPF. The N4 session modification request message may request removal of the N3GPP access from the PDU session of the UE. The N4 session modification request message may request removal of a network resources for the NIN3GPP access from the PDU session of the UE, for the network slice 1.

In response to the determination, the SMF may send to a NSACF, a Nnsacf message. For example, the Nnsacf message may indicate at least one of that a number of UEs for the slice 1 needs to be decreased, that a number of PDU sessions for the slice 1 needs to be decreased, that the NIN3GPP access is removed, that the PDU session is modified to the second (or third) ATSSS type, that the N3GPP access is removed, and/or the like.

In response to receiving the Nnsacf message, the NSACF may adjust the number of the UEs for the slice 1 and/or the number of the PDU sessions for the slice 1.

The example embodiment of FIG. 32 may help a SMF to adjust a resource of a PDU session, may help a UE to indicate modification of the PDU session. For example, the UE may be able to request removal of the NIN3GPP resources from the PDU session. The example embodiment may support the NSACF to adjust a quota of a network slice, when the NIN3GPP resources is removed from the PDU session.

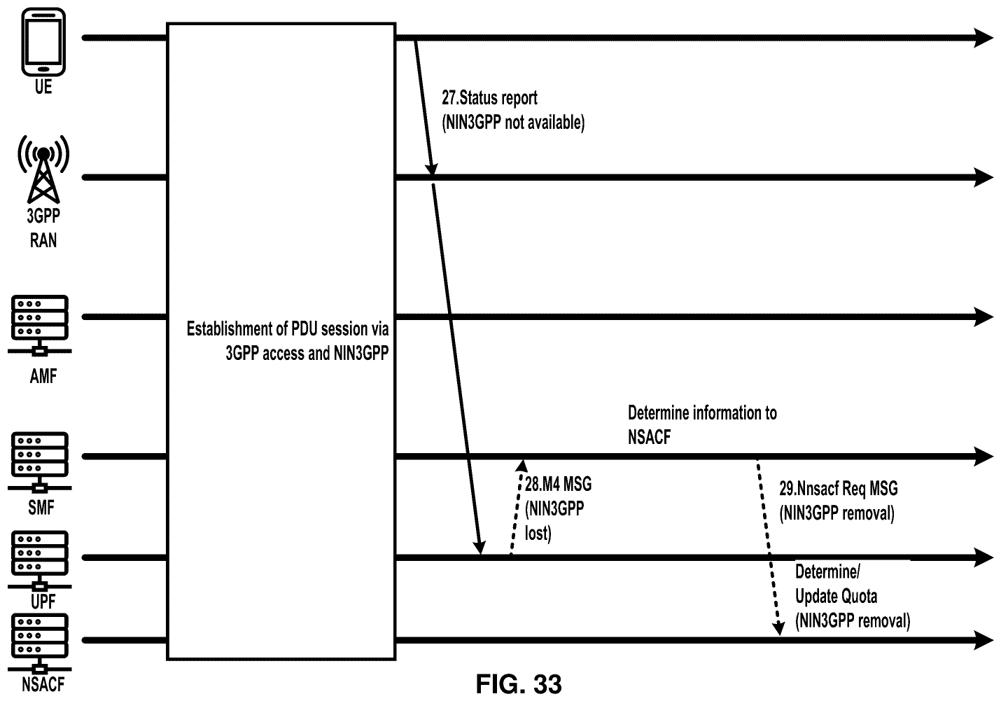

FIG. 33 illustrates an example as per an aspect of an embodiment of the present disclosure. For brevity, based on the other part of the present disclosure, redundant details will be omitted.

In an example, the UE may establish a PDU session of the first ATSSS type. The PDU session may be for the slice 1.

In an example, the UE may send a message 27 to an UPF, via a 3GPP access path (e.g., a path from the UE to the UPF via the 3GPP RAN). The message 27 may indicate that the N3GPP access is not available. For example, when the N3GPP access is lost (e.g., due to out of coverage of WiFi), the UE may not be able to indicate a status of the N3GPP access, via the N3GPP access. To indicate unavailability of the N3GPP access, the UE may send the message 27, via the 3GPP access.

In an example, the UPF may receive the message 27. In response to receiving the message 27, the UPF may send to an SMF of the PDU session, a N4 session report message. The N4 session report message may indicate at least one of that the N3GPP access of the PDU session is lost, that the N3GPP access of the PDU session is not available, that the 3GPP access of the PDU session is available, that the PDU session is for the slice 1, that the UE reports unavailability of the N3GPP access, and/or the like.

In an example, the SMF may receive from the UPF, the N4 session report message. The N4 session report message may be a packet forwarding control protocol (PFCP) message. In response to receiving the N4 session report message, the SMF may determine to remove the N3GPP access (e.g., of the NIN3GPP access, of the first ATSSS type) from the PDU session of the UE for the slice 1. In response to the determination, the SMF may send to a NSACF, a Nnsacf message. For example, the Nnsacf message may indicate at least one of that a number of UEs for the slice 1 needs to be decreased, that a number of PDU sessions for the slice 1 needs to be decreased, that the NIN3GPP access is removed, that the PDU session is modified to the second (or third) ATSSS type, that the N3GPP access is removed from the PDU session, and/or the like.

In response to receiving the Nnsacf message, the NSACF may adjust the number of the UEs for the slice 1 and/or the number of the PDU sessions for the slice 1. For example, the NSACF may decrease the number of the UEs for the slice 1 and/or the number of the PDU sessions for the slice 1.

In response to receiving the N4 session report message, the SMF may send to the UE via the 3GPP RAN and/or via the AMF, a PDU session modification command message. For example, the PDU session modification command message may indicate at least one of removal of the NIN3GPP access, change of the PDU session to the third ATSSS type. For example, the PDU session modification command message may not comprise the information of the resource for the NIN3PP access.

The example embodiment of FIG. 33 may help a core network to accurately manage a usage status of a network slice, based on whether a N3GPP access without a N3IWF is used for a UE and/or for a PDU session.

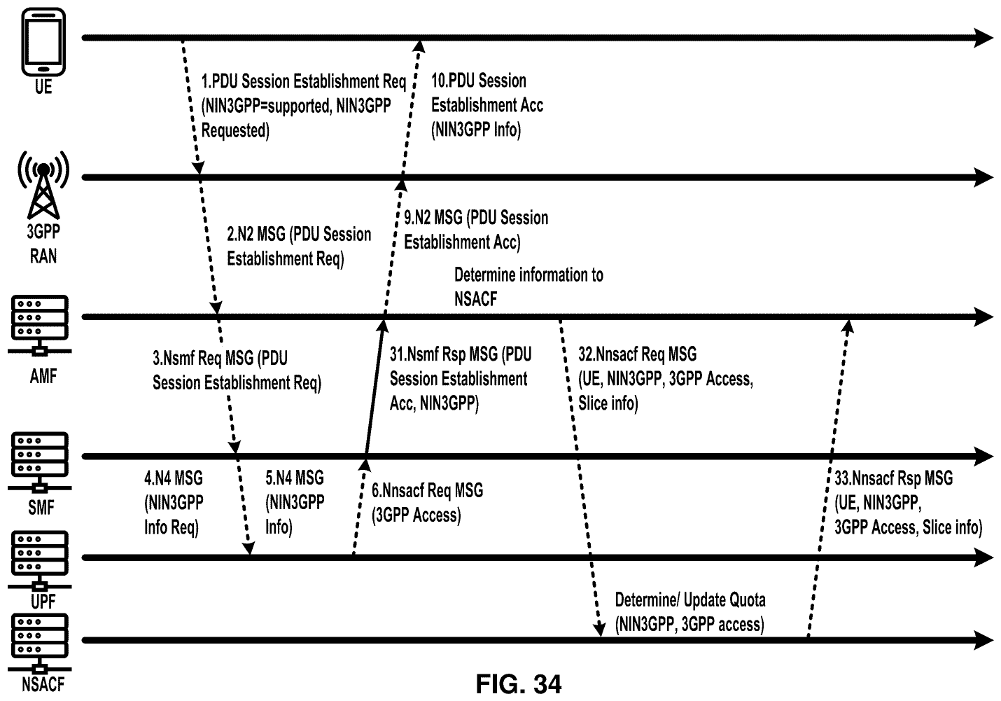

FIG. 34 illustrates an example as per an aspect of an embodiment of the present disclosure. For brevity, based on the other part of the present disclosure, redundant details will be omitted.

In an example, the UE may establish a PDU session of the first ATSSS type. The PDU session may be for the slice 1. For example, the UE may send the message 1 to the SMF.

In an example, the SMF may receive the message 1 from the UE.

In an example, in response to receiving the message 1 from the UE, the SMF may construct the message 10 and/or the SMF may send a message 31 to the AMF. For example, the message 31 may be at least one of a Namf message and/or a Nsmf message. For example, the message 31 may be at least one of a

Nsmf_PDUSession_CreateSMContext response message 31, a Nsmf_PDUSession_UpdateSMContext response message 31, a Namf_Communication_N1N2 message transfer message 31, and/or the like. For example, the message 31 may comprise at least one of the message 10, an identifier of the slice 1 (e.g., S-NSSAI 1), an indication of a NIN3GPP access, and/or the like.

The indication of the NIN3PP access may be the indication of the direct access, the indication of the first ATSSS type, the indication of the first MA PDU session type, and/or the like. The indication of the NIN3GPP access may indicate at least one of that the PDU session is of the first ATSSS type, that the NIN3GPP access is allowed (allocated, used) to the UE, that the slice 1 is allowed for the NIN3GPP access, that the slice 1 is associated with the PDU session, that a N3GPP access is used for the UE for the slice 1, and/or the like.

The AMF may receive the message 10. In response to receiving the message 10, because the message 10 comprises the indication of the NIN3GPP access, the AMF may determine to send a Nnsacf message 32, to the NSACF. For example, because the UE is registered via the 3GPP access, because the UE is allowed for the first network slice for the 3GPP access, because the UE is not registered via the N3GPP access, because the UE does not send a registration request via the N3GPP access, because the SMF indicates that the PDU session associated with the slice 1 is configured with the NIN3GPP access, because the message 1 is received via the 3GPP access, and/or the like, the AMF may determine to send the Nnsacf message 32 to the NSACF.

The Nnscaf message 32 may be at least one of a Nnsacf_NSAC_NumOfUEsUpdate response message 32, Nnsacf_NSAC_NumOfPDUsUpdate response message 32, Nnsacf_NSAC_EACNotify response message 32, Nnsacf_NSAC_QuotaUpdate response message 32, Nnsacf_NSAC_LocalNumberUpdate response message 32, and/or the like. For example, the Nnsacf response message 32 may comprise an information of access type. The information of access type may indicate at least one of the N3GPP access, the NIN3GPP access, the first ATSSS type, the first MA-PDU session type, the direct access, the identifier of the network slice 1 (e.g. the slice 1) and/or the like. The Nnsacf message 32 may indicate at least one of that a number of UEs for the slice 1 needs to be increased, that a number of UEs for the slice 1 needs to be increased for the N3GPP access, that the NIN3GPP access is added for the UE for the slice 1, and/or the like.

The example embodiment of FIG. 34 may help the AMF to be aware of that a N3GPP access is used for the UE, when the UE does not perform registration via the N3GPP access. The example embodiment may help the NSACF to receive whether a network slice is used for the N3GPP access and/or to adjust a number of UEs associated with the slice.

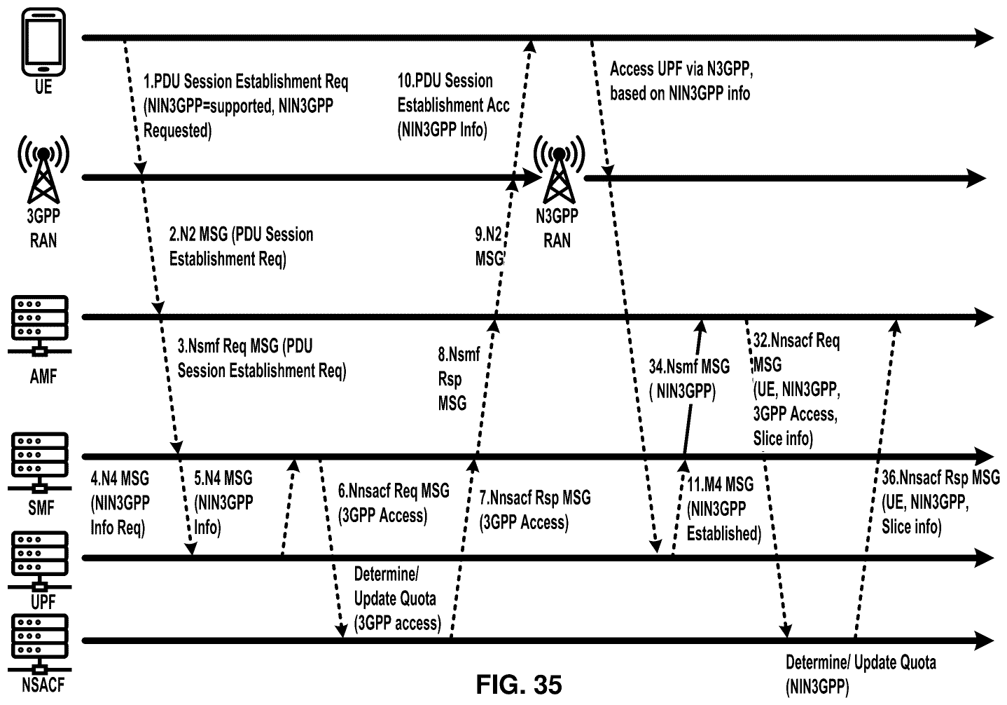

FIG. 35 illustrates an example as per an aspect of an embodiment of the present disclosure. For brevity, based on the other part of the present disclosure, redundant details will be omitted.

In an example, the SMF may receive the N4 session report from the UPF (e.g., as shown in FIG. 31). The N4 session report may indicate that the N3GPP access is established with the UE. In response to receiving the N4 session report, the SMF may send a message 34, to the AMF. The message 34 may be similar to the message 31. The message 34 may indicate that the N3GPP access (e.g., the NIN3GPP access is used for the UE and/or for the slice 1). In response to receiving the message 34, the AMF may send the Nnsacf message 32 to the NSACF. The Nnsacf message 32 may indicate that the number of the UE for the slice 1 needs to be increased.

The example embodiment of FIG. 35 may help the AMF and/or the NSACF to update usage of a network slice, based on whether the UE can use the N3GPP access.

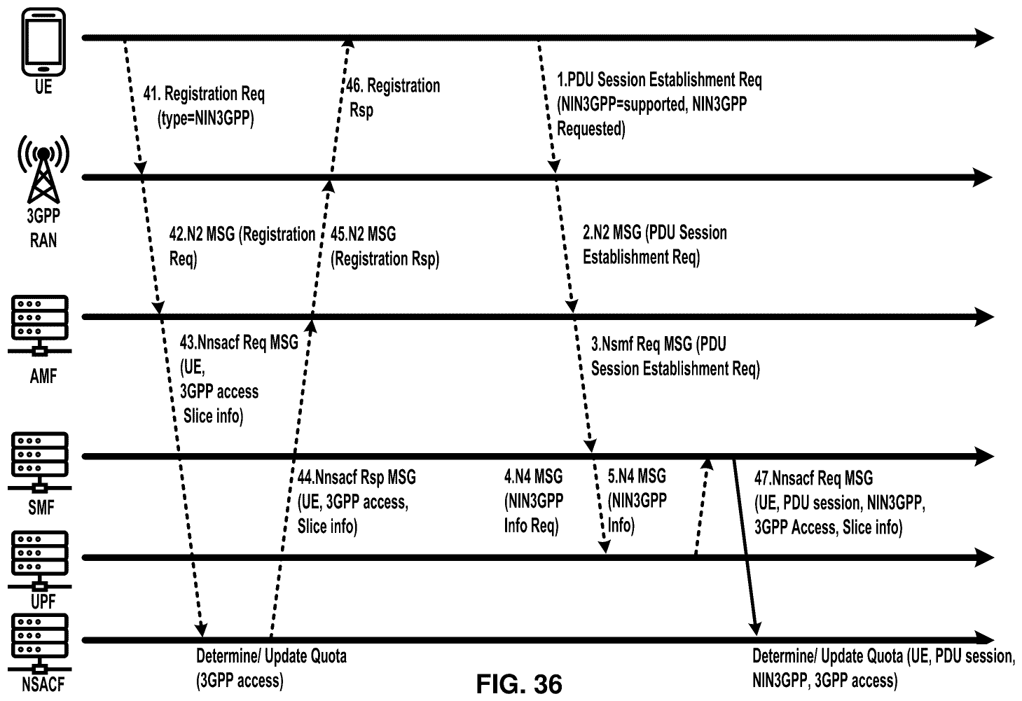

FIG. 36 illustrates an example as per an aspect of an embodiment of the present disclosure. For brevity, based on the other part of the present disclosure, redundant details will be omitted.

In an example, a UE may send a registration request message to an AMF. The registration request message may comprise one or more identifier of one or more requested network slices, a registration type, an indication indicating that the UE supports the direct access, an indication indicating that the UE requests the direct access, and/or the like. The registration type may indicate that the UE requests the direct access. The UE may send the registration request via a 3GPP access. The one or more requested network slices may comprise a slice 1.

In an example, the AMF may send a Nnsacf request message 43 to the NSACF. The Nnsacf request message 43 may be similar to the Nnsacf message 32. For example, the Nnsacf request message 43 may indicate at least one of that an access type is the 3GPP access, that the number of UEs for the slice 1 needs to be increased, and/or the like.

In response to receiving the Nnsacf request message 43, the NSACF may update the number of the UEs for the network slice. For example, the NSACF may store that a list of UEs for the network slice (the network slice 1) may comprise an identifier of the UE and/or that the UE uses the 3GPP access.

In an example, after being registered by the 3GPP access, the UE may send a PDU session establishment request message to the SMF. For example, the PDU session establishment request may indicate at least one of that the UE requests a PDU session, that the PDU session is of the first ATSSS type, the network slice 1, and/or the like.

In an example, the SMF may determine to allow the PDU session of the first ATSSS type. In response to the determination, the SMF may send a Nnsacf request message 47. For example, the Nnsacf request message 47 may be at least one of a Nnsacf_NSAC_NumOfUEsUpdate request message 47, Nnsacf_NSAC_NumOfPDUsUpdate response message 47, Nnsacf_NSAC_EACNotify response message 47, Nnsacf_NSAC_QuotaUpdate response message 47, Nnsacf_NSAC_LocalNumberUpdate response message 47, and/or the like. The Nnsacf request message 47 may indicate at least one of that a PDU session is established for the UE, that the PDU session is established for the slice 1, that the number of UEs for the slice 1 needs to be increased, that the number of the UEs for the slice 1 needs to be increased for the N3GPP access, that the number of PDU session for the slice 1 needs to be increased, that the number of PDU session for the slice 1 needs to be increased for the 3GPP access, that the number of PDU session for the slice 1 needs to be increased for the N3GPP, that the number of PDU session for the slice 1 needs to be increased by 2, that the number of UEs for the slice 1 needs to be increased by 1, an indication of the 3GPP access, an indication of the N3GPP access, an indication of the direct access, and/or the like.

In an example, the NSACF may receive the Nnsacf request message 47, from the SMF. In response to receiving the Nnsacf request message 47, the NSACF may increase the number of PDU sessions for the slice 1 and/or the number of the UEs for the slice 1.

The example embodiment of FIG. 36 may help the NSACF to manage the quota of a network slice and/or to update a number of the PDU sessions for a network slice and a number of the UEs for the network slice, based on input from an SMF. This may help in reducing the signalling from the AMF to the NSACF for accurate management of a quota of a network slice.

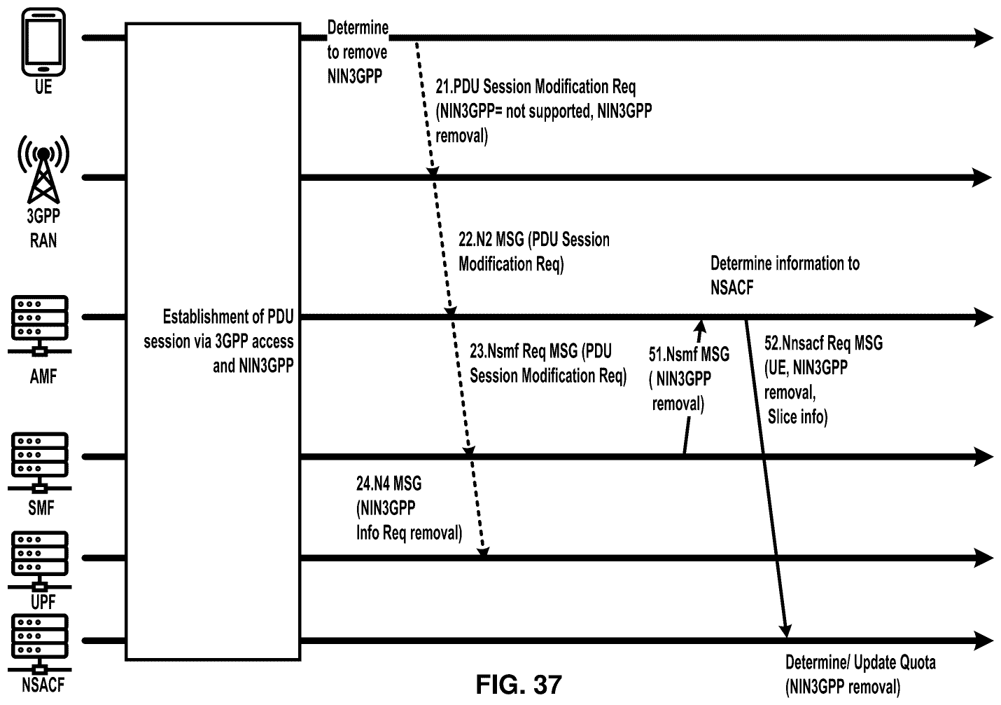

FIG. 37 illustrates an example as per an aspect of an embodiment of the present disclosure. For brevity, based on the other part of the present disclosure, redundant details will be omitted.

In an example, the UE may establish a PDU session of the first ATSSS type. The PDU session may be for the slice 1.

In an example, the UE may send a NAS message 21 to an AMF and/or a SMF. The NAS message 21 may indicate at least one of that the PDU session is requested to be modified to the second (or third) ATSSS type, that the NIN3GPP access (or N3GPP access) is requested to be removed from the PDU session, that the N3GPP access not available, that the first ATSSS type is not supported any more, and/or the like. For example, due to power consumption issue, the UE may determine not to use the N3GPP access. For example, when the UE moves out of a coverage of the N3GPP access, the UE may determine to report unavailability of the N3GPP access. The NAS message 21 may be at least one of a registration request message, a PDU session establishment request message, a PDU session modification request message, and/or the like.

In an example, the SMF (or the AMF) may receive the NAS message 21 from the UE.

In an example, in response to receiving the message 21 from the UE, the SMF may send a message 51 to the AMF. For example, the message 51 may be at least one of a Namf message and/or a Nsmf message. For example, the message 51 may comprise at least one of a Nsmf_PDUSession_CreateSMContext response message 51, a Nsmf_PDUSession_UpdateSMContext response message 51, a Namf_Communication_N1N2 message transfer message 51, and/or the like. For example, the message 51 may comprise at least one of an identifier of the slice 1 (e.g., S-NSSAI 1), an indication of removal of a NIN3GPP access, and/or the like.

The indication of removal of the NIN3PP access may indicate at least one of that the direct access is not used, that a N3GPP access is removed from the PDU session, the indication of the third ATSSS type, the indication of the third MA PDU session type, the indication of modification of the PDU session, a change of ATSSS type, and/or the like.

The AMF may receive the message 51. In response to receiving the message 51, because the message 51 comprises the indication of removal of the NIN3GPP access, the AMF may determine to send a Nnsacf message 52, to the NSACF. For example, because the UE is registered via the 3GPP access, because the UE use the first network slice for the 3GPP access, because the UE is not registered via the 3GPP access, because the SMF indicates that the PDU session associated with the slice is not configured with the NIN3GPP access, and/or the like, the AMF may determine to send the Nnsacf message 52 to the NSACF.

In one embodiment, the SMF may receive the message 21. In response to receiving the message 21, the SMF may determine to change the PDU session of the first ATSSS type to the third ATSSS type. For example, the SMF may send a N4 session request message to the UPF. For example, the N4 session request message may indicate removal of the resources for the N3GPP access and/or removal of the resource associated with the NIN3GPP access.

The Nnscaf message 52 may be at least one of a Nnsacf_NSAC_NumOfUEsUpdate response message 52, Nnsacf_NSAC_NumOfPDUsUpdate response message 52, Nnsacf_NSAC_EACNotify response message 52, Nnsacf_NSAC_QuotaUpdate response message 52, Nnsacf_NSAC_LocalNumberUpdate response message 52, and/or the like. For example, the Nnsacf response message 52 may comprise an information of access type. The information of access type may indicate at least one of that the N3GPP access is not used, that the 3GPP access is used, that the NIN3GPP access is not used, the third ATSSS type, the third MA-PDU session type, and/or the like. The Nnsacf message 52 may indicate at least one of that a number of UEs for the slice 1 needs to be decreased, that a number of UEs for the slice 1 needs to be decreased for the N3GPP access, that the NIN3GPP access is removed for the slice 1 for the UE, and/or the like.

In response to receiving the Nnsacf message, the NSACF may adjust the number of the UEs for the slice 1 and/or the number of the PDU sessions for the slice 1.

The example embodiment of FIG. 37 may help to increase use of the network slice, when a UE is not associated with the N3GPP access.

The following provides some example aspects of the present disclosure:

Aspect 1: A method comprising: sending, by a wireless device to a first access and mobility management function (AMF), a first non-access stratum (NAS) message indicating that the wireless device supports a first access traffic steering, switching, and splitting (ATSSS) type of a plurality of ATSSS types, wherein the plurality of the ATSSS types comprise: the first ATSSS type not using a Non-3GPP interworking function (N3IWF); and a second ATSSS type using the N3IWF; receiving, by the wireless device from the first AMF, a second message comprising an indication indicating that the first ATSSS type is allowed for a first single-network slice selection information (S-NSSAI); and sending, by the wireless device to a second AMF, an establishment request for a first protocol data unit (PDU) session, of the first ATSSS type, associated with the first S-NSSAI.

Aspect 2: A method comprising: receiving, by a wireless device from a first access and mobility management function (AMF), a non-access stratum (NAS) message comprising an indication indicating whether an access traffic steering, switching, and splitting (ATSSS) type of a plurality of ATSSS types is allowed for a single network slice selection assistance information (S-NSSAI).

Aspect 3: The method of aspect 2, further comprising sending by the wireless device to a second AMF, an establishment request of a protocol data unit (PDU) session for the S-NSSAI, of the ATSSS type.

Aspect 4: The method of aspect 2, further comprising sending, by the wireless device to the first AMF, a first non-access stratum (NAS) message indicating the wireless device supporting the ATSSS type.

Aspect 5: The method of aspect 2, wherein the ATSSS type does not uses a N3IWF.

Aspect 6: The method of aspect 2, further comprising sending by the wireless device to a second AMF, a request message requesting establishment of a protocol data unit (PDU) session for the S-NSSAI.

Aspect 7: The method of aspect 6, wherein the request message comprises at least one of an indication indicating the ATSSS type or the S-NSSAI allowed for the ATSSS type.

Aspect 8: The method of aspect 2 to 7, wherein the PDU session of the ATSSS type is associated with a plurality of accesses.

Aspect 9: The method of aspect 2 to 8, wherein the plurality of accesses comprises a 3GPP access and the first N3GPP access.

Aspect 10: The method of aspect 2 to 9, wherein the plurality of accesses does not comprise the N3IWF.

Aspect 11: The method of aspect 2 to 10, wherein the wireless device does not send a second registration request for the N3GPP access.

Aspect 12: The method of aspect 2 to 11, further comprising sending by the wireless device to the first AMF, a first NAS message indicating the wireless device supporting the ATSSS type among the plurality of ATSSS types.

Aspect 13: The method of aspect 2 to 12, wherein the plurality of ATSSS types comprise a second ATSSS type, wherein the second ATSSS type uses the N3IWF.

Aspect 14: The method of aspect 2 to 13, further comprising receiving by the wireless device, a response message indicating establishment of the PDU session of the ATSSS type.

Aspect 15: The method of aspect 2 to 14, further comprising determining by the wireless device, based on receiving the response message, the wireless device being registered for the second access.

Aspect 16: The method of aspect 2 to 14, further comprising determining by the wireless device, based on receiving the response message, the S-NSSAI being allowed for the second access.

Aspect 17: The method of aspect 4, where in the first NAS message comprises a policy information identifier indicating whether the wireless device has a policy section identifier associated with the ATSSS type.

Aspect 18: The method of aspect 3, wherein the second AMF is the first AMF.

Aspect 19: The method of aspect 3, further comprising sending by the wireless device to a user plane function (UPF), one or more data packets of the PDU session, without via the N3IWF.

Aspect 20: The method of aspect 2, wherein the ATSSS type is associated with ATSSS-lite.

Aspect 21: The method of aspect 2, wherein the plurality of ATSSS types supports multi access PDU session.

Aspect 22: The method of aspect 13, wherein the second ATSSS type supports a second MPQUIC functionality via the N3IWF.

Aspect 22: The method of aspect 2, wherein the ATSSS type supports a second MPQUIC functionality without the N3IWF.

Aspect 23: A method comprising: sending, by a wireless device to an access and mobility management function (AMF), a registration request message comprising: one or more requested single network slice selection assistance informations (S-NSSAIs); and a registration type indication indicating access traffic steering, switching, and splitting-lite (ATSSS-lite); receiving, by the wireless device from the AMF, a registration accept message comprising: one or more allowed S-NSSAIs of the one or more requested S-NSSAIs; and a registration indication indicating one or more S-NSSAIs of the one or more allowed S-NSSAIs are allowed for the ATSSS-lite; and sending, by the wireless device to the AMF, a non-access stratum (NAS) message requesting establishment of a protocol data unit (PDU) session, comprising a S-NSSAI of the one or more S-NSSAIs.

Aspect 24: A method comprising: receiving, by a wireless device from an access and mobility management function (AMF), a registration accept message comprising: one or more allowed single network slice selection assistance information (S-NSSAIs) of the one or more requested S-NSSAIs; and an indication indicating whether a single network slice selection assistance information (S-NSSAI) is allowed for an access traffic steering, switching, and splitting-lite (ATSSS-lite).

Aspect 25: The method of aspect 24, further comprising, sending by the wireless device to the AMF, a non-access stratum (NAS) message requesting establishment of a protocol data unit (PDU) session, comprising the S-NSSAI, if the S-NSSAI is allowed for ATSSS-lite.

Aspect 26: The method of aspect 24 to 25, further comprising sending, by the wireless device to the AMF, a registration request message comprising a registration type indication indicating ATSSS-lite.

Aspect 27: The method of aspect 24 to 26, wherein the ATSSS-lite is at least one of associating a PDU session with a resource of an access path with which the wireless device does not signalling connection, establishing the PDU session using a plurality of accesses with being registered to a subset of the plurality of access paths, establishing the PDU session associated with the plurality of accesses without non-3GPP interworking function (N3IWF).

Aspect 28: The method of aspect 24 to 27, wherein the wireless device sends the NAS message, if the AMF indicates a network supporting the ATSSS-lite.

Aspect 29: A method comprising: receiving, by a wireless device from a first access and mobility management function (AMF), one or more configuration information indicating one or more single network slice selection assistance information (S-NSSAIs), comprising: a first configuration information indicating a first S-NSSAI being allowed for a first protocol data unit (PDU) session associated with a first access traffic steering, switching, and splitting (ATSSS) type; and a second configuration information indicating a second S-NSSAI being allowed for a second protocol data unit (PDU) session associated with a second ATSSS type; and sending, by the wireless device to a second AMF, an establishment request of a protocol data unit (PDU) session indicating at least one of: the first S-NSSAI, based on the wireless device being registered via 3GPP access and non-3GPP access; or the second S-NSSAI, based on the wireless device not being registered via non-3GPP access.

Aspect 30: A method comprising: receiving, by a wireless device from a first access and mobility management function (AMF), one or more configuration information indicating one or more single network slice selection assistance information (S-NSSAIs), wherein at least one of the one or more configuration information indicates a third S-NSSAI being allowed for a first ATSSS type; sending, by the wireless device to a second AMF, a first non-access stratum (NAS) message requesting a protocol data unit (PDU) session associated with the third S-NSSAI; and receiving, by the wireless device from a second AMF, a non-access stratum (NAS) message indicating the third S-NSSAI being allowed for a second ATSSS type.

Aspect 31: A method comprising: sending, by a wireless device to an access and mobility management function (AMF) after sending attach request to a mobility management entity (MME), a registration request message comprising one or more single network slice selection assistance information (S-NSSAIs), wherein the registration request message further indicates UE supporting one or more ATSSS type, wherein the one or more ATSSS type comprises: a first ATSSS type being associated with an N3IWF; and a second ATSSS type not being associated with the N3IWF.

Aspect 32: A method comprising: sending, by a wireless device to a mobility management entity (MME), a first request message for a PDN connection; sending, by the wireless device to an access and mobility management function (AMF), a second request for a PDU session associated with PDN connection; and sending, by the wireless device to the AMF, a third request for the PDU session, comprising an indication indicating the PDU session for an ATSSS type not being associated with an N3IWF is allowed.

Aspect 33: A method comprising: sending, by the wireless device to an access and mobility management function (AMF), a uplink non-access stratum (NAS) message requesting establishment of a protocol data unit (PDU) session for a single network slice selection assistance information (S-NSSAI), comprising: an indication indicating the PDU session for an ATSSS type not being associated with an N3IWF is allowed.

Aspect 34: A method comprising: receiving, by a wireless device from an access and mobility management function (AMF) via a first access, a registration accept message comprising one or more allowed single network slice selection assistance information (S-NSSAIs); sending, by the wireless device to the AMF, a first non-access stratum (NAS) request message requesting establishment of a protocol data unit (PDU) session for a S-NSSAI of the one or more allowed S-NSSAIs; receiving, by the wireless device from a second AMF, a second non-access stratum (NAS) message indicating the PDU session being established for an access traffic steering, switching, and splitting (ATSSS) type; determining, by the wireless device after receiving the second NAS message, the S-NSSAI being registered for a second access.

Aspect 35: The method of aspect 34, wherein the first access is 3GPP access and the second access is N3GPP access.

Aspect 36: The method of aspect 34, wherein the ATSSS type is not associated with N3IWF.

Aspect 37: A method comprising: receiving, by a wireless device from an access and mobility management function (AMF) via a first access, a registration accept message comprising one or more allowed single network slice selection assistance information (S-NSSAIs); sending, by the wireless device to the AMF, a first non-access stratum (NAS) request message requesting establishment of a protocol data unit (PDU) session for a S-NSSAI of the one or more allowed S-NSSAIs; receiving, by the wireless device from a second AMF, a second non-access stratum (NAS) message indicating the PDU session being established for an access traffic steering, switching, and splitting (ATSSS) type; and establishing, by the wireless, the PDU session over a second access; and determining, by the wireless device after receiving the second NAS message, the S-NSSAI not being registered for a second access.

Aspect 38: A method comprising: receiving, by a session management function from an access and mobility management function (AMF), an indication indicating a wireless device being de-registered for a first access; determining, by the SMF, whether a PDU session established for the wireless is associated with an access traffic steering, switching, and splitting (ATSSS) type of a plurality of ATSSS types; sending, by the SMF to a UPF, a request requesting releasing of configuration associated with a second access.

Aspect 39: A method comprising: receiving, by a session management function from an unified data management (UDM), one or more configuration information for a wireless device; wherein each of the one or more configuration information indicates: a S-NSSAI; an indication indicating whether the S-NSSAI is allowed for an access traffic steering, switching, and splitting (ATSSS) type of a plurality of ATSSS types.

Aspect 40: A method comprising: sending, by a wireless device to a first access and mobility management function (AMF), a first non-access stratum (NAS) message indicating the wireless device supporting an access traffic steering, switching, and splitting (ATSSS) type of a plurality of ATSSS types comprising: a first ATSSS type not using a N3IWF; and a second ATSSS type using the N3IWF; and receiving, by the wireless device from the first AMF, a message comprising: an indication indicating whether the ATSSS type is allowed for a S-NSSAI; and sending, by a wireless device to a second AMF, an establishment request of a protocol data unit (PDU) session of the ATSSS type, for the S-NSSAI.

Aspect 41: A method comprising: sending, by a session management function to a network slice access control function, a network slice access control request message requesting increase of a number of UE for a network slice associated with a protocol data unit session.

Aspect 42: The method of aspect 41, wherein the network slice access control request message comprises an access type indicating a non 3rd generation partnership project (N3GPP) access.

Aspect 43: The method of aspect 42, wherein the N3GPP access is not associated with a N3GPP interworking function.

Aspect 44: A method comprising: sending, by a session management function to an access and mobility function, a notification message indicating that a protocol data session associated with a network slice is configured with a non 3rd generation partnership project access.

Aspect 45: The method of aspect 44, wherein the N3GPP access is not associated with a N3GPP interworking function.

Aspect 46: A method comprising: sending, by a wireless device to a session management function (SMF), a first requesting a protocol data unit (PDU) session, comprising a first non 3rd generation partnership project (N3GPP) access type of a plurality of N3GPP access types, wherein the first N3GPP access type is not associated with a N3GPP interworking function (N3IWF); and sending, by a wireless device to the SMF, a second request requesting removal of the first N3GPP access type.

Aspect 47: A method comprising: sending, by a session management function (SMF) to a user plane function (UPF), a first requesting a protocol data unit (PDU) session, comprising a first non 3rd generation partnership project (N3GPP) access type of a plurality of N3GPP access types, wherein the first N3GPP access type is not associated with a N3GPP interworking function (N3IWF); and sending, by the SMF to the UPF, a second request requesting removal of the first N3GPP access type.

Aspect 48: A method comprising: receiving, by an access and mobility function (AMF) from a session management function, a notification message indicating that a protocol data session associated with a network slice is configured with a non 3rd generation partnership project access (N3GPP); and sending, by the AMF to a network slice access control function, a network slice access control request message requesting increase of a number of UE for a network slice associated for the N3GPP access.

Aspect 49: The method of aspect 48, wherein the N3GPP access is not associated with a N3GPP interworking function.

Aspect 50: A method comprising: receiving, by a session management function (SMF) from a user plane function (UPF), a N4 session report message indicating establishment of connection to a wireless device via a non 3rd generation partnership project access (N3GPP); and sending, by the SMF to an access and mobility function, a notification message indicating that a protocol data session associated with a network slice is configured with a non 3rd generation partnership project access.

Aspect 51: The method of aspect 50, wherein the N3GPP access is not associated with a N3GPP interworking function.

Aspect 52: A method comprising: receiving, by a session management function (SMF) from a user plane function (UPF), a N4 session report message indicating establishment of connection to a wireless device via a non 3rd generation partnership project access (N3GPP); and sending, by the SMF to a network slice access control function, a network slice access control request message requesting decrease of a number of PDU sessions for a network slice associated for the N3GPP access.

Aspect 53: The method of aspect 51, wherein the N3GPP access is not associated with a N3GPP interworking function.

Aspect 54: A method comprising: receiving, by a session management function (SMF) from a wireless device and via a 3rd generation partnership project (3GPP) access, a protocol data unit (PDU) session establishment request, wherein the PDU session comprise a non-3GPP access not associated with a N3IWF; and sending, by the SMF to a network slice access control function, a network slice access control (NSAC) request message requesting increase of a number of PDU sessions for a network slice, wherein the NSAC request message comprise the 3GPP access and the non-3GPP access not associated with the N3IWF.

Aspect 55: A method comprising: receiving, by a session management function (SMF) from a wireless device and via a 3rd generation partnership project (3GPP) access, a protocol data unit (PDU) session establishment request, wherein the PDU session comprise a non-3GPP access not associated with a N3IWF; and sending, by the SMF to a network slice access control function, a network slice access control (NSAC) request message requesting increase of a number of PDU sessions for a network, wherein the NSAC request message comprise the 3GPP access and the non-3GPP access not associated with the N3IWF.

Aspect 56: A method comprising: receiving, by a session management function (SMF) from a wireless device and via a 3rd generation partnership project (3GPP) access, a protocol data unit (PDU) session establishment request, wherein the PDU session is associated with a non-3GPP access and an 3GPP access; and sending, by the SMF to a network slice access control function, a network slice access control (NSAC) request message requesting increase of a number of PDU sessions for a network slice, wherein the NSAC request message indicates: the 3GPP access and the non-3GPP access, in response to the N3GPP access being associate with the N3IWF; or the 3GPP access, in response to the N3GPP access not being associated with the N3IWF.

Aspect 57: A method comprising: sending, by a session management function (SMF) to a network slice access control function (NSACF), a first network slice access control (NSAC) request message requesting increase of a number of PDU sessions for a network slice; determining, by the SMF, that a PDU session for the network slice comprises a N3GPP access not associated with a N3IWF; and sending, by the SMF to the NSACF, a second NSAC request message requesting increase of a number of UE for the network slice.

Aspect 58: A method comprising: receiving, by a session management function (SMF) from a AMF, an establishment request of a protocol data unit (PDU) session, where the establishment request indicates a wireless device not being registered via a N3GPP access; determining, by the SMF, that a PDU session for the network slice comprises a N3GPP access not associated with a N3IWF; and sending, by the SMF to a network slice access control function and based on the determining, a network slice access control (NSAC) request message requesting increase of a number of PDU sessions for a network slice, wherein the NSAC request message indicates the 3GPP access and the non-3GPP access.

Aspect 59: A method comprising: receiving, by a session management function (SMF) from a AMF, an establishment request of a protocol data unit (PDU) session, where the establishment request indicates a wireless device not being registered via a N3GPP access; determining, by the SMF, that a PDU session for the network slice comprises a N3GPP access not associated with a N3IWF; and sending, by the SMF to a network slice access control function and based on the establishment request, a network slice access control (NSAC) request message requesting increase of a number of PDU sessions for a network slice, wherein the NSAC request message indicates the 3GPP access.

What is claimed is:

1. A method comprising:
receiving, by a wireless device from a first access and mobility management function (AMF), a non-access stratum (NAS) message comprising an indication indicating whether an access traffic steering, switching, and splitting (ATSSS) type of a plurality of ATSSS types is allowed for a single network slice selection assistance information (S-NSSAI).

2. The method of claim 1, further comprising sending by the wireless device to a second AMF, an establishment request of a protocol data unit (PDU) session for the S-NSSAI, of the ATSSS type.

3. The method of claim 2, wherein the PDU session of the ATSSS type is associated with a plurality of accesses.

4. The method of claim 1, further comprising sending, by the wireless device to the first AMF, a first non-access stratum (NAS) message indicating the wireless device supporting the ATSSS type.

5. The method of claim 1, wherein the ATSSS type does not use a non-3GPP interworking function (N3IWF).

6. The method of claim 1, further comprising sending by the wireless device to a second AMF, a request message requesting establishment of a protocol data unit (PDU) session for the S-NSSAI.

7. The method of claim 5, wherein the request message comprises at least one of an indication indicating the ATSSS type or the S-NSSAI allowed for the ATSSS type.

8. A wireless device comprising one or more processors and memory storing instructions that, when executed by the one or more processors, cause the wireless device to:
receiving, by a wireless device from a first access and mobility management function (AMF), a non-access stratum (NAS) message comprising an indication indicating whether an access traffic steering, switching, and splitting (ATSSS) type of a plurality of ATSSS types is allowed for a single network slice selection assistance information (S-NSSAI).

9. The wireless device of claim 8, wherein the instructions further cause the wireless device to send, to a second AMF, an establishment request of a protocol data unit (PDU) session for the S-NSSAI, of the ATSSS type.

10. The wireless device of claim 9, wherein the PDU session of the ATSSS type is associated with a plurality of accesses.

11. The wireless device of claim 8, wherein the instructions further cause the wireless device to send, to the first AMF, a first non-access stratum (NAS) message indicating the wireless device supporting the ATSSS type.

12. The wireless device of claim 8, wherein the ATSSS type does not use a non-3GPP interworking function (N3IWF).

13. The wireless device of claim 8, wherein the instructions further cause the wireless device to send, to a second AMF, a request message requesting establishment of a protocol data unit (PDU) session for the S-NSSAI.

14. The wireless device of claim 13, wherein the request message comprises at least one of an indication indicating the ATSSS type or the S-NSSAI allowed for the ATSSS type.

15. A non-transitory computer-readable medium comprising instructions that, when executed by one or more processors of a wireless device, cause the wireless device to:
receiving, by a wireless device from a first access and mobility management function (AMF), a non-access stratum (NAS) message comprising an indication indicating whether an access traffic steering, switching, and splitting (ATSSS) type of a plurality of ATSSS types is allowed for a single network slice selection assistance information (S-NSSAI).

16. The non-transitory computer-readable medium of claim 15, wherein the instructions further cause the wireless device to send, to a second AMF, an establishment request of a protocol data unit (PDU) session for the S-NSSAI, of the ATSSS type.

17. The non-transitory computer-readable medium of claim 16, wherein the PDU session of the ATSSS type is associated with a plurality of accesses.

18. The non-transitory computer-readable medium of claim 15, wherein the instructions further cause the wireless device to send, to the first AMF, a first non-access stratum (NAS) message indicating the wireless device supporting the ATSSS type.

19. The non-transitory computer-readable medium of claim 15, wherein the ATSSS type does not use a non-3GPP interworking function (N3IWF).

20. The non-transitory computer-readable medium of claim 15, wherein the instructions further cause the wireless device to send, to a second AMF, a request message requesting establishment of a protocol data unit (PDU) session for the S-NSSAI.
